(19) United States
(12) Patent Application Publication
(10) Pub. No.: US 2025/0136744 A1
(43) Pub. Date: May 1, 2025

(54) HYBRID OLEFINIC COMPOSITIONS COMPRISING RESIN COMPOSITIONS POLYMERIZABLE BY ADDITION OR CONDENSATION POLYMERIZATION REACTIONS

(71) Applicant: MATERIA, INC., Pasadena, CA (US)

(72) Inventors: Madhura PADE, Pasadena, CA (US); Wenliang Patrick YANG, Ballston Lake, NY (US)

(21) Appl. No.: 18/694,086

(22) PCT Filed: Sep. 23, 2022
(86) PCT No.: PCT/US2022/076961

§ 371 Date: Mar. 21, 2024

Related U.S. Application Data
(60) Provisional application No. 63/248,044, filed on Sep. 24, 2021.

(51) Int. Cl. C08G 18/12; C08G 18/32; C08G 61/08; C09D 5/08

(52) U.S. Cl. CPC C08G 18/12; C08G 18/3206; C08G 61/08; C09D 5/08; C08G 2150/00; C08G 2170/00; C08G 2261/3324; C08G 2261/3325; C08G 2261/374; C08G 2261/418

(57) ABSTRACT

The invention relates to hybrid compositions comprising at least one cyclic olefin monomer composition: at least one resin composition polymerizable by addition or condensation polymerization; and, optionally, at least one additive. The invention also relates to articles of manufacture made from the hybrid compositions of the invention, and methods of making the articles. The invention also relates to coating compositions comprising the hybrid compositions of the invention, and to objects or substrates coated with the coating compositions of the invention, which may then be cured. The invention also relates to methods of coating the objects or substrates with the coating compositions of the invention. The invention further relates to the use of the hybrid compositions of the invention as adhesives.

### CROSS REFERENCE TO RELATED APPLICATIONS

This application claims priority to U.S. Provisional Application No. 63/248,044, filed on Sep. 24, 2021, the disclosure of which is incorporated by reference.

### FIELD OF INVENTION

This invention relates to hybrid compositions comprising at least one cyclic olefin monomer composition; at least one resin composition polymerizable by addition or condensation polymerization; and, optionally, at least one additive. The invention also relates to methods of producing molded articles using the hybrid compositions of the invention via a ring-opening metathesis polymerization process. The invention further relates to the use of the hybrid compositions of the invention as coatings, such as anti-corrosion coatings and protective coatings, to the use of the hybrid compositions of the invention as adhesives, and methods of applying them. The invention also relates to the articles of manufacture made from and/or coated with the hybrid compositions of the invention.

The hybrid compositions of the invention may be utilized for a wide range of substrates. The invention has utility in the fields of polymers, materials, and manufacture.

### BACKGROUND

Standard epoxy coating formulations are made by mixing a reactive epoxy resin (comprising other additives or fillers) and a curative (also referred to as a hardener). When applied to a substrate by brush or spray, the formulations form dry film on the substrate. Similarly, standard polyurethane coatings are made using reactive polyols, reactive chain extenders and isocyanate based hardeners or crosslinkers. The polar nature of these standard coatings allows them to adhere strongly to metal substrates. The coatings can also withstand continuous exposure to hot and dry environments. But these standard formulations can deteriorate rapidly in an aqueous environment due to water ingress through the coating film, causing the substrate to rust. Conversely, a non-polar hydrophobic cyclic olefinic coating system can impede water ingress and protect the underlying substrate from corrosion. Significantly faster reactivity of the cyclic olefinic monomer with a ruthenium catalyst can shorten work-time. But the hydrophobic, non-polar nature of the olefinic system can only provide adhesion to the substrate via mechanical interlocking with sandblasted metal substrates unless an appropriate adhesion promoter is formulated into the coatings. This invention solves one or more of the shortcomings of these standard coatings.

### SUMMARY OF THE INVENTION

The invention relates to hybrid compositions comprising, consisting essentially of, or consisting of at least one cyclic olefin monomer composition; at least one resin composition polymerizable by addition or condensation polymerization; and, optionally, at least one additive.

The invention also relates to articles of manufacture made from the hybrid compositions of the invention, and methods of making the articles.

The invention further relates to the use of the hybrid compositions of the invention as coatings. And the invention also relates to objects or substrates coated with the hybrid compositions of the invention, which may then be cured for a coating. The invention also relates to methods of coating the objects or substrates with the hybrid compositions of the invention.

The invention further relates to the use of the hybrid compositions of the invention as adhesives.

### DETAILED DESCRIPTION OF THE INVENTION

### Terminology and Definitions

Unless otherwise indicated, the invention is not limited to specific reactants, substituents, catalysts, olefin metathesis catalysts, catalyst compositions, olefins, cyclic olefin compositions, coating compositions, reaction conditions, or the like, as such may vary. It is also to be understood that the terminology used herein is for the purpose of describing particular embodiments only and is not to be interpreted as being limiting.

In this specification and in the claims that follow, reference will be made to a number of terms, which shall be defined to have the meanings as described herein.

The term “alkyl” as used herein, refers to a linear, branched, saturated hydrocarbon group typically containing 1 to 24 carbon atoms, preferably 1 to 12 carbon atoms, more preferably 1 to 6 carbon atoms: such as methyl (Me), ethyl (Et), n-propyl(Pr or n-Pr), iso-propyl (i-Pr), n-butyl (Bu or n-Bu), iso-butyl (i-Bu), tert-butyl (t-Bu), octyl (Oct), decyl, and the like.

The term “cycloalkyl” refers to a cyclic alkyl group, can be monocyclic, bicyclic or polycyclic, typically having 3 to 10, preferably 5 to 7, carbon atoms, generally, cycloalkyl groups are cyclopentyl (Cp), cyclohexyl (Cy), adamantyl.

The term “substituted alkyl” refers to alkyl substituted with one or more substituent groups, and the terms “heteroatom-containing alkyl” and “heteroalkyl” refer to alkyl in which at least one carbon atom is replaced with a heteroatom.

The term “alkylene” as used herein refers to a difunctional linear, branched alkyl group, where “alkyl” is as defined above.

The term “alkenyl” as used herein refers to a linear, branched hydrocarbon group of 2 to 24 carbon atoms containing at least one double bond, such as ethenyl, n-propenyl, iso-propenyl, n-butenyl, iso-butenyl, octenyl, decenyl, tetradecenyl, hexadecenyl, and the like. Preferred alkenyl groups herein contain 2 to 12 carbon atoms, more preferred alkenyl groups herein contain 2 to 6 carbon atoms.

The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom.

The term “cycloalkenyl” refers to a cyclic alkenyl group, preferably having 3 to 12 carbon atoms.

The term “alkenylene” as used herein refers to a difunctional linear, branched, where “alkenyl” is as defined above.

The term “alkynyl” as used herein refers to a linear or branched hydrocarbon group of 2 to 24 carbon atoms containing at least one triple bond, such as ethynyl, n-propynyl, and the like. Preferred alkynyl groups herein contain 2 to 12 carbon atoms, more preferred alkynyl groups herein contain 2 to 6 carbon atoms.

The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom.

The term “alkynylene” as used herein refers to a difunctional alkynyl group, where “alkynyl” is as defined above.

The term “alkoxy” as used herein refers to an alkyl group bound through a single, terminal ether linkage; that is, an “alkoxy” group may be represented as —O-alkyl where “alkyl” is as defined above. Analogously, “alkenyloxy” refer to an alkenyl group bound through a single, terminal ether linkage, and “alkynyloxy” refers to an alkynyl group bound through a single, terminal ether linkage.

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Preferred aryl groups contain 5 to 24 carbon atoms, and particularly preferred aryl groups contain 6 to 10 carbon atoms. Exemplary aryl groups contain one aromatic ring or two fused or linked aromatic rings, e.g., phenyl (Ph), naphthyl, biphenyl, diphenylether, diphenylamine, benzophenone, phenanthryl and the like.

“Substituted aryl” refers to an aryl moiety substituted with one or more substituent groups, and the terms “heteroatom containing aryl” and “heteroaryl” refer to aryl substituents in which at least one carbon atom is replaced with a heteroatom, as will be described in further detail herein.

The term “aryloxy” as used herein refers to an aryl group bound through a single, terminal ether linkage, wherein “aryl” is as defined above. An “aryloxy” group may be represented as —O-aryl where aryl is as defined above. Preferred aryloxy groups contain 5 to 24 carbon atoms, and particularly preferred aryloxy groups contain 6 to 10 carbon atoms. Examples of aryloxy groups include, without limitation, phenoxy, o-halo-phenoxy, m-halo-phenoxy, p-halo-phenoxy, o-methoxy-phenoxy, m-methoxy-phenoxy, p-methoxy-phenoxy, 2,4-dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Preferred alkaryl and aralkyl groups contain 6 to 24 carbon atoms, and particularly preferred alkaryl and aralkyl groups contain 6 to 16 carbon atoms. Alkaryl groups include, without limitation, p-methylphenyl, 2,4-dimethylphenyl, p-cyclohexylphenyl, 2,7-dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The terms “alkaryloxy” and “aralkyloxy” refer to substituents of the formula-OR wherein R is alkaryl or aralkyl, respectively, as defined herein.

The term “acyl” refers to substituents having the formula —(CO)-alkyl, —(CO)-aryl, —(CO)-aralkyl, —(CO)-alkaryl, —(CO)-alkenyl, or —(CO)-alkynyl, and the term “acyloxy” refers to substituents having the formula-O(CO)-alkyl, —O(CO)-aryl, —O(CO)-aralkyl, —O(CO)-alkaryl, —O(CO)-alkenyl, or —(CO)-alkynyl wherein “alkyl,” “aryl,” “aralkyl,” “alkaryl,” “alkenyl,” and “alkynyl” are as defined above. The acetoxy group (—O(CO)CH₃, often abbreviated as —OAc) is a common example of an acyloxy group.

The terms “cyclic” and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic or polycyclic.

The term “polycyclic ring” refers to alicyclic or aromatic groups that may or may not be substituted and/or heteroatom containing, and that have at least two closed rings tethered, fused, linked via a single bond or bridged. Polycyclic rings include without limitation naphthyl, biphenyl, phenanthryl and the like.

The term “spiro compound” refers to a chemical compound, which presents a twisted structure of two or more rings (a ring system), in which 2 or 3 rings are linked together by one common atom.

The terms “halo” and “halogen” and “halide” are used in the conventional sense to refer to a fluorine (F), chlorine (CI), bromine (Br), or iodine (I) substituent.

“Hydrocarbyl” refers to univalent hydrocarbyl moieties containing 1 to 24 carbon atoms, preferably 1 to 12 carbon atoms, including linear, branched, cyclic, saturated and unsaturated species, such as alkyl groups, alkenyl groups, alkynyl groups, aryl groups, and the like. “Substituted hydrocarbyl” refers to hydrocarbyl substituted with one or more substituent groups.

“Hydrocarbylene” refers to divalent hydrocarbyl moieties containing 1 to 24 carbon atoms, preferably 1 to 12 carbon atoms, including linear, branched, cyclic, saturated and unsaturated species, formed by removal of two hydrogens from a hydrocarbon. “Substituted hydrocarbylene” refers to hydrocarbylene substituted with one or more substituent groups.

The term “heteroatom-containing” as in a “heteroatom-containing hydrocarbyl group” refers to a hydrocarbon molecule or a hydrocarbyl molecular fragment in which one or more carbon atoms is replaced with an atom other than carbon, e.g., nitrogen, oxygen, sulfur, phosphorus or silicon, typically nitrogen, oxygen or sulfur. The term “heteroatom-containing hydrocarbylene” and “heterohydrocarbylene” refer to hydrocarbylene in which at least one carbon atom is replaced with a heteroatom. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include without limitation alkoxyaryl, alkylsulfanyl-substituted alkyl, N-alkylated amino alkyl, and the like. Examples of heteroaryl substituents include without limitation pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups include without limitation pyrrolidino, morpholino, piperazino, piperidino, etc.

In addition, the aforementioned substituent groups may, if a particular group permits, be further substituted with one or more additional substituent groups or with one or more hydrocarbyl moieties such as those specifically enumerated above. Analogously, the above mentioned hydrocarbyl moieties may be further substituted with one or more substituent groups or additional hydrocarbyl moieties such as those specifically mentioned above. Analogously, the above-mentioned hydrocarbylene moieties may be further substituted with one or more substituent groups or additional hydrocarbyl moieties as noted above.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation groups such as halo, hydroxyl, sulfhydryl, C₁-C₂₄ alkoxy, C₂-C₂₄ alkenyloxy, C₂-C₂₄ alkynyloxy, C₅-C₂₄ aryloxy, C₆-C₂₄ aralkyloxy, C₆-C₂₄ alkaryloxy, acyl (including C₂-C₂₄ alkylcarbonyl (—CO-alkyl) and C₆-C₂₄ arylcarbonyl (—CO-aryl)), acyloxy (—O-acyl, including C₂-C₂₄ alkylcarbonyloxy (—O—CO-alkyl) and C₆-C₂₄ arylcarbonyloxy (—O—CO-aryl)), C₂-C₂₄ alkoxycarbonyl (—(CO)—O-alkyl), C₆-C₂₄ aryloxycarbonyl (—(CO)—O-aryl), halocarbonyl (—CO—X where X is halo), C₂-C₂₄ alkylcarbonato (—O—(CO)—O-alkyl), C₆-C₂₄ arylcarbonato (—O—(CO)—O-aryl), carboxylic acid (—COOH), carbamoyl (—(CO)—NH2), mono-(C₁-C₂₄ alkyl)-substituted carbamoyl (—(CO)—NH(C₁-C₂₄ alkyl)), di-(C₁-C₂₄ alkyl)-substituted carbamoyl (—(CO)—N(C₁-C₂₄ alkyl)₂), mono-(C₁-C₂₄ haloalkyl)-substituted carbamoyl (—(CO)—NH(C₁-C₂₄ haloalkyl)), di-(C₁-C₂₄ haloalkyl)-substituted carbamoyl (—(CO)—N(C₁-C₂₄ haloalkyl)₂), mono-(C₅-C₂₄ aryl)-substituted carbamoyl (—(CO)—NH-aryl), di-(C₅-C₂₄ aryl)-substituted carbamoyl (—(CO)—N(C₅-C₂₄ aryl)₂), N(C₁-C₂₄ alkyl)(C₅-C₂₄ aryl)-substituted carbamoyl (—(CO)—N(C₁-C₂₄ alkyl)(C₅-C₂₄ aryl), thiocarbamoyl (—(CS)—NH2), mono-(C₁-C₂₄ alkyl)-substituted thiocarbamoyl (—(CS)—NH(C₁-C₂₄ alkyl)), di-(C₁-C₂₄ alkyl)-substituted thiocarbamoyl (—(CS)—N(C₁-C₂₄ alkyl)₂), mono-(C₅-C₂₄ aryl)-substituted thiocarbamoyl (—(CS)—NH-aryl), di-(C₅-C₂₄ aryl)-substituted thiocarbamoyl (—(CS)—N(C₅-C₂₄ aryl)₂), N(C₁-C₂₄ alkyl)(C₅-C₂₄ aryl)-substituted thiocarbamoyl (—(CS)—N(C₁-C₂₄ alkyl)(C₅-C₂₄ aryl), —C(O)—NH (alkyl) optionally substituted with a silyl group, —C(O)—N(alkyl)₂ optionally substituted with a silyl group, carbamido (—NH—(CO)—NH₂), cyano (—C═N), cyanato (—O—C═N), thiocyanato (—S—C═N), isocyanate (—NCO), thioisocyanate (—NCS), formyl (—(CO)—H), thioformyl (—(CS)—H), amino (—NH₂), mono-(C₁-C₂₄ alkyl)-substituted amino (—NH(C₁-C₂₄ alkyl), di-(C₁-C₂₄ alkyl)-substituted amino ((—N(C₁-C₂₄ alkyl)₂), mono-(C₅-C₂₄ aryl)-substituted amino (—NH(C₅-C₂₄ aryl), di-(C₅-C₂₄ aryl)-substituted amino (—N(C₅-C₂₄ aryl)₂), C₂-C₂₄ alkylamido (—NH—(CO)-alkyl), C₆-C₂₄ arylamido (—NH—(CO)-aryl), imino (—CRNH where, R includes without limitation H, C₁-C₂₄ alkyl, C₅-C₂₄ aryl, C₆-C₂₄ alkaryl, C₆-C₂₄ aralkyl, etc.), C₂-C₂₀ alkylimino (—CRN (alkyl), where R includes without limitation H, C₁-C₂₄ alkyl, C₅-C₂₄ aryl, C₆-C₂₄ alkaryl, C₆-C₂₄ aralkyl, etc.), arylimino (—CRN (aryl), where R includes without limitation H, C₁-C₂₀ alkyl, C₅-C₂₄ aryl, C₆-C₂₄ alkaryl, C₆-C₂₄ aralkyl, etc.), nitro (—NO₂), nitroso (—NO), sulfo (—S(O)₂OH), C₁-C₂₄ alkylsulfanyl (—S-alkyl; also termed “alkylthio”), C₅-C₂₄ arylsulfanyl (—S-aryl; also termed “arylthio”), C₁-C₂₄ alkylsulfinyl (—(SO)-alkyl), C₅-C₂₄ arylsulfinyl (—(SO)-aryl), C₁-C₂₄ alkylsulfonyl (—SO₂-alkyl), C₁-C₂₄ monoalkylaminosulfonyl (—SO₂—N(H)alkyl), C₁-C₂₄ dialkylaminosulfonyl (—SO₂—N(alkyl)₂), C₅-C₂₄ arylsulfonyl (—SO₂-aryl), boryl (—BH₂), borono (—B(OH)₂), boronato (—B(OR)₂ where R includes without limitation alkyl or other hydrocarbyl), phosphono (—P(O)(OH)₂), phospho (—PO₂), phosphino (—PH₂), silyl (—SiR₃ wherein R is H, hydrocarbyl or C₁-C₆ alkoxy), and silyloxy (—O-silyl); hydrocarbyl moieties C₁-C₂₄ alkyl (preferably C₁-C₁₂ alkyl, more preferably C₁-C₆ alkyl), C₂-C₂₄ alkenyl (preferably C₂-C₁₂ alkenyl, more preferably C₂-C₆ alkenyl), C₂-C₂₄ alkynyl (preferably C₂-C₁₂ alkynyl, more preferably C₂-C₆ alkynyl), C₅-C₂₄ aryl (preferably C₆-C₁₀ aryl), C₆-C₂₄ alkaryl (preferably C₆-C₁₆ alkaryl), or C₆-C₂₄ aralkyl (preferably C₆-C₁₆ aralkyl). The hydrocarbyl, alkyl and aryl groups in the above moieties may themselves be substituted.

By “functionalized” as in “functionalized hydrocarbyl,” “functionalized alkyl,” “functionalized olefin,” “functionalized cyclic olefin,” and the like, is meant that in the hydrocarbyl, alkyl, olefin, cyclic olefin, or other moiety, at least one H atom bound to a carbon (or other) atom is replaced with one or more functional group(s) such as those described hereinabove. The term “functional group” is meant to include any functional species that is suitable for the uses described herein. In some cases, the terms “substituent” and “functional group” are used interchangeably.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present on a given atom, and thus, the description includes structures wherein a non-hydrogen substituent is present and structures wherein a non-hydrogen substituent is not present.

The term “nil” as used herein, means absent or nonexistent.

The term “sulfhydryl” as used herein, represents a group of formula “—SH.”

The term “hydroxyl” as used herein, represents a group of formula “—OH.”

The term “carbonyl” as used herein, represents a group of formula “—C(O)—.”

The term “ketone” as used herein, represents an organic compound having a carbonyl group linked to a carbon atom such as —C(O)R^{x1}, wherein R^{x1} can be alkyl, aryl, cycloalkyl, cycloalkenyl, heterocycle as defined above.

Unless otherwise specified, the term “ester” as used herein, represents an organic compound having a carbonyl group linked to a carbon atom such as —C(O)OR^{x1} wherein R^{x1} can be alkyl, aryl, cycloalkyl, cycloalkenyl, heterocycle as defined above.

The term “amine” as used herein, represents a group of formula “—NR^{x}R^{y},” wherein R^{x} and R^{y} can be the same or independently H, alkyl, aryl, cycloalkyl, cycloalkenyl, heterocycle as defined above.

The term “carboxyl” as used herein, represents a group of formula “—C(O)O—.”

The term “sulfonyl” as used herein, represents a group of formula “—SO₂.”

The term “sulfate” as used herein, represents a group of formula “—O—S(O)₂—O—.”

The term “sulfonate” as used herein, represents a group of the formula “—S(O)₂—O—.”

The term “amide” as used herein, represents a group of formula “—C(O)NR^{x}R_{y},” wherein R^{x} and R^{y} can be the same or independently H, alkyl, aryl, cycloalkyl, cycloalkenyl, heterocycle as defined above.

The term “sulfonamide” as used herein, represents a group of formula “—S(O)₂NR^{x}R^{y}” wherein R^{x} and R^{y} can be the same or independently H, alkyl, aryl, cycloalkyl, cycloalkenyl, heterocycle as defined above.

The term “sulfoxide” as used herein, represents a group of formula “—S(O)—.”

The term “phosphonic acid” as used herein, represents a group of formula “—P(O)(OH)₂.”

The term “phosphonate ester” as used herein, represents a group of formula “—P(O)(OR^{x1})₂,” wherein R^{x1} can be alkyl, aryl, cycloalkyl, cycloalkenyl, heterocycle as defined above.

The term “phosphoric acid” as used herein, represents a group of formula “—OP(O)(OH)₂.”

The term “phosphate ester” as used herein, represents a group of formula “—OP(O)(OR^{x1})₂,” wherein R^{x1} can be alkyl, aryl, cycloalkyl, cycloalkenyl, heterocycle as defined above.

The term “sulphonic acid” as used herein, represents a group of formula “—S(O)₂OH.”

The formula “H” as used herein, represents a hydrogen atom.

The formula “O” as used herein, represents an oxygen atom.

The formula “N” as used herein, represents a nitrogen atom.

The formula “S” as used herein, represents a sulfur atom.

Functional groups may be protected in cases where the functional group interferes with the olefin metathesis catalyst, and any of the protecting groups commonly used in the art may be employed. Acceptable protecting groups may be found, for example, in Greene et al., Protective Groups in Organic Synthesis, 5th Ed. (New York: Wiley, 2014). Examples of protecting groups include acetals, cyclic acetals, boronate esters (boronates), cyclic boronate esters (cyclic boronates), carbonates, or the like. Examples of protecting groups include cyclic acetals or cyclic boronate esters.

The terms “coating” as used herein, refers to a substance temporarily or permanently applied to a surface or substrate for decorative purpose, to impart a function on a surface or substrate such as electrical passivity or conductivity, or to protect the surface or substrate from deterioration or degradation as a result of its reaction with the environment or corrosive agents. In particular, the coatings in this invention are suitable for industrial coatings such as protective coatings and particularly anti-corrosion coatings. Coatings may be applied as liquids, gases (vapor deposition) or solids.

The term “adhesive” or “adhesive composition” as used herein refers to a substance applied between two substrates to create a bond or joint.

Unless otherwise specified, the term “adhesion promoter” as used herein, refers to an additive or a primer which promotes adhesion of coatings to the substrate of interest. An adhesion promoter usually has an affinity for the substrate and the applied coating.

The term “dispersant” as used herein, refers to agents able to prevent settling or clump and is used interchangeably with “dispersing agent.”

The term “antioxidant” is used herein interchangeably with the terms “antiozonant” and is one type of a “stabilizer.”

An “interpenetrating polymer network” or “IPN” means a combination of two or more polymers in network form that are synthesized in juxtaposition. Most IPNs do not interpenetrate on a molecular scale, but form divided phases of nanometer size. Many IPNs exhibit dual phase continuity, which means that two or more polymers in the system form phases that are continuous on a macroscopic scale.

A “semi-interpenetrating polymer network” or “SIPN” means a polymer comprising one or more networks and one or more linear or branched polymer(s) characterized by the penetration on a molecular scale of at least one of the networks by at least some of the linear or branched macromolecules. Semi-interpenetrating polymer networks are distinguished from interpenetrating polymer networks because the constituent linear or branched polymers can, in principle, be separated from the constituent polymer network(s) without breaking chemical bonds; they are polymer blends.

### Hybrid Compositions of the Invention

The invention relates to hybrid compositions comprising, consisting essentially of, or consisting of:
a) at least one cyclic olefin monomer composition comprising, consisting essentially of, or consisting of:
   a1) at least one cyclic olefin monomer;
   a2) optionally, at least one linear monomer;
   a3) at least one olefin metathesis catalyst; and
   a4) optionally, at least one additive;
b) at least one resin composition polymerizable by addition or condensation polymerization; and
c) optionally, at least one additive; wherein components a) and/or b) are optionally crosslinked.

If one or both of a) and b) are crosslinked, the hybrid composition may comprise, consist essentially of, or consists of an interpenetrating polymer network (IPN) or a semi-interpenetrating prepolymer network (SIPN) of the at least one cyclic olefin monomer composition and the at least one resin composition polymerizable by addition or condensation polymerization.

If the hybrid compositions forms an IPN, an example of an IPN is a sequential interpenetrating polymer network, which is prepared by a process in which the second component network is formed following the formation of the first component network.

If the hybrid compositions forms an SIPN, an example of an SIPN is a sequential semi-interpenetrating polymer network, which is prepared by a process in which the linear or branched components are formed following the completion of the reactions that lead to the formation of the network(s) or vice versa.

Components a), b), and, if present, c) may also form a homogeneous mixture. If needed, a solvent (e.g., ethyl acetate, n-butyl acetate, and methyl amyl ketone) or a compatibilizer can be used to attain a homogeneous mixture of components a), b), and, if present, c).

The at least one cyclic olefin monomer composition may be present in the hybrid composition in an amount ranging from about 0.1-99.9 wt. % (e.g., about 0.5-99.5 wt. %, 1-99 wt. %, 5-95 wt. %, 10-90 wt. %, 20-80 wt. %, 30-70 wt. %, 40-60 wt. %, 45-55 wt. %) or about 50 wt. %, based on the total weight of the hybrid composition, and

the at least one resin composition polymerizable by addition or condensation polymerization may be present in the hybrid composition in an amount ranging from about 99.9-0.1 wt. % (e.g., about 99.5-0.5 wt. %, 99-1 wt. %, 95-5 wt. %, 90-10 wt. %, 80-20 wt. %, 70-30 wt. %, 60-40 wt. %, 55-45 wt. %) or about 50 wt. %, based on the total weight of the hybrid composition.

### Cyclic Olefin Monomers

In general, any cyclic olefin monomer suitable for the reactions disclosed herein may be used in the present invention. Such cyclic olefins may be optionally substituted, optionally heteroatom-containing, mono-unsaturated, di-unsaturated, or poly-unsaturated C₅ to C₂₄ hydrocarbons, that may be mono-, di-, or poly-cyclic. When the cyclic olefin comprises more than one ring, the rings may or may not be fused.

The cyclic olefin may generally be any strained or unstrained cyclic olefin, provided the cyclic olefin is able to participate in a polymerization reaction either individually or as part of a cyclic olefin composition.

The cyclic olefin may be represented by the structure of Formula (I):

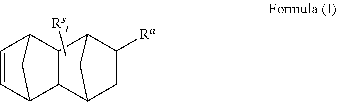

wherein:
R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(OR^{m})(ORⁱ), —C(R^{h})(Rⁱ)C(O)NR^{o}R^{p}, C(R^{h})(Rⁱ)C(O)NR^{o}ORⁿ;
each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, —C(R^{h})(Rⁱ)C(O)NR^{o}ORⁿ;
t is 0, 1, 2, 3, 4, 5 or 6;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)—(optionally substituted C₅₋₂₄ aryl), —C(O)—(optionally substituted linear or branched C₂₋₂₄ alkenyl), or optionally substituted C₃₋₁₂ cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{k} is optionally substituted linear or branched C₁₋₂₄ alkyl, optionally substituted linear or branched C₂₋₂₄ alkenyl, optionally substituted C₃₋₁₀ cycloalkyl, optionally substituted heterocycle, optionally substituted C₅₋₂₄ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{m} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{o} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl; and
R^{p} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl.

The cyclic olefin may be represented by Formula (I) wherein:
R^{a} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), an optionally substituted spiro heterocycle, optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁱ), —C(R^{h})(Rⁱ)C(O)NR^{o}R^{p}, C(R^{h})(Rⁱ)C(O)NR^{o}ORⁿ;
each R^{s} is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, —C(R^{h})(Rⁱ)C(O)NR^{o}ORⁿ;
t is 0, 1, 2, 3 or 4;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)—(optionally substituted C₆₋₁₀ aryl), —C(O)—(optionally substituted linear or branched C₂₋₁₂ alkenyl), or optionally substituted C₅₋₁₂ cycloalkenyl;
R^{h} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{k} is optionally substituted linear or branched C₁₋₁₂ alkyl, optionally substituted linear or branched C₂₋₁₂ alkenyl, optionally substituted C₃₋₈ cycloalkyl, optionally substituted heterocycle, optionally substituted C₆₋₁₀ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
R^{l} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{m} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁿ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{o} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl; and
R^{p} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl.

The cyclic olefin may also be represented by Formula (I) wherein:
R^{a} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₇ cycloalkenyl);
t is 0;
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl;
R^{s} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)—(optionally substituted C₆₋₁₀ aryl), —C(O)—(optionally substituted linear or branched C₂₋₆ alkenyl), or optionally substituted C₅₋₁₂ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl.

Depending on the position of R^{s} on the tetracyclododeca-3-ene moiety, the cyclic olefin monomer of Formula (I), can be of structure

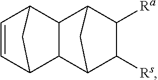

wherein: t is 1, R^{a} and R^{s} are as defined herein; and R^{a} and R^{s} can form an optionally substituted polycyclic ring with the rest of the molecule.

The cyclic olefin may further be represented by Formula (I) wherein: R^{a} is

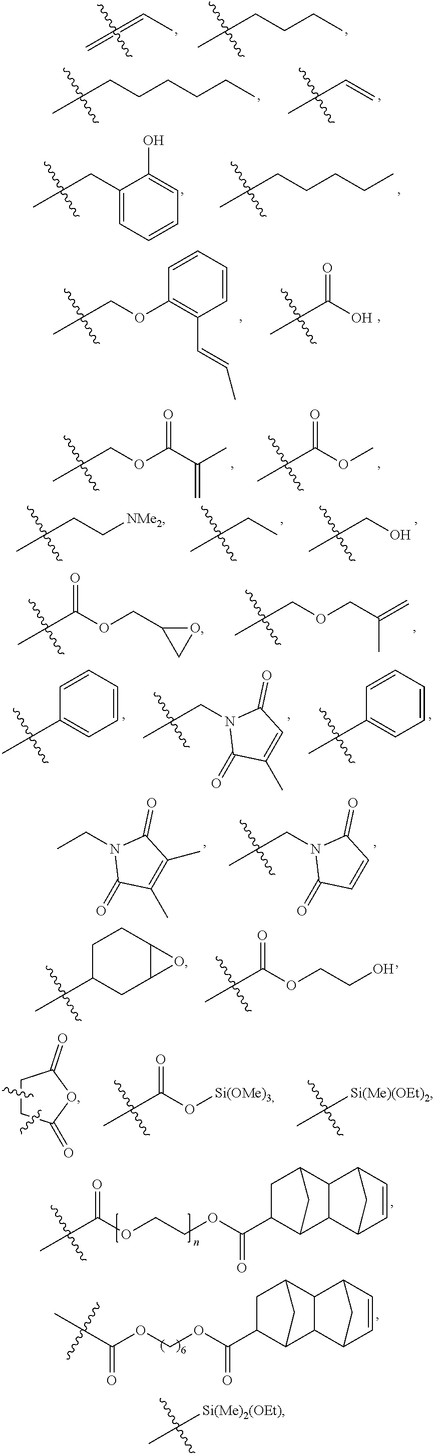

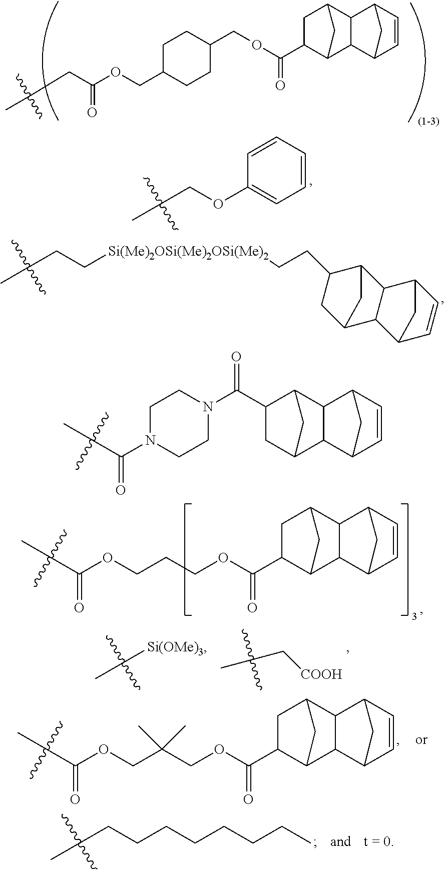

Non-limiting examples of monomers of Formula (I) can be represented by:

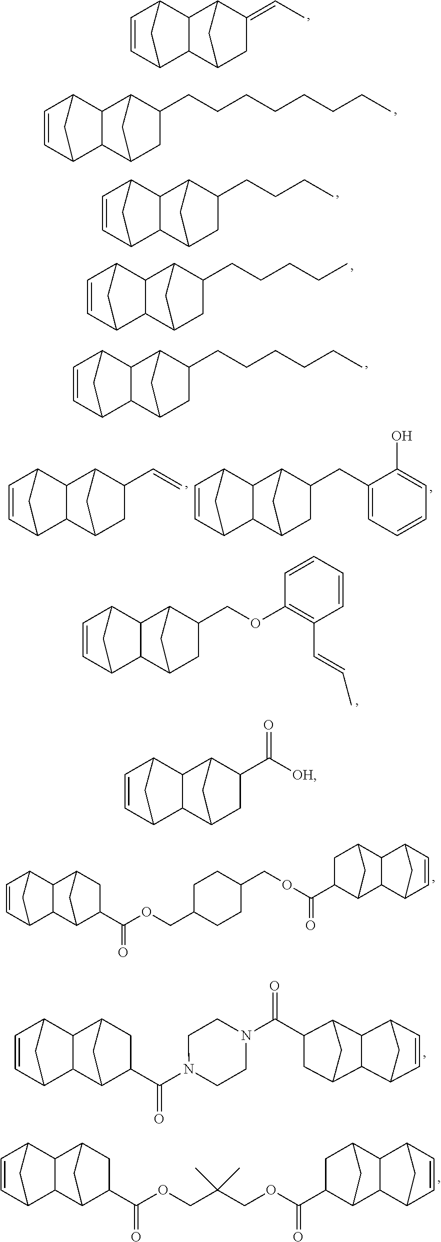

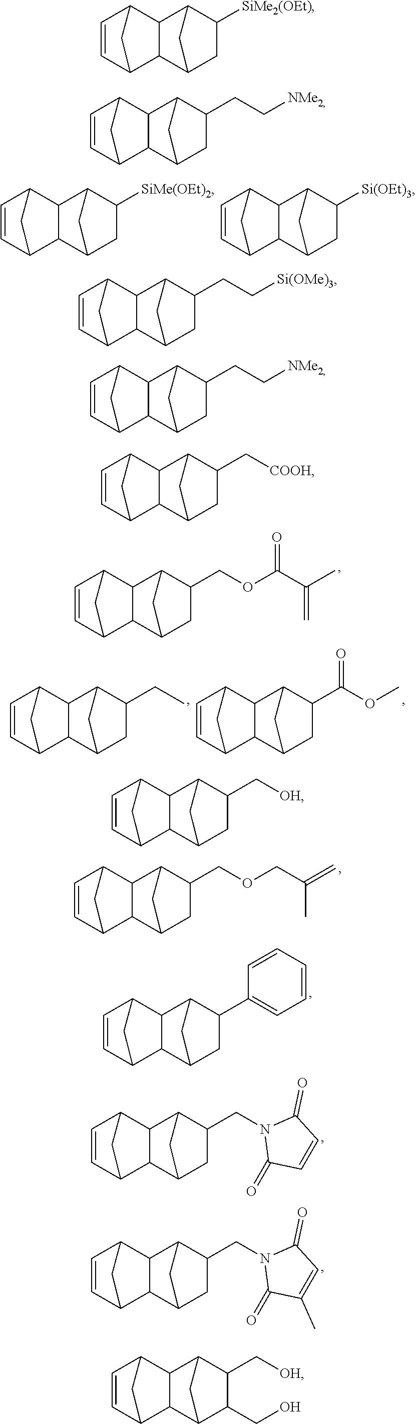

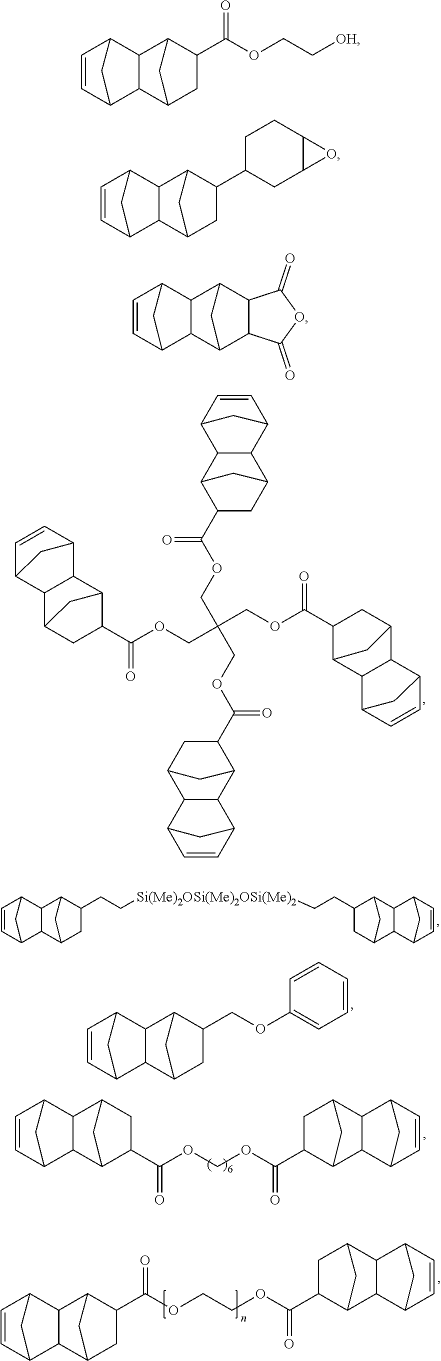

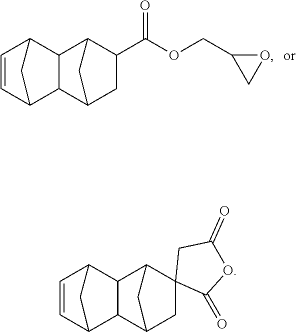 [SMILES: O=C(OCC1CO1)C1CC2CC1C1C3C=CC(C3)C21 ; O=C1CC2(CC3CC2C2C4C=CC(C4)C32)C(=O)O1]

The cyclic olefin may also be represented by the structure of Formula (II):

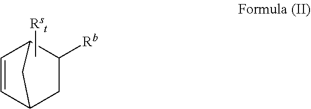

wherein:
R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —Si(OR^{k})₃, —S(O)₂OR^{h}, —OS(O)₂R^{h}, optionally substituted heterocycle, an optionally substituted spiro heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁱ), —C(R^{h})(Rⁱ)C(O)NR^{o}R^{p}, —C(R^{h})(Rⁱ)C(O)NR^{o}ORⁿ;
each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR), —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, —C(R^{h})(Rⁱ)C(O)NR^{o}ORⁿ;
t is 0, 1, 2, 3, 4, 5 or 6;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)—(optionally substituted C₅₋₂₄ aryl), —C(O)—(optionally substituted linear or branched C₂₋₂₄ alkenyl), or optionally substituted C₃₋₁₂ cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{k} is optionally substituted linear or branched C₁₋₂₄ alkyl, optionally substituted linear or branched C₂₋₂₄ alkenyl, optionally substituted C₃₋₁₀ cycloalkyl, optionally substituted heterocycle, optionally substituted C₅₋₂₄ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
R^{l} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{m} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl;
R^{o} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl; and
R^{p} is H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl.

The cyclic olefin may be represented by the structure of Formula (II) wherein:
R^{b} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{h}, CN, NO₂, —CF₃, —P(O)(OR)₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁱ), —C(R^{h})(Rⁱ)C(O)NR^{o}R^{p}, —C(R^{h})(Rⁱ)C(O)NR^{o}ORⁿ;
each R^{s} is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR), —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, —C(R^{h})(Rⁱ)C(O)NR^{o}ORⁿ;
t is 0, 1, 2, 3 or 4;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)—(optionally substituted C₆₋₁₀ aryl), —C(O)—(optionally substituted linear or branched C₂₋₁₂ alkenyl), or optionally substituted C₅₋₁₂ cycloalkenyl;
R^{h} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{k} is optionally substituted linear or branched C₁₋₁₂ alkyl, optionally substituted linear or branched C₂₋₁₂ alkenyl, optionally substituted C₃₋₈ cycloalkyl, optionally substituted heterocycle, optionally substituted C₆₋₁₀ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
R^{l} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{m} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
Rⁿ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{o} is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl; and
R^{p} is H, optionally substituted linear or branched C₁₋₁₂ alkyl, optionally substituted C₅₋₇cycloalkyl, optionally substituted heterocycle, optionally substituted C₆₋₁₀ aryl or optionally substituted C₅₋₁₂ cycloalkenyl.

The cyclic olefin may also be represented by Formula (II) wherein:
R^{b} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl);
t is 0;
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl;
R^{g} is H, optionally substituted linear or branched C₁₋₆ alkyl, optionally substituted C₅₋₇cycloalkyl, optionally substituted heterocycle, optionally substituted C₆₋₁₀ aryl, optionally substituted linear or branched C₂₋₆ alkenyl, —C(O)—(optionally substituted C₆₋₁₀ aryl), —C(O)—(optionally substituted linear or branched C₂₋₆ alkenyl), or optionally substituted C₅₋₁₂ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl or optionally substituted C₅₋₁₂ cycloalkenyl.

Depending on the position of R^{s} on the 2-norbornene moiety, the cyclic olefin monomer of structure Formula (II), can be represented by

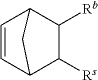

wherein: t=1, R^{s} and R^{b} are as defined herein; and R^{s} and R^{b} can form together an optionally substituted polycyclic structure with the rest of the molecule.

The cyclic olefin may also be represented by Formula (II) wherein: R^{b} is

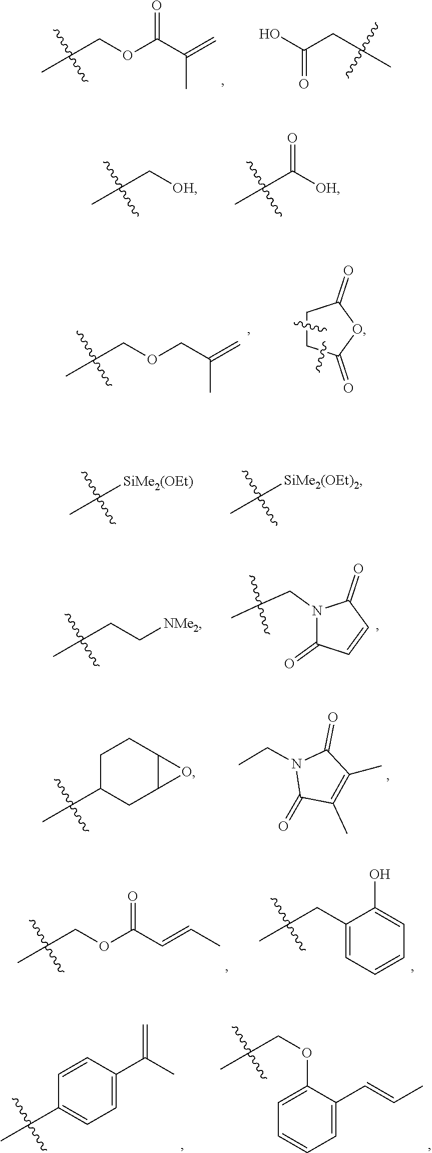

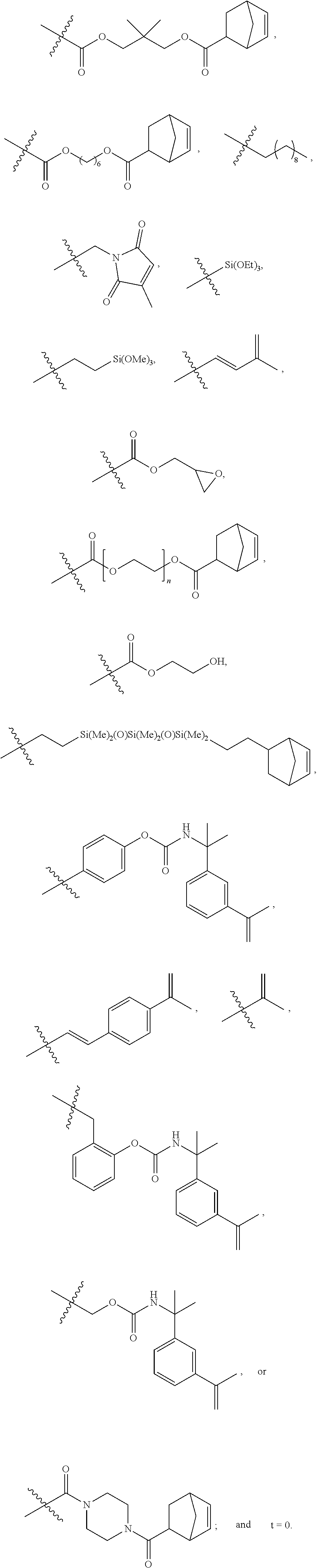

Non-limiting examples of monomers of Formula (II) can be represented by

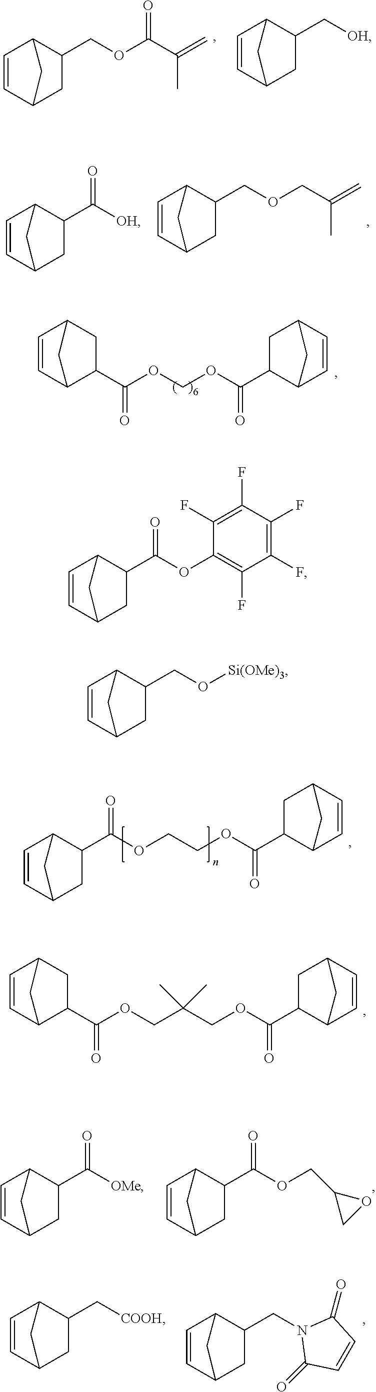

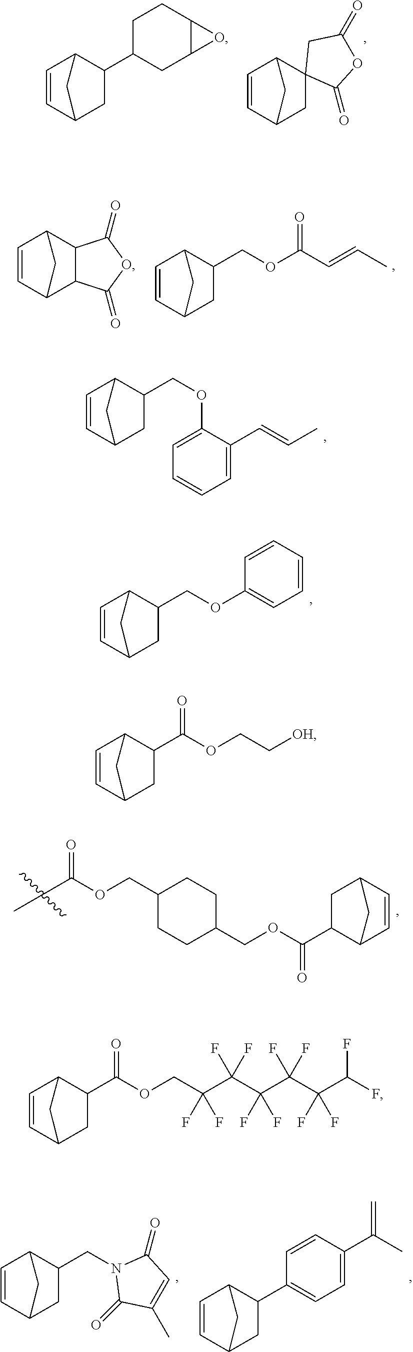

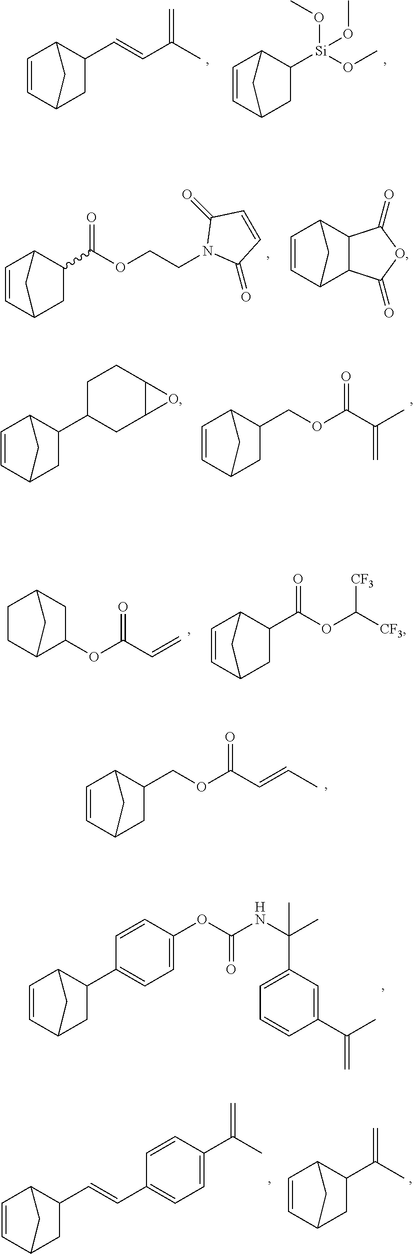

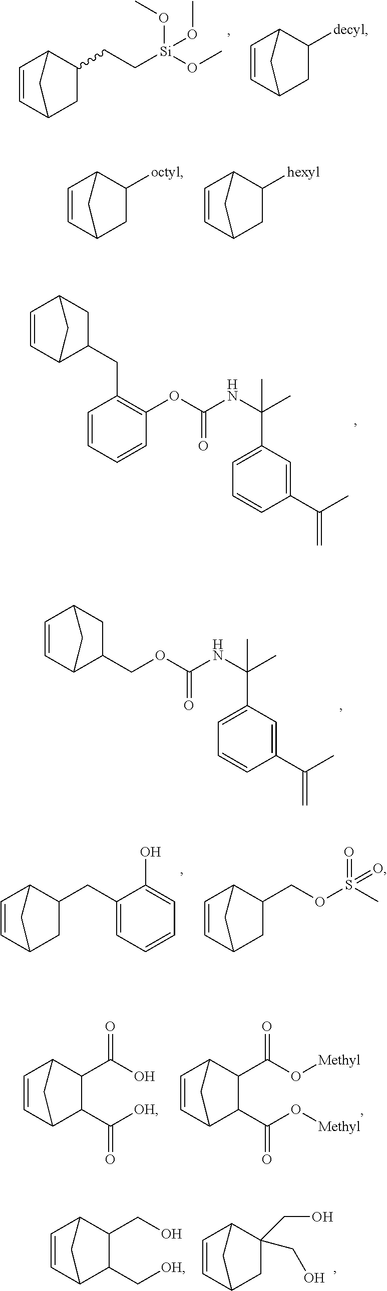

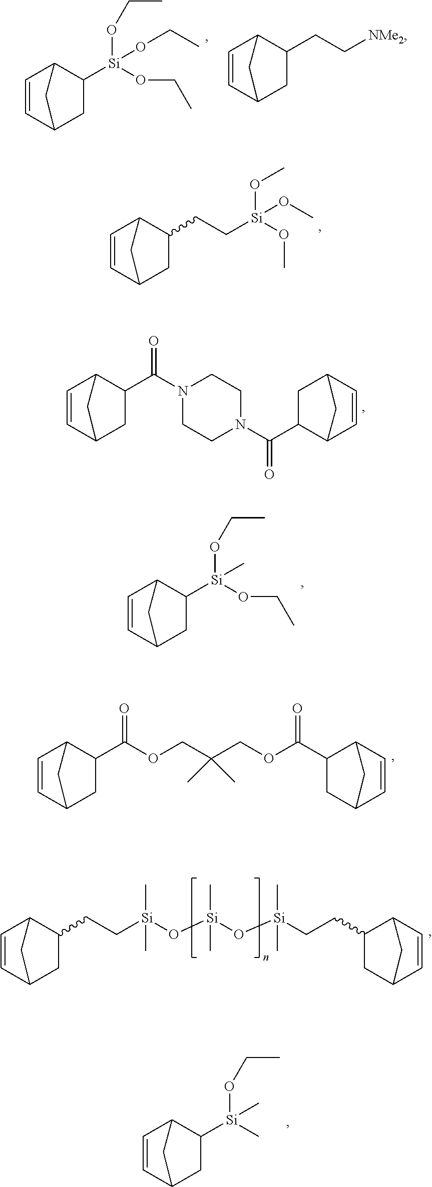

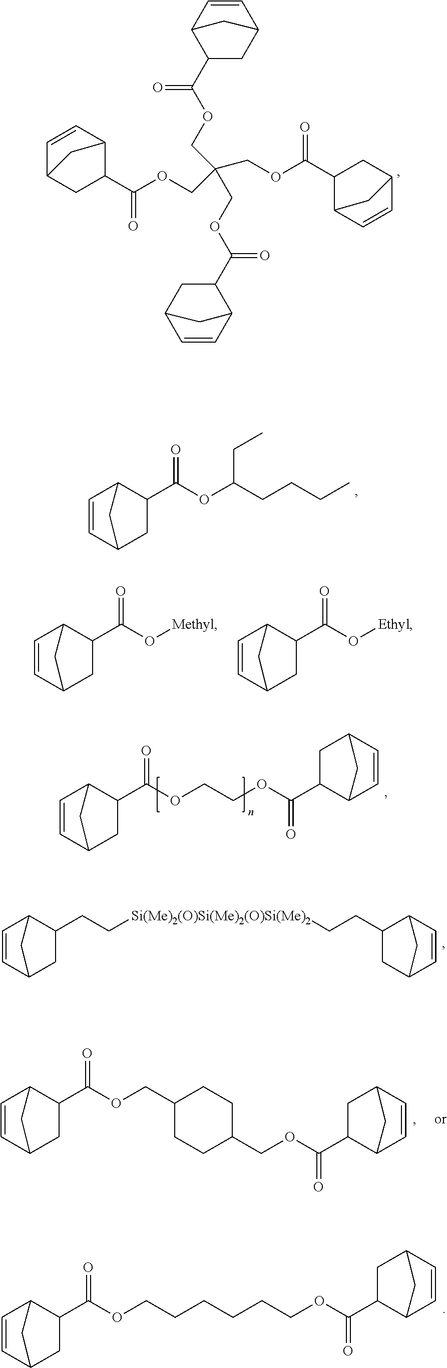

The cyclic olefin may also be represented by the structure of Formula (IN):

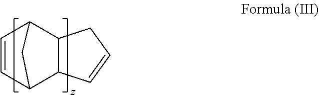

wherein z is 0, 1, 2 or 3.

The cyclic olefin may be represented by the structure of Formula (MI), wherein z is 1 or 2.

The cyclic olefin may be represented by the structure of Formula (MI), wherein z is 2.

Non-limiting examples of monomers of Formula (IN) can be represented by:

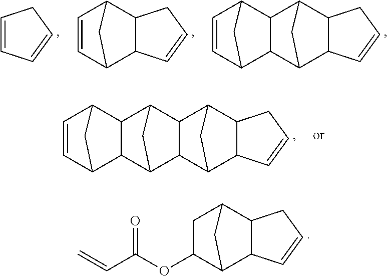

The cyclic olefin may also be represented by the structure of Formula (V):

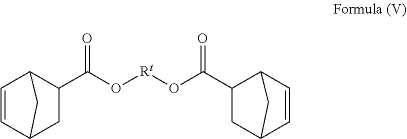

wherein:

Rt is an optionally substituted linear or branched C₁-C₁₂ alkyl, —(optionally substituted linear or branched C₁-C₆ alkyl)-R^{u}-(optionally substituted linear or branched C₁-C₆ alkyl)-, or —(R^{v})—(R^{w})—(R^{x})—;
R^{u} is O, an optionally substituted C₃-C₁₀-cycloalkyl, optionally substituted C₃-C₁₂ cycloalkenyl, optionally substituted heterocycle, or optionally substituted C₅-C₂₄ aryl;
R^{v} and R^{x} are independently selected from—(optionally substituted linear or branched C₁-C₁₂ alkyl)-aryl-, wherein one or more of the carbon atoms in the C₁-C₁₂ alkyl may be replaced by O; and R^{w} is optionally substituted linear or branched C₁-C₆ alkyl.

Non-limiting examples of monomers of Formula (V) can be represented by

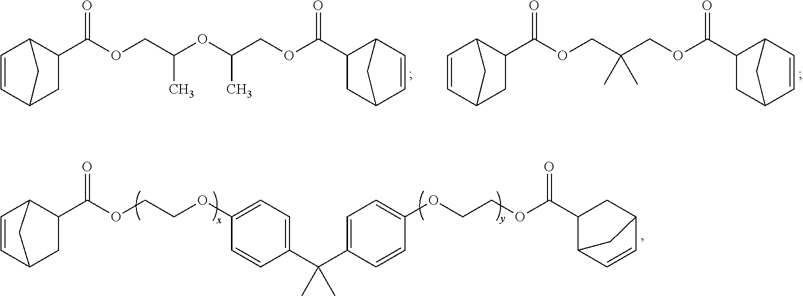

wherein x and y are independently 0, 1, 2, or 3 and the value of x+y is 3;

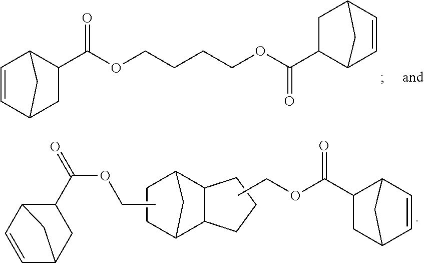

The cyclic olefin may also be represented by the structure of Formula (VI):

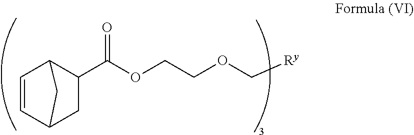

wherein R^{y} is optionally substituted linear or branched C₁-C₆ alkyl.

A non-limiting example of a monomer of Formula (VI) can be represented by

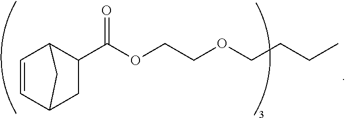

Examples of cyclic olefins thus include, without limitation, dicyclopentadiene; tricyclopentadiene, tetracyclopentadiene; norbornene; 5-isobutyl-2-norbornene; 5,6-dimethyl-2-norbornene; 5-phenyl-2-norbornene; 5-benzyl-2-norbornene; 5-acetyl-2-norbornene; 5-methoxycarbonyl-2-norbornene; 5-ethoxycarbonyl-2-norbornene; 5-methyl-5-methoxycarbonyl-2-norbornene; 5-cyano-2-norbornene; 5,5,6-trimethyl-2-norbornene; endo,exo-5,6-dimethoxy-2-norbornene; endo,endo-5,6-dimethoxy-2-norbornene; endo, exo-5-6-dimethoxycarbonyl-2-norbornene; endo,endo-5,6-dimethoxycarbonyl-2-norbornene; norbornadiene; tricycloundecene; tetracyclododecene; 8-methoxycarbonyl-tetracyclododecene; 8-cyanotetracyclododecene; C₁-C₁₂ hydrocarbyl substituted norbornenes such as 5-methyl-2-norbornene; 5-ethyl-2-norbornene; 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like; C₂-C₁₂ hydrocarbyl substituted tetracyclododecenes such as 8-methyl-tetracyclododeca-3-ene; 8-ethyl-tetracyclododeca-3-ene; 8-butyl-tetracyclododeca-3-ene; 8-hexyl-tetracyclododeca-3-ene; 8-octyl-2-tetracyclododeca-3-ene; 8-decyl-2-tetracyclododeca-3-ene; 8-dodecyl-2-tetracyclododeca-3-ene; 8-vinyl-tetracyclododeca-3-ene; 8-ethylidene-2-tetracyclododeca-3-ene; 8-isopropenyl-tetracyclododeca-3-ene; 5-propenyl-tetracyclododeca-3-ene; 5-butenyl-tetracyclododeca-3-ene.

Preferably, the cyclic olefin monomer is selected from the group consisting of the cyclic olefin monomer of formula (I) is tetracyclododecene (TCD), 2-ethylidene-1,2,3,4,4a,5,8,8a-octahydro-1,4:5,8-dimethanonaphthalene (ENB-DDA), 2-hexyl-1,2,3,4,4a,5,8,8a-octahydro-1,4:5,8-dimethanonaphthalene (HNB-DDA), and a mixture thereof; the cyclic olefin monomer of formula (II) is 5-ethylidene-2-norbornene (ENB), 5-octyl-2-norbornene (ONB), 2-hydroxyethyl bicyclo[2.2.1]hept-5-ene-2-carboxylate (HENB), 5-carboxylic acid-2-norbornene ethyl ester, carbamic acid, [3-(triethoxysilyl) propyl]-bicyclo[2.2.1]hept-5-en-2-ylmethyl ester (NBCbSi), 5-norbornene-2-methanol (NB-methanol), 5-norbornene-2-exo,3-exo-dimethanol (NB-dimethanol), 2-hydroxyethyl bicyclo[2.2.1]hept-5-ene-2-carboxylate (NB-epoxide), norbornene triethoxy silane (NB-triethoxysilane), 5-(perfluorobutyl) bicyclo[2.2.1]hept-2-ene (NB-Fluorocarbon (1)), bicyclo[2.2.1]hept-5-ene-2-carboxylic acid, 1,1,2,2,3,3,4,4,5,5,6,6-dodecafluorohexyl ester (NB-fluorocarbon (2)), bicyclo[2.2.1]hept-5-ene-2-carboxylic acid, 2,2,2-trifluoro-1-(trifluoromethyl)ethyl ester (NB-fluorocarbon (3)), and a mixture thereof; and the cyclic olefin monomer of formula (III) is dicyclopentadiene (DCPD), tricyclopentadiene (TCPD), tetracyclopentadene (TeCPD), or a mixture thereof.

Even more preferably, the cyclic olefin monomer is selected from the group consisting of the cyclic olefin monomer of Formula (II) is 5-ethylidene-2-norbornene (ENB), 5-octyl-2-norbornene (ONB), or a mixture thereof; and the cyclic olefin monomer of Formula (III) is dicyclopentadiene (DCPD), tricyclopentadiene (TCPD), tetracyclopentadene (TeCPD), or a mixture thereof. Preferably, the cyclic olefin monomer of formula (III) is dicyclopentadiene (DCPD) and tricyclopentadiene (TCPD) and the ratio of DCPD: TCPD ranges from 30:70 to 70:30 (e.g., 35:65, 40:60, 43:57, 45:55, 50:50, 55:45, 57:43, 60:40, 65:35).

It is well understood by one of skill in the art that bicyclic and polycyclic olefins as disclosed herein may consist of a variety of structural isomers and/or stereoisomers, any and all of which are suitable for use in the present invention. Any reference herein to such bicyclic and polycyclic olefins unless specifically stated, includes mixtures of any and all such structural isomers and/or stereoisomers.

### Linear Olefin Monomers

The linear olefin monomers, if present in the invention, may be represented by the structure of Formula (IV) in which Re and Rd may be in a cis or trans configuration:

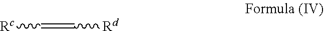

wherein:
R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁱ), —C(R^{h})(Rⁱ)C(O)NR^{o}R^{p}, or —C(R^{h})(Rⁱ)C(O)NR^{o}ORⁿ;
R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR)₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(OR^{m})(ORⁿ), —C(R^{h})(Rⁱ)C(O)NR^{o}R^{p}, or —C(R^{h})(Rⁱ)C(O)NR^{o}ORⁿ;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)—(optionally substituted C₅₋₂₄ aryl), —C(O)—(optionally substituted linear or branched C₂₋₂₄ alkenyl), or optionally substituted C₃₋₁₂cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl; and
R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl.

The linear olefin monomers may also be represented by the structure of Formula (IV) wherein:
R^{c} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR, —C(R^{h})(Rⁱ)C(O) H, —C(R^{h})(Rⁱ)C(O)R^{k}, —C(R^{h})(Rⁱ)CRⁱ(OR^{m})(ORⁱ), —C(R^{h})(Rⁱ)C(O)NR^{o}R^{p}, or —C(R^{h})(Rⁱ)C(O)NR^{o}ORⁿ;
R^{d} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR)₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂—(optionally substituted C₅₋₁₂ cycloalkenyl), C(R^{h})(Rⁱ)COORⁱ, —C(R^{h})(Rⁱ)C(O) H, —C(R^{h})(Rⁱ)C(O)R^{k}, C(R^{h})(Rⁱ)CRⁱ(ORⁿ)(ORⁿ), —C(R^{h})(Rⁱ)C(O)NR^{o}R^{p}, or —C(R^{h})(Rⁱ)C(O)NR^{o}ORⁿ;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)—(optionally substituted C₆₋₁₀ aryl), —C(O)—(optionally substituted linear or branched C₂₋₁₂ alkenyl), or optionally substituted C₅₋₁₂ cycloalkenyl;
R^{h} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
Rⁱ is H, optionally substituted linear or branched C₁₋₁₂ alkyl, optionally substituted C₅₋₇ cycloalkyl, optionally substituted heterocycle, optionally substituted C₆₋₁₀ aryl or optionally substituted C₅₋₁₂ cycloalkenyl;
R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{l} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{m} is H, optionally substituted linear or branched C₁₋₁₂ alkyl, optionally substituted C₅₋₇cycloalkyl, optionally substituted heterocycle, optionally substituted C₆₋₁₀ aryl, or optionally substituted C₅₋₁₂ cycloalkenyl;
Rⁿ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{o} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{p} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl.

The linear olefin monomers may further be represented by Formula (IV) wherein:
R^{c} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, or —CH₂-(optionally substituted C₅₋₁₂ cycloalkenyl);
R^{a} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, or —CH₂-(optionally substituted C₅₋₁₂ cycloalkenyl);
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₆ alkyl, optionally substituted C₅₋₇cycloalkyl, optionally substituted heterocycle, optionally substituted C₆₋₁₀ aryl, optionally substituted linear or branched C₂₋₆ alkenyl, —C(O)—(optionally substituted C₆₋₁₀ aryl), —C(O)—(optionally substituted linear or branched C₂₋₆ alkenyl), or optionally substituted C₅₋₇ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl.

The linear olefin monomers may be represented by Formula (IV) wherein:

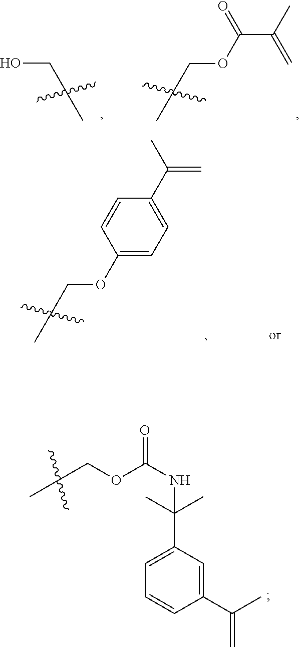

R^{o} is H,

### and R^{d} is

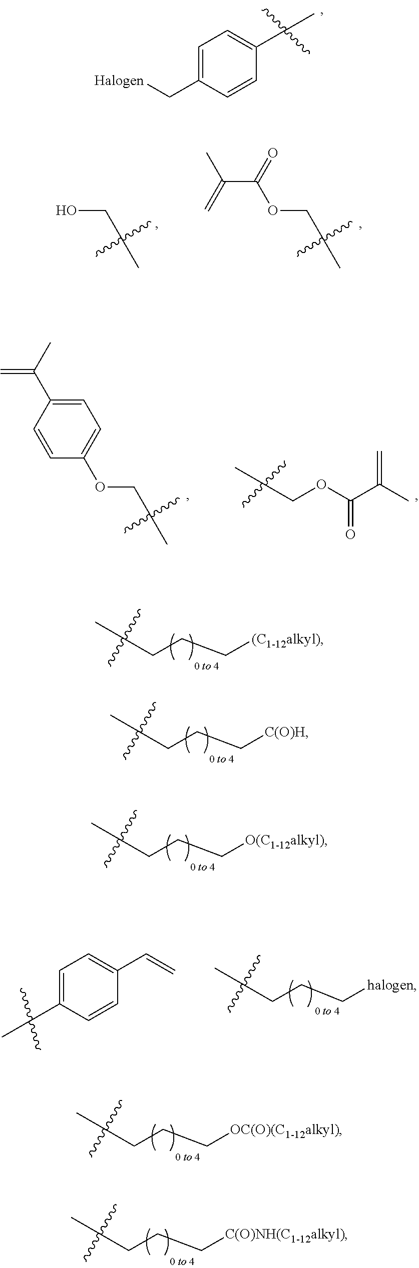

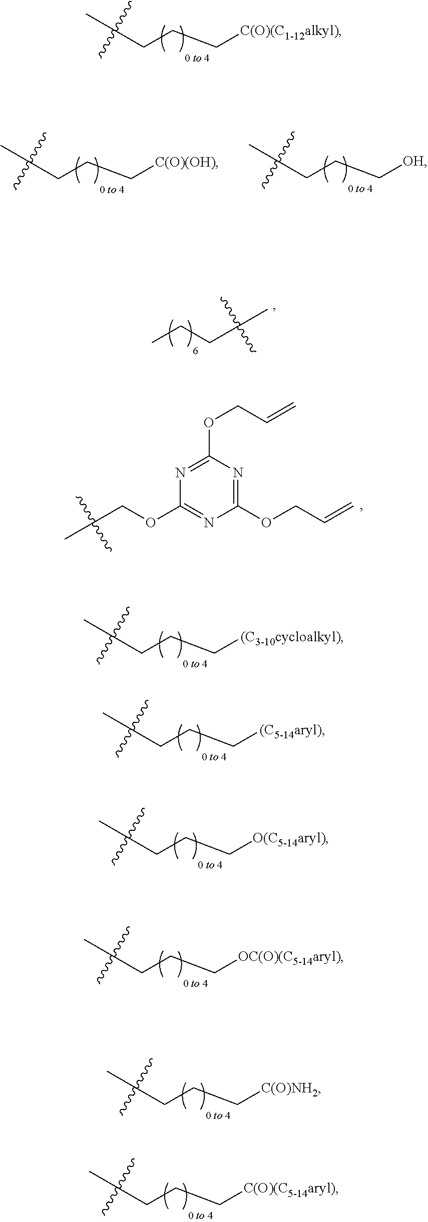

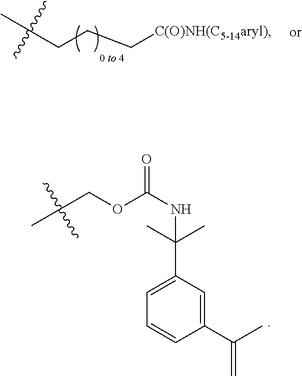

Non-limiting examples of Formula (IV) can be represented by

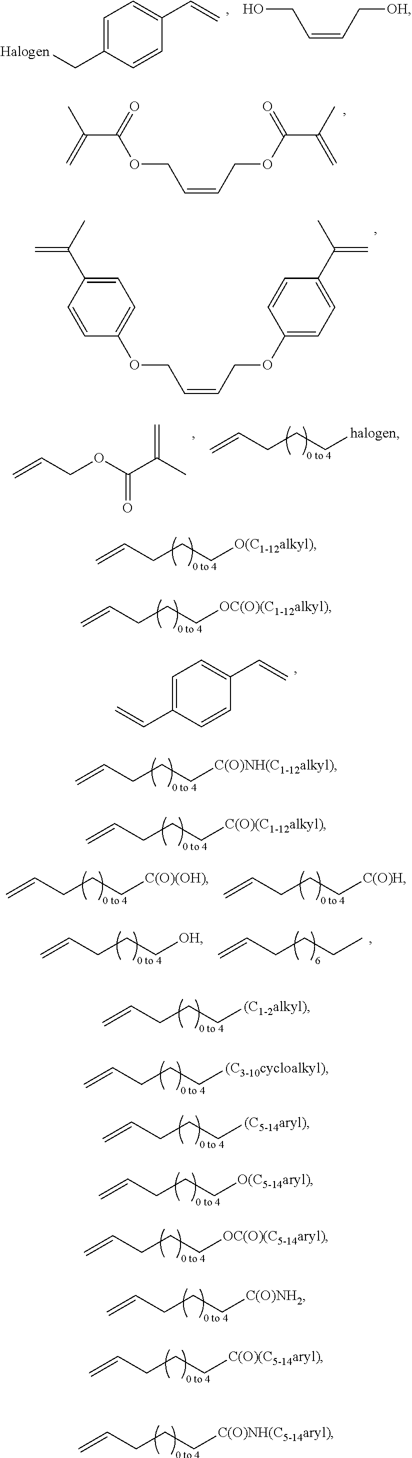

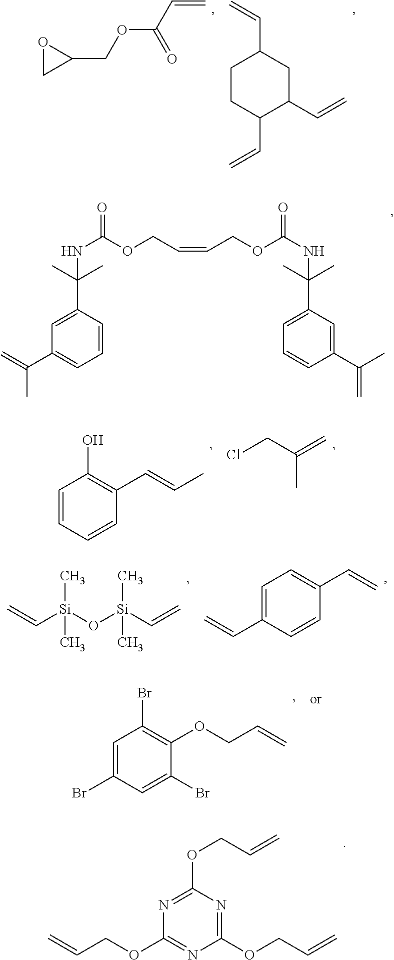

The cyclic olefin monomer composition of the invention may as the olefinic component comprise, consist essentially or, or consist of at least one cyclic olefin monomer selected from the group consisting of Formulae (I) and (II); Formulae (I) and (III); Formulae (I) and (V); Formulae (I) and (VI); Formulae (II) and (III); Formulae (II) and (V); Formulae (II) and (VI); Formulae (III) and (V); Formulae (III) and (VI); Formulae (V) and (VI); Formulae (I), (II), and (III); Formulae (I), (II), and (V); Formulae (I), (II), and (VI); Formulae (II), (III), and (V); Formulae (II), (III), and (VI); Formulae (III), (V), and (VI); Formulae (I), (II), (III), and (V); Formulae (I), (II), (III), and (VI); or Formulae (II), (III), (V), and (VI). A cyclic olefin monomer composition of the invention may contain only cyclic olefin monomers of Formula (I), (II), (III), (V), (VI), or mixtures thereof, or as just mentioned, may contain at least one particular cyclic olefin monomer selected from one of Formula (I), (II), (III), (V), and (VI) but not contain a linear olefin monomer of Formula (IV). In a cyclic olefin monomer composition of the invention, the olefinic component may comprise, consist essentially or, or consist of, 0-100%, preferably 25-100%, most preferably 50-100% or 70-85% of at least one cyclic olefin monomer of Formula (I); 0-100%, preferably 20-80% or 15-50% of at least one cyclic olefin monomer of Formula (II); 0-100%, preferably 10-80% or 20-75% of at least one cyclic olefin monomer of Formula (III); 0-100%, preferably 10-80% or 20-75% of at least one cyclic olefin monomer of Formula (V); 0-100%, preferably 10-80% or 20-75% of at least one cyclic olefin monomer of Formula (VI); and 0-20%, preferably 0-10% or 1-5% of at least one linear olefin monomer of Formula (IV), such that the olefins making up the olefinic component add up to 100% of that component of a cyclic olefin monomer composition of the invention.

The linear olefin monomers may be optionally substituted, optionally heteroatom-containing, mono-unsaturated, or multi-unsaturated.

### Resin Composition Polymerizable by Addition or Condensation Polymerization

As discussed above, the at least one cyclic olefin monomer composition is formulated with at least one resin composition polymerizable by addition or condensation polymerization to form the hybrid compositions, in which the cyclic olefin monomer composition and/or the resin composition polymerizable by addition or condensation polymerization is crosslinked. The co-curing process can be either simultaneous or sequential and may form IPNs or SIPNs; for example, a co-cured polyurethane can form from a polyol and a diisocyanate; a co-cured epoxy can form from a bis —epoxide and a hardener such as an anhydride, amine, or thiol. Care should be taken when using chemistries that are known to inhibit ROMP. Copolymeric coatings may be formed if multifunctional monomers are incorporated; for example, isocyanate- or alcohol-containing olefinic comonomers can copolymerize urethanes with the hybrid compositions of the invention, and epoxide-containing comonomers can copolymerize epoxies with the hybrid compositions of the invention. Other polymers such as polysiloxanes, polyureas, and acrylics can be incorporated into the hybrid compositions of the invention.

Resin compositions polymerizable by addition or condensation polymerization include, but are not limited to, polyurethane formulations, epoxy resin formulations, inorganic silicone-ceramic formulations, silicone acrylic matrix formulations, polyaspartic resins, and mixtures thereof. In the context of this invention, the resin compositions polymerizable by addition or condensation polymerization cannot be the at least one cyclic olefin monomer composition, as defined herein.

The polyurethane formulations may comprise, consist essentially of, or consist of the reaction product of at least one polyol and at least one polyisocyanate. The polyol may be an acrylic polyol, a polyester polyol, a polycarbonate polyol, a polyether polyol, or mixtures thereof. The polyol may include polyol having at least two or three hydroxyl groups, such as ethylene glycol, 1,5-propanediol, 1,5-pentadiol, and glycerol. A mixture of polyols can also be used in making the polyurethane formulations. Polyester polyols can include those made from the melt polycondensation of polyfunctional acids with polyfunctional alcohols or those made from the ring opening polymerization of cyclic monomers such as epsilon-caprolactone. Examples of suitable polyester polyols include, for example, poly (caprolactone) polyols, poly (hexamethylene adipate), and the like. Examples of suitable polyether polyols include, for example, poly (ethylene glycol), poly (propylene glycol), poly (butylene glycol), poly (tetramethylene oxide), and the like. Acrylic polyols may be synthesized, typically by free radical polymerization, from a mixture of at least one hydroxy functional monomer plus one or more non-functional monomers. Suitable hydroxy-functional monomers include, for example, hydroxyethyl acrylate, hydroxyethyl methacrylate, hydroxypropyl acrylate, hydroxypropyl methacrylate, and the like. Examples of non-functional monomers include, for example, styrene, methyl methacrylate, methyl acrylate, butyl methacrylate, butyl acrylate, lauryl methacrylate, lauryl acrylate, 2-ethylhexyl acrylate, 2-ethyl hexyl methacrylate, and the like. The acrylic polyol may be synthesized in solution using a thermally-activated free radical initiator. The polyol can be synthesized in either a batch, semi-batch, or continuous process. Examples of free radical initiators are benzoyl peroxide, t-amyl peroxy-2-ethylhexanoate, t-butyl hydroperoxide, di-t-butyl peroxide, azobisisobutyronitrile, azobisisovaleronitrile, and the like. The acrylic polyol may be made by free radical polymerization and then diluted in a solvent, such as toluene, xylene, methylisobutyl ketone, and the like. The polyol may include a polycaprolactone polyol such as a polycaprolactone triol. Commercially-available polyols that may be used include, for example, JEFFOL® FE41-42 and JEFFOL® FX31-240.

Any suitable polyisocyanate may be used to make the polyurethane formulations, including aliphatic, cycloaliphatic, araliphatic, or aromatic polyisocyanates, either singly or in mixtures of two or more. Examples of useful aliphatic polyisocyanates include, but are not limited to, those selected from the group consisting of hexamethylene 1,6-diisocyanate (HDI), 1,5-pentanediisocyanate (PDI) 1,12-dodecane diisocyanate, 2,2,4-trimethyl-hexamethylene diisocyanate (TMDI), 2,4,4-trimethyl-hexamethylene diisocyanate (TMDI), 2-methyl-1,5-pentamethylene diisocyanate, dimer diisocyanate, the urea of hexamethyl diisocyanate, and mixtures thereof. Commercially available aliphatic polyisocyanates include, for example, PPG Amershield™ and PPG Amercoat® 450H. Examples of useful cycloaliphatic polyisocyanates include, but are not limited to, those selected from the group consisting of dicyclohexylmethane diisocyanate (H12 MDI, commercially available under the Desmodur® trademark from Covestro LLC (Bayer Materials Science), Leverkusen, Germany, isophorone diisocyanate (IPDI), 1,4-cyclohexane diisocyanate (CHDI), 1,4-cyclohexanebis(methylene isocyanate)(BDI), 1,3-bis(isocyanatomethyl)cyclohexane (H₆ XDI), and mixtures thereof. Examples of useful araliphatic polyisocyanates include but are not limited to those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, or mixtures thereof. Suitable aromatic polyisocyanates include, but are not limited to, those selected from the group consisting of 2,4-toluene diisocyanate, 2,6-toluene diisocyanate, a dimer of toluene diisocyanate (available under the Desmodur® trademark from Covestro LLC (formerly Bayer Materials Science), Leverkusen, Germany), diphenylmethane 4,4′-diisocyanate (MDI), 1,5-diisocyanato-naphthalene, 1,4-phenylene diisocyanate, 1,3-phenylene diisocyanate, fluorinated and/or silicone containing derivatives of the aforementioned, and mixtures thereof. Preferably, the polyisocyanate may be a polyfunctional resin derived from isocyanate or biuret selected from the group consisting of TDI (toluene diisocyanate), TDI biuret, MDI (diphenylmethane diisocyanate), MDI biuret, HDI (hexamethylene diisocyanate), HDI biuret, NDI (naphthalene diisocyanate), NDI biuret, HMDI (hydrogenated MDI), HMDI biuret, and IPDI (isophorone diisocyanate), and IPDI biuret. More preferably, the polyisocyanate is an HDI trimer.

Preferred polyurethane formulations include the reaction product of an HDI trimer and polyols selected from the group consisting of 1,5-pentadiol, 1,5-propanediol, and ethylene glycol, and the commercially-available polyols JEFFOL® FX31-240 and JEFFOL® FE41-42.

The epoxy resin that may be used includes, but is not limited to, helloxy-type systems, bis A/F systems, cycloaliphatic, etc., Novolac epoxies (DEN), phenolic epoxy. One commercially-available epoxy resin that may be used is EPON™ Resin 828.

The inorganic silicone-ceramic formulation that may be used includes, but is not limited to, those that are commercially-available, including PPG HI-TEMP 1027™. The silicone-ceramic formulations may also be formulated by mixing a silicone base with ceramic microspheres.

The silicone acrylic matrix formulation that may be used includes, but is not limited to, DOWSIL™ FA products (e.g., DOWSIL FA 4002 ID, 4003 ID, 4004 ID, 4001 CM, 4012 ID, and 4103). Another commercially-available silicone acrylic matrix formulation that may be used is PPG HI-TEMP™ 500.

The polyaspartic resin that may be used includes, but is not limited to, the commercially-available polyaspartic resins sold by Covestro LLC (e.g., aspartics Desmophen® NH 1220, 1420, 1422, 1423, 2850 XP, 1520, and 1521). For example, Covestro's commercially available aspartic Desmophen® NH 1520 may be reacted with various aliphatic polyisocyanates to form different combinations of aspartic resins that may be used in the invention. Examples of suitable polyaspartic resins that may also be used are described in U.S. Pat. Nos. 5,126,170; 5,236,741; 5,489,704; 5,243,012; 5,736,604; 6,458,293; 6,833,424; 7,169,876; and 2006/0247371, which are incorporated herein by reference.

### Olefin Metathesis Catalysts

The olefin metathesis catalysts that may be present in the at least one cyclic olefin monomer composition of the invention are represented by the general structure of Formula (1):

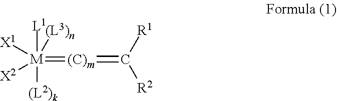

wherein:
M is a Group 8 transition metal; generally, M is ruthenium or osmium; typically, M is ruthenium;
L¹, L², and L³ are independently neutral electron donor ligands;
n is 0 or 1; typically, n is 0;
m is 0, 1, or 2; typically, m is 0;
k is 0 or 1; typically, k is 1;
X¹ and X² are independently anionic ligands; generally, x¹ and x² are independently halogen, trifluoroacetate, per-fluorophenols or together they can form a nitrate; typically, x¹ and X² are independently Cl, Br, I, or F; and
R¹ and R² are independently hydrogen, optionally substituted hydrocarbyl, optionally substituted heteroatom-containing hydrocarbyl; typically, R¹ is hydrogen and R² is optionally substituted phenyl, C₁-C₆ alkyl or substituted 1-propenyl; or R¹ and R² are linked together to form one or more cyclic groups, such as a substituted indenylidene, specifically 3-phenylindenylid-1-ene.
L¹ and L² may be independently selected from phosphine, sulfonated phosphine, phosphite, phosphinite, phosphonite, arsine, stibine, ether, (including cyclic ethers), amine, amide, imine, sulfoxide, carboxyl, nitrosyl, pyridine, substituted pyridine, imidazole, substituted imidazole, pyrazine, substituted pyrazine and thioether. Exemplary ligands are trisubstituted phosphines. Preferred trisubstituted phosphines are of the formula PR^{H1}R^{H2}R^{H3}, where R^{H1}, R^{H2}, and R^{H3} are each independently optionally substituted: C₆₋₁₀ aryl or C₁-C₁₀ alkyl, or C₃₋₁₀ cycloalkyl. Preferably, L¹ and L² are independently selected from the group consisting of trimethylphosphine (PMe₃), triethylphosphine (PEt₃), tri-n-butylphosphine (PBu₃), tri (ortho-tolyl)phosphine (P-o-tolyl₃), tri-tert-butylphosphine (P-tert-Bu₃), tricyclopentylphosphine (PCp₃), tricyclohexylphosphine (PCy₃), triisopropylphosphine (P-i-Pr₃), trioctylphosphine (POct₃), triisobutylphosphine, (P-i-Bu₃), triphenylphosphine (PPh₃), tri (pentafluorophenyl)phosphine (P(C₆Fs)₃), methyldiphenylphosphine (PMePh₂), dimethylphenylphosphine (PMe₂Ph), and diethylphenylphosphine (PEt₂Ph).
L¹ and/or L² may be independently selected from

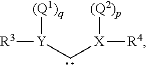

wherein X and Y are independently C, CR^{3a}, N, O, S, or P; only one of X or Y can be C or CR^{3a}; typically, X and Y are independently N; Q¹, Q², R³, R^{3a} and R⁴ are independently hydrogen optionally substituted hydrocarbyl, optionally substituted heteroatom-containing hydrocarbyl; generally, Q¹, Q², R³, R^{3a} and R⁴ are optionally linked to X or to Y via a linker such as optionally substituted hydrocarbylene, optionally substituted heteroatom-containing hydrocarbylene, or —(CO)—; typically Q¹, Q², R³, R^{3a} and R⁴ are directly linked to X or to Y; and p is 0, when X is O or S, p is 1, when X is N, P or CR^{3a}, and p is 2, when X is C; q is 0, when Y is O or S, q is 1, when Y is N, P or CR^{3a}, and q is 2, when X is C.
L¹ and/or L² may also be independently selected from

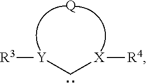

wherein Q is a two-atom linkage having the structure —[CR¹¹R¹²]ₛ—[CR¹³R¹⁴]ₜ— or —[CR¹¹═CR¹³]—; typically Q is —[CR¹¹R¹²]]—[CR¹³R¹⁴]ₛ—, wherein R¹¹, R¹², R¹³, and R¹⁴ are independently hydrogen, optionally substituted hydrocarbyl, optionally substituted heteroatom-containing hydrocarbyl; typically R¹¹, R¹², R¹³, and R¹⁴ are independently hydrogen, optionally substituted C₁-C₁₂ alkyl, optionally substituted C₁-C₁₂ heteroalkyl, optionally substituted C₅-C₁₄ aryl; “s” and “t” are independently 1 or 2; typically, “s” and “t” are independently 1; or any two of R¹¹, R¹², R¹³, and R¹⁴ are optionally linked together and can form an optionally substituted, saturated or unsaturated polycyclic ring structure.
L¹ and/or L² can also be independently selected from

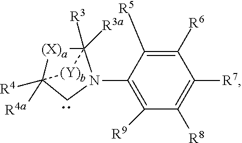

wherein:
X is —CR^{1a}R^{2a}—;
a is 1 or 2;
R^{1a} is H, optionally substituted C₁₋₂₄ alkyl, optionally substituted C₃₋₈ cycloalkyl, halogen, optionally substituted C₅-C₂₄ aryl, optionally substituted C₆-C₂₄ aralkyl, optionally substituted C₁-C₂₀ heteroalkyl, —C(O)R²¹, —OR²², CN, —NR²³R²⁴, NO₂, —CF₃, —S(O)ₓR²⁵, —P(O)(OH)₂, —OP(O)(OH)₂, —SR²⁷, or together with R^{2a} forms an optionally substituted spiro monocyclic or spiro polycyclic C₃₋₁₀ cycloalkyl or spiro heterocyclic ring, with the carbon atom to which they are attached, or together with R³ or together with R⁴ forms an optionally substituted polycyclic ring;
R^{2a} is H, optionally substituted C₁₋₂₄ alkyl, optionally substituted C₃₋₈ cycloalkyl, halogen, optionally substituted C₅-C₂₄ aryl, optionally substituted C₆-C₂₄ aralkyl, optionally substituted C₁-C₂₀ heteroalkyl, —C(O)R²¹, —OR²², CN, —NR²³R²⁴, NO₂, —CF₃, —S(O)ₓR²⁵, —P(O)(OH)₂, —OP(O)(OH)₂, —SR²⁷, or together with R^{1a} forms a spiro monocyclic or spiro polycyclic C₃₋₁₀ cycloalkyl or spiro heterocyclic ring, with the carbon atom to which they are attached, or together with R³ or together with R⁴ forms an optionally substituted polycyclic ring;
Y is —CR^{1b}R^{2b}—;
b is 0, 1, or 2;
R^{1b} is H, optionally substituted C₁₋₂₄ alkyl, optionally substituted C₃₋₈ cycloalkyl, halogen, optionally substituted C₅-C₂₄ aryl, optionally substituted C₆-C₂₄ aralkyl, optionally substituted C₁-C₂₀ heteroalkyl, —C(O)R²¹, —OR²², CN, —NR²³R²⁴, NO₂, —CF₃, —S(O)ₓR²⁵, —P(O)(OH)₂, —OP(O)(OH)₂, —SR²⁷, or together with R^{2b} forms a five-, six-, or ten-membered cycloalkyl or heterocyclic ring, with the carbon atom to which they are attached;
R^{2b} is H, optionally substituted C₁₋₂₄ alkyl, optionally substituted C₃₋₈ cycloalkyl, halogen, optionally substituted C₅-C₂₄ aryl, optionally substituted C₆-C₂₄ aralkyl, optionally substituted C₁-C₂₀ heteroalkyl, —C(O)R²¹, —OR²², CN, —NR²³R²⁴, NO₂, —CF₃, —S(O)ₓR²⁵, —P(O)(OH)₂, —OP(O)(OH)₂, —SR²⁷, or together with R^{1b} forms a five-, six-, or ten-membered cycloalkyl or heterocyclic ring, with the carbon atom to which they are attached;
R³ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R^{1a} or together with R^{2a} can form an optionally substituted polycyclic ring, or together with R^{3a} can form an optionally substituted spiro monocyclic or spiro polycyclic C₃₋₁₀ cycloalkyl;
R^{3a} is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R^{1a} or together with R^{2a} can form an optionally substituted polycyclic ring, or together with R³ can form an optionally substituted spiro monocyclic or spiro polycyclic C₃₋₁₀ cycloalkyl;
R⁴ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R^{1a} or together with R^{2a} can form an optionally substituted polycyclic ring, or together with R^{4a} can form an optionally substituted spiro monocyclic or spiro polycyclic C₃₋₁₀ cycloalkyl;
R^{4a} is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R^{1a} or together with R^{2a} can form an optionally substituted polycyclic ring, or together with R⁴ can form an optionally substituted spiro monocyclic or spiro polycyclic C₃₋₁₀ cycloalkyl;
R⁵ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R⁶ can form an optionally substituted polycyclic ring;
R⁶ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl or together with R⁵ or together with R⁷ can form an optionally substituted polycyclic ring;
R⁷ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R⁶ or together with R^{g} can form an optionally substituted polycyclic ring;
R^{g} is H, optionally substituted C₁₋₂₄ alkyl, halogen-C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R⁷ or together with R⁹ can form an optionally substituted polycyclic ring;
R⁹ is H, optionally substituted C₁₋₂₄ alkyl, halogen, —C(O)R²¹, —OR²², CN, —NR²³R²⁴, NO₂, —CF₃, —S(O)ₓR²⁵, —P(O)(OH)₂, —OP(O)(OH)₂, —SR²⁷, optionally substituted heterocycle, optionally substituted C₃₋₈ cycloalkyl, optionally substituted C₅₋₂₄ aryl, optionally substituted C₃₋₁₂ cycloalkenyl, or together with R^{g} can form a polycyclic ring;
R²¹ is OH, OR²⁶, NR²³R²⁴, optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
R²² is H, optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
R²³ is H, optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
R²⁴ is H, optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
R²⁵ is H, optionally substituted C₁₋₂₄ alkyl, OR²², —NR²³R²⁴, optionally substituted heterocycle, optionally substituted C₃₋₈ cycloalkyl, optionally substituted C₅₋₂₄ aryl or optionally substituted C₃₋₁₂ cycloalkenyl;
R²⁶ is optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
R²⁷ is H, optionally substituted C₁₋₂₄ alkyl, optionally substituted C₃₋₈ cycloalkyl, optionally substituted heterocycle, optionally substituted C₅₋₂₄ aryl or optionally substituted C₃₋₁₂ cycloalkenyl;
x is 1 or 2; and with the provisos
a. when a is 2, then the “X-X” bond can be saturated or unsaturated;
b. when b is 2, the “Y-Y” bond can be saturated or unsaturated;
c. when a is 2, and the “X-X” bond is unsaturated, then R^{2a} is nil;
d. when b is 1, then R^{3a} and R^{4a} are both nil;
e. when b is 2, then R^{3a} and R^{4a} are both nil;
f. when b is 2, and the “Y-Y” bond is unsaturated, then R^{2b} is nil.
L¹ and/or L² may also be independently selected from

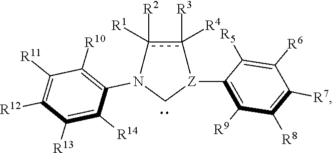

wherein:
Z is N or CR³²;
R¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² can form a spiro compound or together with R³ or together with R⁴ can form a polycyclic ring;
R² is H, optionally substituted C₁₋₂₄ alkyl, halogen, —C(O)R²⁵, —OR²⁶, CN, —NR²⁷R²⁸, NO₂, —CF₃, —cycloalkyl, optionally substituted C₅₋₂₄ aryl, optionally substituted C₃₋₈ cycloalkenyl or together with R¹ can form a spiro compound or together with R³ or together with R⁴ can form a polycyclic ring;
R³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl or optionally substituted C₃₋₈ cycloalkenyl or together with R² or together with R¹ can form a polycyclic ring or together with R⁴ can form a spiro compound;
R⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R³ can form a spiro compound or together with R² or together with R¹ can form a polycyclic ring;
R⁵ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁶ can form an optionally substituted polycyclic ring;
R⁶ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁵ or together with R⁷ can form an optionally substituted polycyclic ring;
R⁷ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl optionally substituted C₃₋₈ cycloalkenyl, or together with R⁶ or together with R^{g} can form an optionally substituted polycyclic ring;
R⁸ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁷ or together with R⁹ can form an optionally substituted polycyclic ring;
R⁹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R^{g} can form an optionally substituted polycyclic ring;
R¹⁰ is H, optionally substituted C₁₋₂₄ alkyl, halogen, —C(O)R²⁵, —OR²⁶, CN, —NR²⁷R²⁸, NO₂, —CF₃, —cycloalkyl, optionally substituted C₅₋₂₄ aryl, optionally substituted C₃₋₈ cycloalkenyl, or together with R¹¹ can form an optionally substituted polycyclic ring;
R¹¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R¹⁰ or together with R¹² can form an optionally substituted polycyclic ring;
R¹² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ or together with R¹³ can form an optionally substituted polycyclic ring;
R¹³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁴ or together with R¹² can form an optionally substituted polycyclic ring;
R¹⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹³ can form a polycyclic ring;
R³² is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; R²⁷ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; and x is 1 or 2.
L¹ and/or L² may also be independently selected from

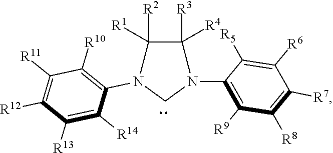

wherein:
R¹ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl, or together with R² can form a spiro compound or together with R³ or together with R⁴ can form a polycyclic ring;
R² is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R¹ can form a spiro compound or together with R³ or together with R⁴ can form a polycyclic ring;
R³ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₆₋₁₀ aryl or optionally substituted C₃₋₈ cycloalkenyl or together with R² or together with R¹ can form a polycyclic ring or together with R⁴ can form a spiro compound;
R⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₆₋₁₀ aryl, optionally substituted C₃₋₈ cycloalkenyl, or together with R³ can form a spiro compound or together with R² or together with R¹ can form a polycyclic ring;
R⁵ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl, or together with R⁶ can form an optionally substituted polycyclic ring;
R⁶ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl, or together with R⁵ or together with R⁷ can form an optionally substituted polycyclic ring;
R⁷ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl optionally substituted C₃₋₈ cycloalkenyl, or together with R⁶ or together with R^{g} can form an optionally substituted polycyclic ring;
R⁸ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₆₋₁₀ aryl, optionally substituted C₃₋₈ cycloalkenyl, or together with R⁷ or together with R⁹ can form an optionally substituted polycyclic ring;
R⁹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₆₋₁₀ aryl, optionally substituted C₅₋₇ cycloalkenyl, or together with R^{g} can form an optionally substituted polycyclic ring;
R¹⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl, or together with R¹¹ can form an optionally substituted polycyclic ring;
R¹¹ is H, optionally substituted C₁₋₁₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R¹⁰ or together with R¹² can form an optionally substituted polycyclic ring;
R¹² is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₆₋₁₀ aryl, optionally substituted C₃₋₈ cycloalkenyl, or together with R¹¹ or together with R¹³ can form an optionally substituted polycyclic ring;
R¹³ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl, or together with R¹⁴ or together with R¹² can form an optionally substituted polycyclic ring;
R¹⁴ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₅₋₂₄ aryl, optionally substituted C₃₋₈ cycloalkenyl, or together with R¹³ can form a polycyclic ring;
R²⁵ is OH, OR³⁰, NR²⁷R²⁸, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁶ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁷ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁸ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁹ is H, optionally substituted C₁₋₁₂ alkyl, OR²⁶, —NR²⁷R²⁸, optionally substituted heterocycle, optionally substituted C₅₋₇ cycloalkyl, optionally substituted C₆₋₁₀ aryl or optionally substituted C₃₋₈ cycloalkenyl;
R³⁰ is optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³¹ is H, optionally substituted C₁₋₁₂ alkyl, optionally substituted C₃₋₁₀ cycloalkyl, optionally substituted heterocycle, optionally substituted C₆₋₁₀ aryl or optionally substituted C₃₋₈ cycloalkenyl; and
x is 1 or 2.
L¹ and/or L² may also be independently selected from

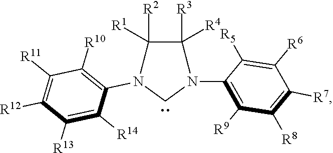

wherein:
R¹ is H, phenyl, methyl, ethyl, iso-propyl, n-propyl, n-butyl, tert-butyl, or sec-butyl;
R² is H, phenyl, methyl, ethyl, iso-propyl, n-propyl, n-butyl, tert-butyl, or sec-butyl;
R³ is H, phenyl, methyl, ethyl, iso-propyl, n-propyl, n-butyl, tert-butyl, or sec-butyl;
R⁴ is H, phenyl, methyl, ethyl, iso-propyl, n-propyl, n-butyl, tert-butyl, or sec-butyl;
R⁵ is H, methyl, ethyl, iso-propyl, n-propyl, n-butyl, tert-butyl, sec-butyl, F, optionally substituted phenyl, or together with R⁶ can form an optionally substituted polycyclic ring;
R⁶ is H, methyl, ethyl, iso-propyl, n-propyl, n-butyl, tert-butyl, sec-butyl, F, optionally substituted phenyl, or together with R⁵ or together with R⁷ can form an optionally substituted polycyclic ring;
R⁷ is H, methyl, ethyl, iso-propyl, n-propyl, n-butyl, tert-butyl, sec-butyl, optionally substituted phenyl, or together with R⁶ or together with R^{g} can form an optionally substituted polycyclic ring;
R^{g} is H, methyl, ethyl, iso-propyl, n-propyl, n-butyl, tert-butyl, sec-butyl, optionally substituted phenyl, or together with R⁷ or together with R⁹ can form an optionally substituted polycyclic ring;
R⁹ is H, methyl, ethyl, iso-propyl, n-propyl, n-butyl, tert-butyl, sec-butyl, F, optionally substituted phenyl, or together with R^{g} can form a polycyclic ring;
R¹⁰ is H, methyl, ethyl, iso-propyl, n-propyl, n-butyl, tert-butyl, sec-butyl, optionally substituted phenyl, or together with R¹¹ can form an optionally substituted polycyclic ring;
R¹¹ is H, methyl, ethyl, iso-propyl, n-propyl, n-butyl, tert-butyl, sec-butyl, optionally substituted phenyl, or together with R¹⁰ or together with R² can form an optionally substituted polycyclic ring;
R¹² is H, methyl, ethyl, iso-propyl, n-propyl, n-butyl, tert-butyl, sec-butyl, F, optionally substituted phenyl, or together with R¹¹ or together with R¹³ can form a polycyclic ring;
R¹³ is H, methyl, ethyl, iso-propyl, n-propyl, n-butyl, tert-butyl, sec-butyl, F, optionally substituted phenyl, or together with R¹² or together with R¹⁴ can form an optionally substituted polycyclic ring;
R¹⁴ is H, methyl, ethyl, iso-propyl, n-propyl, n-butyl, tert-butyl, sec-butyl, optionally substituted phenyl, or together with R¹³ can form an optionally substituted polycyclic ring.
L² may be

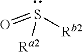

wherein: R^{a2} is hydrogen, optionally substituted hydrocarbyl, optionally substituted heteroatom-containing hydrocarbyl; generally R^{a2} is optionally substituted C₁-C₁₀ alkyl, optionally substituted C₃-C₁₀ cycloalkyl, optionally substituted C₅-C₂₄ aryl; typically R^{a2} is methyl, ethyl, n-propyl, iso-propyl, n-butyl, tert-butyl, cyclohexyl or phenyl; and R^{b2} is hydrogen, optionally substituted hydrocarbyl, optionally substituted heteroatom-containing hydrocarbyl; generally R^{b2} is optionally substituted C₁-C₁₀ alkyl, optionally substituted C₃-C₁₀ cycloalkyl, optionally substituted C₅-C₂₄ aryl; typically R^{b2} is methyl, ethyl, n-propyl, iso-propyl, n-butyl, tert-butyl, cyclohexyl or phenyl; or R³² and R^{b2} are linked together to form a five or a six heterocyclic membered ring with the sulfoxide group [—S(O)—].
L² may also be

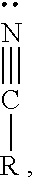

wherein: R is optionally substituted hydrocarbyl, optionally substituted heteroatom-containing hydrocarbyl; generally, R is optionally substituted C₁-C₁₀ alkyl, optionally substituted C₃-C₁₀ cycloalkyl, optionally substituted C₅-C₂₄ aryl; typically, R is methyl, ethyl, n-propyl, iso-propyl, n-butyl, tert-butyl, or phenyl.
L² may also be

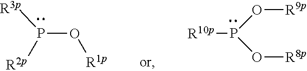

wherein: R^{1p}, R^{2p}, R^{3p} are each independently optionally substituted C₆-C₁₀ aryl, or optionally substituted C₁-C₁₀ alkyl, or optionally substituted C₃-C₁₀ cycloalkyl. R^{8p}, R^{9p}, R^{10p} are each independently optionally substituted C₆-C₁₀ aryl, or optionally substituted C₁-C₁₀ alkyl, or optionally substituted C₃-C₁₀ cycloalkyl.
L² may also be: PR^{H1}R^{H2}R^{H3}, wherein: R^{H1}, R^{H2}, and R^{H3} are each independently optionally substituted C₆-C₁₀ aryl, or optionally substituted C₁-C₁₀ alkyl, or optionally substituted C₃-C₁₀ cycloalkyl. R^{H1} may be methyl, ethyl, n-propyl, iso-propyl, n-butyl, tert-butyl, cyclohexyl, cyclopentyl or phenyl. R^{H2} may be methyl, ethyl, n-propyl, iso-propyl, n-butyl, tert-butyl, cyclohexyl, cyclopentyl or phenyl. R^{H3} may be methyl, ethyl, n-propyl, iso-propyl, n-butyl, tert-butyl, cyclohexyl, cyclopentyl or phenyl. L² may be: P(Cyclohexyl)₃: P(Et)₂Ph,: P(Ph)₃.

x¹ and X² may be independently halogen, trifluoroacetate, per-fluorophenols or together they can form a nitrate; typically, x¹ and x² are independently Cl, Br, I or F. Preferably, X¹ and X² are both C₁.
R¹ may be hydrogen and R² may be optionally substituted phenyl, C₁-C₆ alkyl or substituted 1-propenyl; or R¹ and R² are linked together to form one or more cyclic groups, such as a substituted indenylidene, specifically 3-phenylindenylid-1-ene. R¹ may also be hydrogen and R² may be 2-methyl-1-propenyl. R¹ and R² may also form together a 3-phenylindenylid-1-ene. R¹ can also be hydrogen and R² can be phenyl.
L² may be

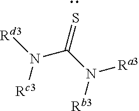

wherein: R^{a3} is optionally substituted hydrocarbyl, optionally substituted heteroatom-containing hydrocarbyl; generally R^{a3} is optionally substituted C₁-C₁₀ alkyl, optionally substituted C₃-C₁₀ cycloalkyl, optionally substituted C₅-C₂₄ aryl; typically R^{a3} is methyl, ethyl, n-propyl, iso-propyl, n-butyl, tert-butyl, cyclohexyl, benzyl or phenyl; R^{b3} is optionally substituted hydrocarbyl, optionally substituted heteroatom-containing hydrocarbyl; generally, R^{b3} is optionally substituted C₁-C₁₀ alkyl, optionally substituted C₃-C₁₀ cycloalkyl, optionally substituted C₅-C₂₄ aryl; typically, R^{b3} is methyl, ethyl, n-propyl, iso-propyl, n-butyl, tert-butyl, cyclohexyl, benzyl or phenyl; or R^{a3} and R^{b3} can be linked to form a five-, six- or seven-membered heterocycle ring with the nitrogen atom they are linked to; R^{c3} is optionally substituted hydrocarbyl, optionally substituted heteroatom-containing hydrocarbyl; generally, R^{c3} is optionally substituted C₁-C₁₀ alkyl, optionally substituted C₃-C₁₀ cycloalkyl, optionally substituted C₅-C₂₄ aryl; typically, R^{c3} is methyl, ethyl, n-propyl, iso-propyl, n-butyl, tert-butyl, cyclohexyl, benzyl or phenyl; R^{d3} is optionally substituted hydrocarbyl, optionally substituted heteroatom-containing hydrocarbyl; generally, R^{d3} is optionally substituted C₁-C₁₀ alkyl, optionally substituted C₃-C₁₀ cycloalkyl, optionally substituted C₅-C₂₄ aryl; typically, R^{d3} is methyl, ethyl, n-propyl, iso-propyl, n-butyl, tert-butyl, cyclohexyl, benzyl or phenyl; or R^{c3} and R^{d3} can be linked to form a five-, six- or seven-membered heterocycle ring with the nitrogen atom they are linked to; or R^{b3} and R^{c3} can be linked to form a five-, six- or seven-membered heterocycle ring with the nitrogen atoms they are linked to.

The moiety

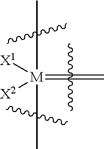

may be

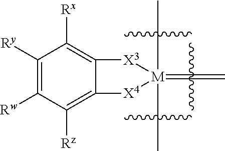

wherein: X³ and X⁴ are independently O or S; typically, X³ and X⁴ are independently S; and R^{x}, R^{y}, R^{y}, and R² are independently hydrogen, halogen, optionally substituted hydrocarbyl, optionally substituted heteroatom-containing hydrocarbyl; generally R^{x}, R^{y}, R^{w}, and R^{z} are independently hydrogen, halogen, optionally substituted C₁-C₁₂ alkyl, optionally substituted C₃-C₁₀ cycloalkyl, optionally substituted C₅-C₂₄ aryl; typically, R^{x1}, R_{y}, R^{w}, and R² are independently C₁-C₆ alkyl, hydrogen, optionally substituted phenyl, or halogen; or R^{x1} and R^{y} are linked together to form an optionally substituted bicyclic or polycyclic aryl; or R^{w} and R² are linked together to form an optionally substituted bicyclic or polycyclic aryl; or R^{y} and R^{w} are linked together to form an optionally substituted bicyclic or polycyclic aryl.

The olefin metathesis catalyst used in the at least one cyclic olefin monomer composition of the invention may also be represented by the general structure of Formula (2):

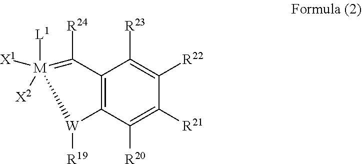

wherein:
M is ruthenium;
L¹, x¹, and X² are as defined herein;
W is O, halogen, NR³³ or S;
R¹⁹ is H, optionally substituted C₁₋₂₄ alkyl, —C(R³⁴)(R³⁵)COOR³⁶, —C(R³⁴)(R³⁵)C(O) H, —C(R³⁴)(R³⁵)C(O)R³⁷, —C(R³⁴)(R³⁵)CR³⁸ (OR³⁹)(OR⁴⁰), —C(R³⁴)(R³⁵)C(O)NR⁴¹R⁴², —C(R³⁴)(R³⁵)C(O)NR⁴¹OR⁴⁰, —C(O)R²⁵, optionally substituted heterocycle, optionally substituted C₃₋₁₀ cycloalkyl, optionally substituted C₅₋₂₄ aryl, optionally substituted C₃₋₈ cycloalkenyl, or when W is NR³³, then R¹⁹ together with R³³ can form an optionally substituted heterocyclic ring or when W is halogen then R¹⁹ is nil;
R²⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²¹ can form a polycyclic ring;
R²¹ is H, optionally substituted C₁₋₂₄ alkyl, halogen, —C(O)R²⁵, —OR²⁶, CN, —NR²⁷R²⁸, NO₂, —CF₃, —cycloalkyl, optionally substituted C₅₋₂₄ aryl, optionally substituted C₃₋₈ cycloalkenyl or together with R²⁰ or together with R²² can form a polycyclic ring;
R²² is H, optionally substituted C₁₋₂₄ alkyl, halogen, —C(O)R²⁵, —OR²⁶, CN, —NR²⁷R²⁸, NO₂, —CF₃, —cycloalkyl, optionally substituted C₅₋₂₄ aryl, optionally substituted C₃₋₈ cycloalkenyl or together with R²¹ or together with R²³ can form a polycyclic ring;
R²³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²² can form a polycyclic ring;
R²⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl or optionally substituted C₃₋₈ cycloalkenyl;
R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; R²⁷ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; R³³ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁴ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁵ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁶ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁷ is optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁸ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴⁰ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴² is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; and
x is 1 or 2.

The olefin metathesis catalyst used in the at least one cyclic olefin monomer composition of the invention may also be represented by the general structure of Formula (2):

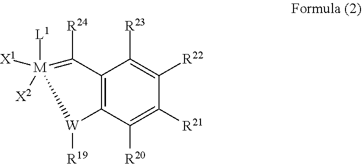

wherein:
M is ruthenium;
L¹, x¹, and X² are as defined herein;
W is O, halogen, NR³³, or S;
R¹⁹ is H, optionally substituted C₁₋₁₂ alkyl, —C(R³⁴)(R³⁵)COOR³⁶, —C(R³⁴)(R³⁵)C(O) H, —C(R³⁴)(R³⁵)C(O)R³⁷, —C(R³⁴)(R³⁵)CR³⁸ (OR³⁹)(OR⁴⁰), —C(R³⁴)(R³⁵)C(O)NR⁴¹R⁴², —C(R³⁴)(R³⁵)C(O)NR⁴¹OR⁴⁰, —C(O)R²⁵, optionally substituted heterocycle, optionally substituted C₅₋₇ cycloalkyl, optionally substituted C₆₋₁₀ aryl, optionally substituted C₃₋₈ cycloalkenyl, or when W is NR³³, then R¹⁹ together with R³³ can form an optionally substituted heterocyclic ring or when W is halogen then R¹⁹ is nil;
R²⁰ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R²¹ can form a polycyclic ring;
R²¹ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R²⁰ or together with R²² can form a polycyclic ring;
R²² is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R²¹ or together with R²³ can form a polycyclic ring;
R²³ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl, optionally substituted C₃₋₈ cycloalkenyl or together with R²² can form a polycyclic ring;
R²⁴ is H, optionally substituted C₁₋₁₂ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₅₋₇ cycloalkyl, optionally substituted C₆₋₁₀ aryl or optionally substituted C₃₋₈ cycloalkenyl;
R²⁵ is OH, OR³⁰, NR²⁷R²⁸, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁶ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁷ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R²⁸ is H, optionally substituted C₁₋₁₂ alkyl, optionally substituted C₅₋₇ cycloalkyl, optionally substituted heterocycle, optionally substituted C₅₋₂₄ aryl or optionally substituted C₃₋₈ cycloalkenyl;
R²⁹ is H, optionally substituted C₁₋₁₂ alkyl, OR²⁶, —NR²⁷R²⁸, optionally substituted heterocycle, optionally substituted C₅₋₇ cycloalkyl, optionally substituted C₆₋₁₀ aryl or optionally substituted C₃₋₈ cycloalkenyl;
R³⁰ is optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³¹ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³³ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁴ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁵ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁶ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁷ is optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁸ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R³⁹ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R⁴⁰ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R⁴¹ is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl;
R⁴² is H, optionally substituted C₁₋₁₂ alkyl, optionally substituted C₅₋₇ cycloalkyl, optionally substituted heterocycle, optionally substituted C₆₋₁₀ aryl or optionally substituted C₃₋₈ cycloalkenyl; and
x is 1 or 2.

The olefin metathesis catalyst used in the at least one cyclic olefin monomer composition of the invention may also be represented by the structure of Formula (2):

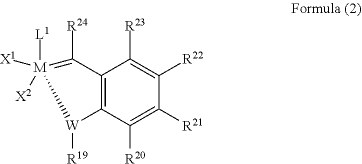

wherein:
M is ruthenium;
L¹, X¹, and X² are as defined herein;
W is O;
R¹⁹ is H, methyl, ethyl, n-propyl, iso-propyl, n-butyl, tert-butyl, cyclohexyl, cyclopentyl or phenyl;
R²⁰ is H, methyl, ethyl, n-propyl, iso-propyl, n-butyl, tert-butyl, cyclohexyl, cyclopentyl or phenyl;
R²¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²⁰ or together with R²² can form a polycyclic ring;
R²² is H, methyl, ethyl, n-propyl, iso-propyl, n-butyl, tert-butyl, cyclohexyl, cyclopentyl or phenyl.;
R²³ is H, methyl, ethyl, n-propyl, iso-propyl, n-butyl, tert-butyl, cyclohexyl, cyclopentyl or phenyl;
R²⁴ is H, methyl, ethyl, n-propyl, iso-propyl, n-butyl, tert-butyl, cyclohexyl, cyclopentyl or phenyl;
R²⁵ is OH, OR³⁰, NR²⁷R²⁸, methyl, ethyl, n-propyl, iso-propyl, n-butyl, tert-butyl, cyclohexyl, cyclopentyl or phenyl;
R²⁶ is H, methyl, ethyl, n-propyl, iso-propyl, n-butyl, tert-butyl, cyclohexyl, cyclopentyl or phenyl;
R²⁷ is H, methyl, ethyl, n-propyl, iso-propyl, n-butyl, tert-butyl, cyclohexyl, cyclopentyl or phenyl;
R²⁸ is H, methyl, ethyl, n-propyl, iso-propyl, n-butyl, tert-butyl, cyclohexyl, cyclopentyl or phenyl;
R²⁹ is H, methyl, ethyl, n-propyl, iso-propyl, n-butyl, tert-butyl, OR²⁶, —NR²⁷R²⁸, cyclohexyl, cyclopentyl or phenyl;
R³⁰ is methyl, ethyl, n-propyl, iso-propyl, n-butyl, tert-butyl, cyclohexyl, cyclopentyl or phenyl;
R³¹ is H, methyl, ethyl, n-propyl, iso-propyl, n-butyl, tert-butyl, cyclohexyl, cyclopentyl or phenyl;
x is 1 or 2.

The olefin metathesis catalyst used in the at least one cyclic olefin monomer composition of the invention may also be represented by the structure of Formula (2):

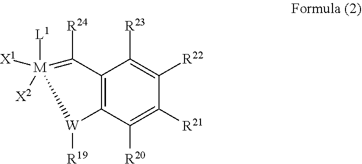

wherein:
L¹ is

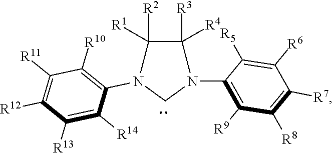

R¹ is H, phenyl, methyl, ethyl, iso-propyl, n-propyl, n-butyl, tert-butyl, or sec-butyl;
R² is H, phenyl, methyl, ethyl, iso-propyl, n-propyl, n-butyl, tert-butyl, or sec-butyl;
R³ is H, phenyl, methyl, ethyl, iso-propyl, n-propyl, n-butyl, tert-butyl, or sec-butyl;
R⁴ is H, phenyl, methyl, ethyl, iso-propyl, n-propyl, n-butyl, tert-butyl, or sec-butyl;
R⁵ is H, methyl, ethyl, iso-propyl, n-propyl, n-butyl, tert-butyl, sec-butyl, F, optionally substituted phenyl, or together with R⁶ can form an optionally substituted polycyclic ring;
R⁶ is H, methyl, ethyl, iso-propyl, n-propyl, n-butyl, tert-butyl, sec-butyl, F, optionally substituted phenyl, or together with R⁵ or together with R⁷ can form an optionally substituted polycyclic ring;
R⁷ is H, methyl, ethyl, iso-propyl, n-propyl, n-butyl, tert-butyl, sec-butyl, optionally substituted phenyl, or together with R⁶ or together with R^{g} can form an optionally substituted polycyclic ring;
R^{g} is H, methyl, ethyl, iso-propyl, n-propyl, n-butyl, tert-butyl, sec-butyl, optionally substituted phenyl, or together with R⁷ or together with R⁹ can form an optionally substituted polycyclic ring;
R⁹ is H, methyl, ethyl, iso-propyl, n-propyl, n-butyl, tert-butyl, sec-butyl, F, optionally substituted phenyl, or together with R^{g} can form a polycyclic ring;
R¹⁰ is H, methyl, ethyl, iso-propyl, n-propyl, n-butyl, tert-butyl, sec-butyl, optionally substituted phenyl, or together with R¹¹ can form an optionally substituted polycyclic ring;
R¹¹ is H, methyl, ethyl, iso-propyl, n-propyl, n-butyl, tert-butyl, sec-butyl, optionally substituted phenyl, or together with R¹⁰ or together with R² can form an optionally substituted polycyclic ring;
R¹² is H, methyl, ethyl, iso-propyl, n-propyl, n-butyl, tert-butyl, sec-butyl, F, optionally substituted phenyl, or together with R¹¹ or together with R¹³ can form a polycyclic ring;
R¹³ is H, methyl, ethyl, iso-propyl, n-propyl, n-butyl, tert-butyl, sec-butyl, F, optionally substituted phenyl, or together with R¹² or together with R¹⁴ can form an optionally substituted polycyclic ring;
R¹⁴ is H, methyl, ethyl, iso-propyl, n-propyl, n-butyl, tert-butyl, sec-butyl, optionally substituted phenyl, or together with R¹³ can form an optionally substituted polycyclic ring.

R¹⁹ is H, methyl, ethyl, n-propyl, iso-propyl, n-butyl, tert-butyl, cyclohexyl, cyclopentyl or phenyl;
R²⁰ is H, methyl, ethyl, n-propyl, iso-propyl, n-butyl, tert-butyl, cyclohexyl, cyclopentyl or phenyl;
R²¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²⁰ or together with R²² can form a polycyclic ring;
R²² is H, methyl, ethyl, n-propyl, iso-propyl, n-butyl, tert-butyl, cyclohexyl, cyclopentyl or phenyl;
R²³ is H, methyl, ethyl, n-propyl, iso-propyl, n-butyl, tert-butyl, cyclohexyl, cyclopentyl or phenyl;
R²⁴ is H, methyl, ethyl, n-propyl, iso-propyl, n-butyl, tert-butyl, cyclohexyl, cyclopentyl or phenyl;
R²⁵ is OH, OR³⁰, NR²⁷R²⁸, methyl, ethyl, n-propyl, iso-propyl, n-butyl, tert-butyl, cyclohexyl, cyclopentyl or phenyl;
R²⁶ is H, methyl, ethyl, n-propyl, iso-propyl, n-butyl, tert-butyl, cyclohexyl, cyclopentyl or phenyl;
R²⁷ is H, methyl, ethyl, n-propyl, iso-propyl, n-butyl, tert-butyl, cyclohexyl, cyclopentyl or phenyl;
R²⁸ is H, methyl, ethyl, n-propyl, iso-propyl, n-butyl, tert-butyl, cyclohexyl, cyclopentyl or phenyl;
R²⁹ is H, methyl, ethyl, n-propyl, iso-propyl, n-butyl, tert-butyl, OR²⁶, —NR²⁷R²⁸, cyclohexyl, cyclopentyl or phenyl;
R³⁰ is methyl, ethyl, n-propyl, iso-propyl, n-butyl, tert-butyl, cyclohexyl, cyclopentyl or phenyl;
R³¹ is H, methyl, ethyl, n-propyl, iso-propyl, n-butyl, tert-butyl, cyclohexyl, cyclopentyl or phenyl;
x is 1 or 2.

The olefin metathesis catalyst used in the at least one cyclic olefin monomer composition of the invention may also be represented by the structure of Formula (2):

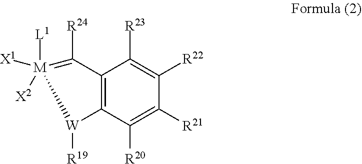

wherein: L¹ is

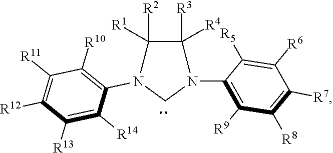

wherein:
R¹ is H;
R² is H;
R³ is H;
R⁴ is H;
R⁵ is H, methyl, or iso-propyl;
R⁶ is H;
R⁷ is H, methyl;
R^{g} is H;
R⁹ is H, methyl, or iso-propyl;
R¹⁰ is H, methyl, or iso-propyl;
R¹¹ is H;
R¹² is H or methyl;
R¹³ is H;
R¹⁴ is H, methyl, or iso-propyl;

X¹ and X² are CI;

W is O;

R¹⁹ is iso-propyl;

R²⁰ is H;
R²¹ is H;
R²² is H;
R²³ is H; and
R²⁴ is H.

The olefin metathesis catalysts used in the at least one cyclic olefin monomer compositions of the invention can be represented by general structures:

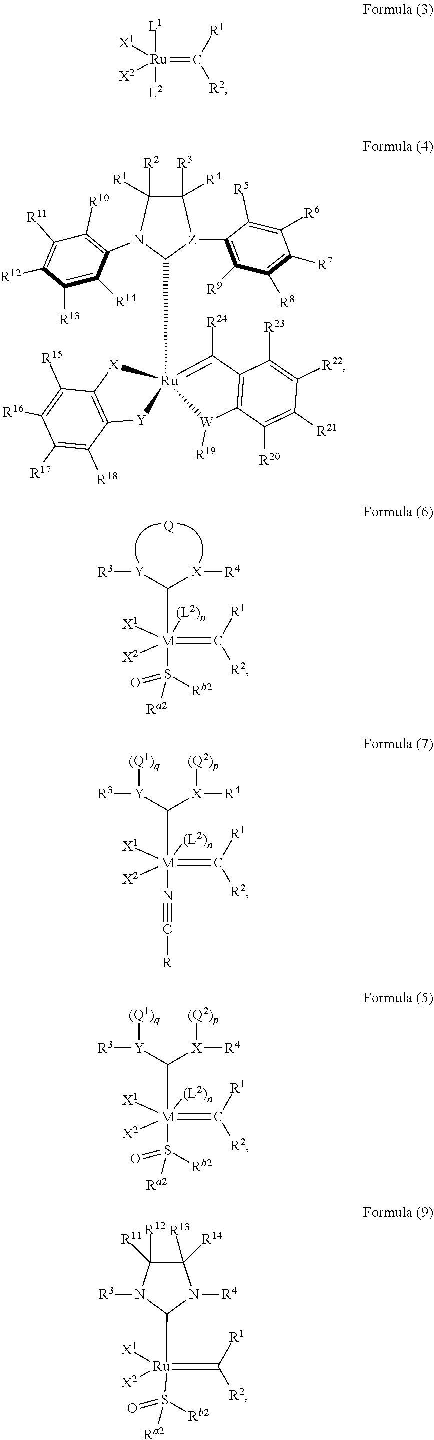

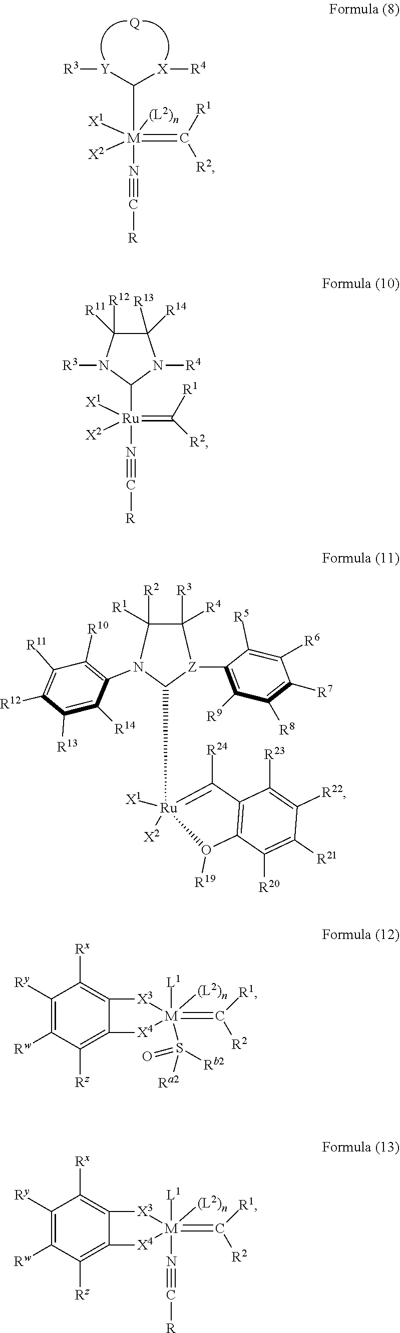

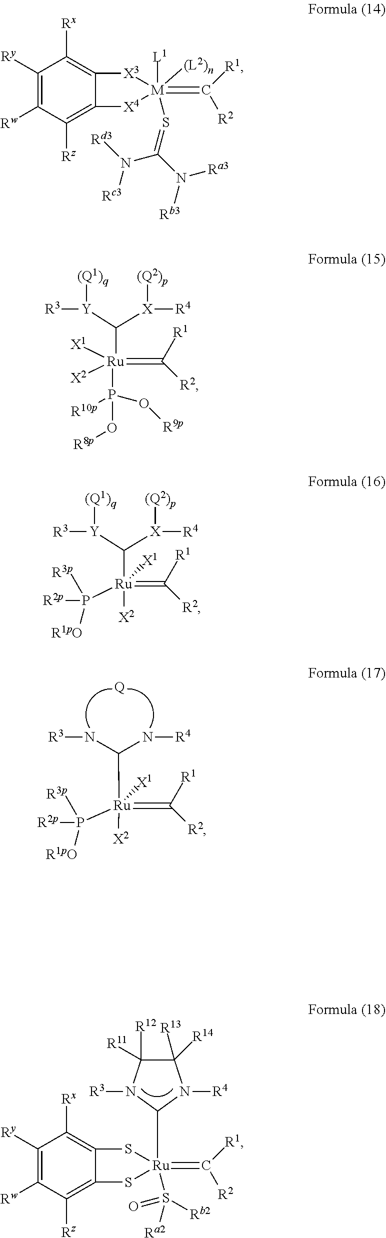

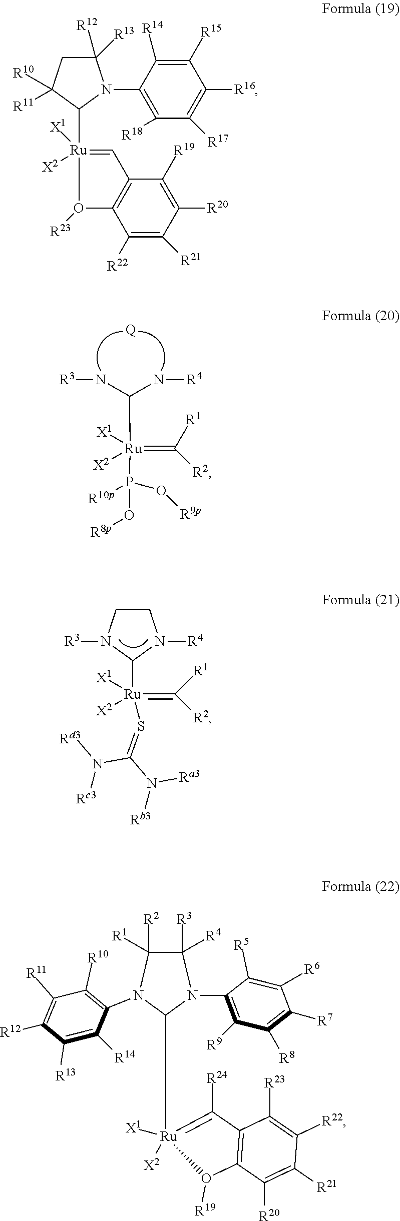

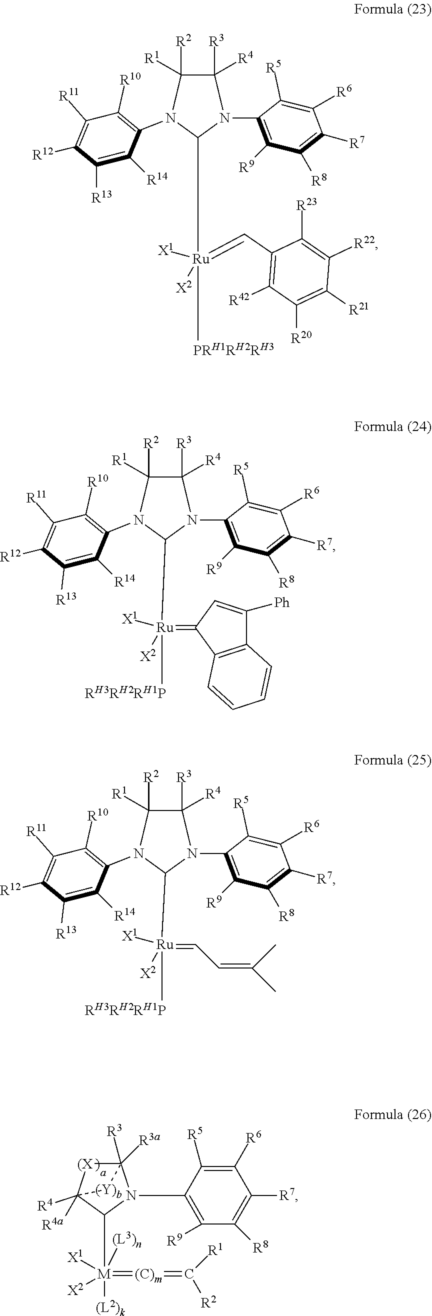

wherein Q, Q¹, Q², p, q, X¹, X², X³, X⁴, R¹, R², R³,R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁰, R²¹, R²², R²³, R²⁴, R^{a2}, R^{b2}, R^{a3}, R^{b3}, R^{c3}, R^{d3}, R^{1p}, R^{2p}, R³⁰, R^{H1}, R^{H2}, R^{H3}, —(L²) n— and R⁴² are as defined herein.

Preferred olefin metathesis catalysts used in the at least one cyclic olefin monomer compositions of the invention are encompassed by Formulae:

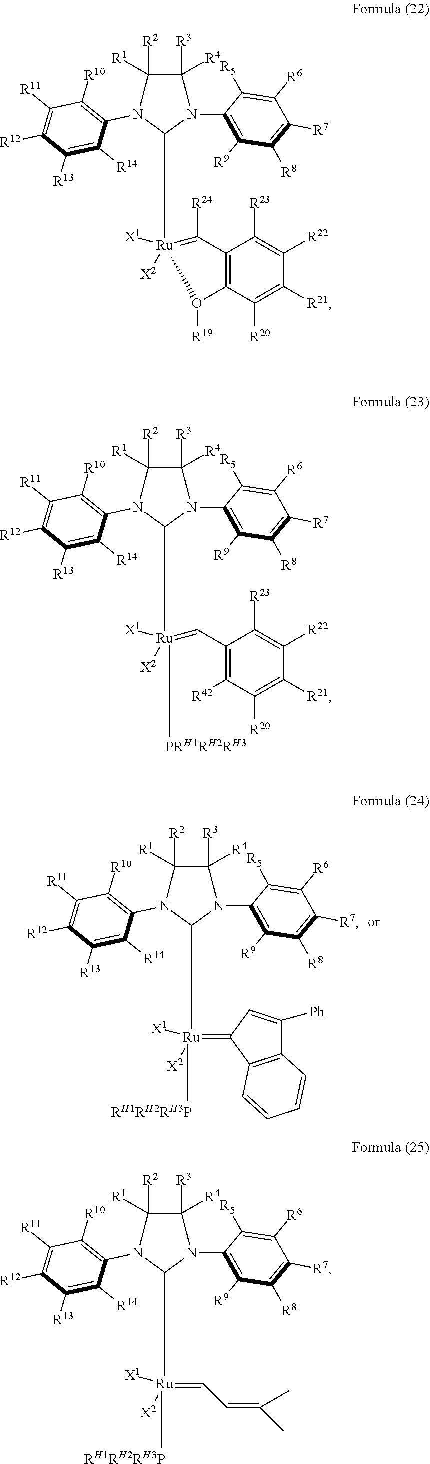

wherein X¹, X², R¹, R², R³, R⁴, R⁵, R⁶, R⁷, R⁸, R⁹, R¹⁰, R¹¹, R¹², R¹³, R¹⁴, R¹⁹, R²⁰, R²¹, R²², 23, R²⁴, R^{H1}, R^{H2}, R^{H3} and R⁴² are as defined herein.

Most preferred olefin metathesis catalysts used in the at least one cyclic olefin monomer compositions of the invention are encompassed by Formulae:

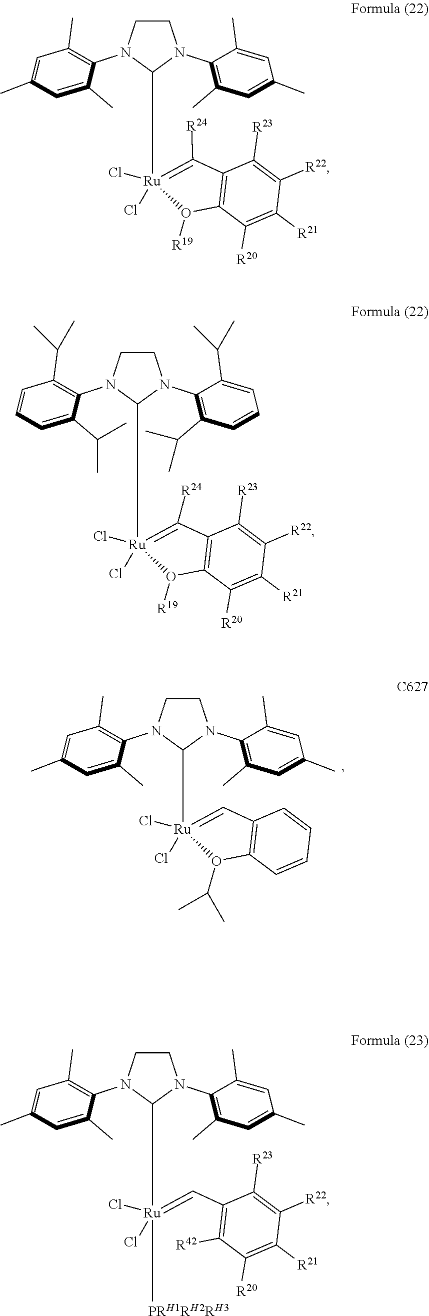

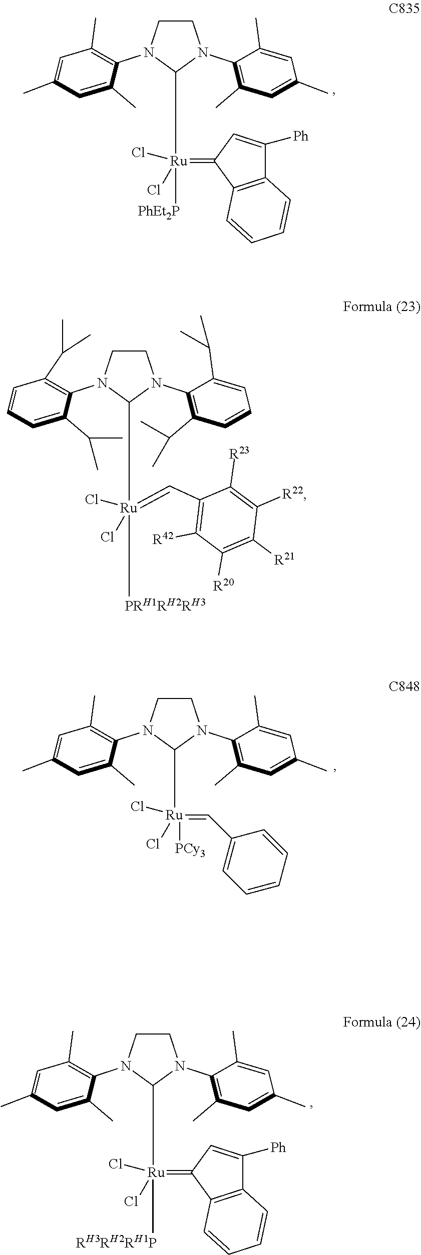

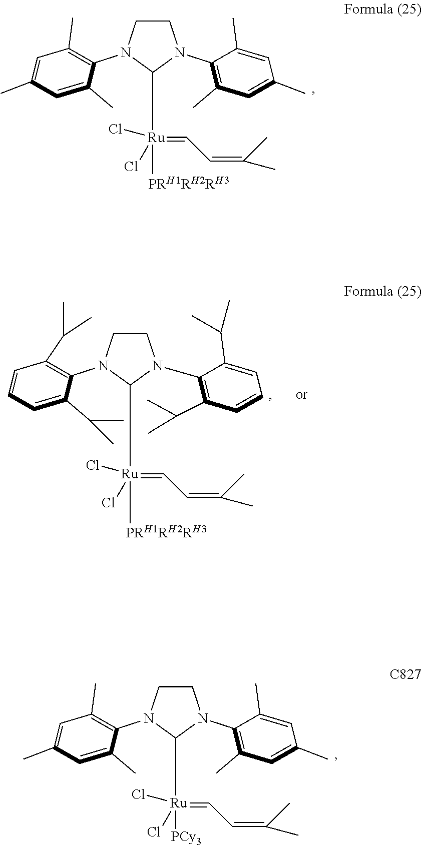

wherein: R¹⁹, R²⁰, R²¹, R²², R²³, R²⁴, Cy, R^{H1}, R^{H2}, R^{H3} and R⁴² are as defined herein.

It will be appreciated that the amount of catalyst that is used (i.e., the “catalyst loading”) in the reaction is dependent upon a variety of factors such as the identity of the reactants and the reaction conditions that are employed. It is therefore understood that catalyst loading may be optimally and independently chosen for each reaction. In general, however, the catalyst will be present in an amount that ranges from a low of about 0.1 ppm, 1 ppm, or 5 ppm, to a high of about 10 ppm, 15 ppm, 25 ppm, 50 ppm, 100 ppm, 200 ppm, 500 ppm, or 1000 ppm relative to the amount of the cyclic olefin monomer.

The catalyst will generally be present in an amount that ranges from a low of about 0.00001 mol %, 0.0001 mol %, or 0.0005 mol %, to a high of about 0.001 mol %, 0.0015 mol %, 0.0025 mol %, 0.005 mol %, 0.01 mol %, 0.02 mol %, 0.05 mol %, or 0.1 mol % relative to the cyclic olefin monomer.

When expressed as the molar ratio of olefin to catalyst, the catalyst (the “olefin to catalyst ratio”), loading will generally be present in an amount that ranges from a low of about 10,000,000:1, 1,000,000:1, 500,000:1 or 200,00:1, to a high of about 100,000:1 60,000:1, 50,000:1, 45,000;1, 40,000:1, 30,000:1, 20,000:1, 10,000:1, 5,000:1, or 1,000:1.

### Additives

The cyclic olefin monomer composition, the resin composition polymerizable by addition or condensation polymerization, and/or the hybrid composition (referred to collectively as the “composition(s)”) may also contain, independent of one another, at least one additive known in the art. Suitable additives include, but are not limited to, solvents, pot life extenders, gel modifiers, hardness modulators, impact modifiers, fillers, binders, thixotropes, rheology modifiers, dispersants, wetting agents, plasticizers, pigments, flame retardants, dyes, fibers, reinforcement materials, coupling agents (e.g., silane coupling agents), adhesion promoters, film formers, lubricants, and stabilizers such as, for example, antioxidants, antiozonants, UV absorbers, and UV light stabilizers and other stabilizers known in the art. Furthermore, the amount of an additive added to the composition(s) may vary, depending on the particular type of additive. The additive and the additive loading should not interfere with polymerizing/curing the composition(s). Care should be taken when using chemistries that are known to inhibit ROMP. The concentration of the additives in the composition(s) typically ranges from, for example, about 0.001-95 wt. %, particularly, from about 0.1-75 wt. %, or even more particularly, from 1-60 wt. %, 5-70 wt. %, 10-60 wt. %, or from 20-60 wt. %, based on the solid content of that particular composition.

Suitable solvents include without limitation ethyl acetate (EA), n-butyl acetate (n-BA), and methyl amyl ketone (MAK).

Suitable pot life extenders include without limitation triphenylphosphine (TPP) and cumene hydroperoxide.

Suitable impact modifiers or elastomers include without limitation natural rubber, butyl rubber, polyisoprene, polybutadiene, polyisobutylene, ethylene-propylene copolymer, styrene-butadiene-styrene triblock rubber, random styrene-butadiene rubber, styrene-isoprene-styrene triblock rubber, styrene-ethylene/butylene-styrene copolymer, styrene-ethylene/propylene-styrene copolymer, ethylene-propylene-diene terpolymers, ethylene-vinyl acetate and nitrile rubbers.

Suitable antioxidants or antiozonants include without limitation: primary antioxidants such as 2,6-di-tert-butyl-4-methylphenol (BHT); styrenated phenols, such as Wingstay® S (Goodyear); 2- and 3-tert-butyl-4-methoxyphenol; alkylated hindered phenols, such as Wingstay C (Goodyear); 4-hydroxymethyl-2,6-di-tert-butylphenol; 2,6-di-tert-butyl-4-sec-butylphenol; 2,2′-methylenebis(4-methyl-6-tert-butylphenol); 2,2′-methylenebis(4-ethyl-6-tert-butylphenol); 4,4′-methylenebis (2,6-di-tert-butylphenol); miscellaneous bisphenols, such as Cyanox′ 53 and Permanax WSO; 2,2′-ethylidenebis (4,6-di-tert-butylphenol); 2,2′-methylenebis(4-methyl-6-(1-methylcyclohexyl) phenol); 4,4′-butylidenebis (6-tert-butyl-3-methylphenol); polybutylated Bisphenol A; 4,4′-thiobis (6-tert-butyl-3-methylphenol); 4,4′-methylenebis (2,6-dimethylphenol); 1,1′-thiobis (2-naphthol); methylene bridged polyaklylphenols, such as Ethyl antioxidant 738; 2,2′-thiobis (4-methyl-6-tert-butylphenol); 2,2′-isobutylidenebis (4,6-dimethylphenol); 2,2′-methylenebis(4-methyl-6-cyclohexylphenol); butylated reaction products of p-cresol and dicyclopentadiene, such as Wingstay L; tetrakis(methylene-3,5-di-tert-butyl-4-hydroxyhydrocinnamate) methane, i.e., Irganox 1010; 1,3,5-trimethyl-2,4,6-tris (3,5-di-tert-butyl-4-hydroxybenzyl)benzene, e.g., Ethanox 330; 4,4′-methylenebis (2,6-di-tertiary-butylphenol), e.g., Ethanox 4702 or Ethanox 4710; 1,3,5-tris (3,5-di-tert-butyl-4-hydroxybenzyl) isocyanurate, i.e., Good-rite 3114; 2,5-di-tert-amylhydroquinone; tert-butylhydroquinone; 1,6-hexamethylene bis(3-(3,5-di-tert-butyl-4-hydroxyphenylpropionate), such as Irganox 259; octadecyl-3,5-di-tert-butyl-4-hydroxyhydrocinnamate, i.e., Irganox 1076; diphenylamine; 4,4′-diemthoxydiphenylamine; secondary antioxidants such as tris (nonylphenylphosphite); bis(2,4-di-tert-butyl) pentaerythritol)diphosphate; distearyl pentaerythritol diphosphite; phosphited phenols and bisphenols, such as Naugard 492; phosphite/phenolic antioxidant blends, such as Irganox B215; di-n-octadecyl (3,5-di-tert-butyl-4-hydroxybenzyl)phosphonate, such as Irganox 1093; tetrakis (2,4-di-tert-butylphenyl) 4,4′-biphenylylenediphosphonite; esters of thiodipropionic acid such as Irganox PS 802, Irganox PS 800, and Cyanox MTDP. Such materials are normally employed in the composition(s) at levels of about 0.1-10 wt. %, or more preferably at levels of about 0.1-5 wt. %.

As mentioned above, UV absorbers and UV light stabilizers are two examples of the type of stabilizers which may be used in the composition(s). Suitable UV absorbers include nickel quenchers, benzophenones, benzotriazoles, benzyldene malonates, triazines, etc. Suitable UV light stabilizers include hindered amines, etc. The blend of various UV absorbers and UV light stabilizers are also suitable to provide protection against UV. Some suitable UV absorbers include 2-(2H-benzotriazol-2-yl)-p-cresol, 2-tert-Butyl-6-(5-chloro-2H-benzotriazol-2-yl)-4-methylphenol, and 2,2′-methylenebis[6-(2H-benzotriazol-2-yl)-4-(1,1,3,3-tetramethylbutyl) phenol], 2-hydroxy-4-methoxybenzophenone and 2-hydroxy-4-octyloxybenzophenone, as 2-(4,6-diphenyl-1,3,5-triazin-2-yl)-5-[(hexyl)oxy]-phenol; oxanilide UV absorbers such as N-(2-ethoxyphenyl)-N′-(2-ethylphenyl) oxamide, dimethyl 2-(4 methoxybenzylidene) malonate, bis(1,2,2,6,6-pentamethyl-4-piperidyl) sebacate, methyl 1,2,2,6,6-pentamethyl-4-piperidyl sebacate, bis(1,2,2,6,6-pentamethyl-4-pperidyl) sebacate, bis(1-octyloxy-2,2,6,6-tetramethyl-4-piperidyl) sebacate, LOWILITE® Q84 and POLYBATCH® LLUVS 110, Tinuvin 1130, Tinuvin 171, Tinuvin 328, Tinuvin 384-2, Tinuvin 900, Tinuvin 928, Tinuvin 99, Tinuvin 5050, Tinuvin 5060, Tinuvin 5151, Tinuvin 5248, Tinuvin 5251, Tinuvin 5350, Tinuvin 123, Tinuvin 144, Tinuvin 152, Tinuvin 249, Tinuvin 292, Tinuvin 400, Tinuvin 405, Tinuvin 460, Tinuvin 477, Tinuvin 479 (BASF), Chimassorb 81, Chimassorb 944, Chimassorb 2020 (BASF), KEMISORB 10, KEMISORB 11, KEMISORB 111 (Chemipro Kasei Ksisha), BP-2, BP-3, BP-6, BP-9 (Dalian Richfortune Chemicals), Ultra V 301 (Dover, ICI Industries), Grandsorb BP-1, Grandsorb BP-2, Grandsorb BP-4, Grandsorb BP-6 (Hongkun Group), SpeedBlock UV-6 (Lamsson), Maxgard 1000, Maxgard 300, Maxgard 400, Maxgard 500, Maxgard 600, Maxgard 700 (Lycus), Cyasorb UV-3346, Hostavin N 30 and the like. Such stabilizers can be used as individual components or in combination with other stabilizers known in the art for compositions. Such materials are normally employed in the composition(s) at levels of about 0.1-10 wt. %, but more preferably at levels of about 0.1-5 wt. %.

Suitable fillers include, for example, microparticulate density modulators, such as, microspheres, or macroparticulate density modulators, for example: glass or ceramic beads. Other suitable fillers are inorganic fillers such as, for example, aluminum powder, aluminum flakes (e.g., aluminum flake paste), glass flakes, micaceous iron oxide, calcium carbonate, dolomite, silicas, silicates, talc, kaolin, mica, feldspar, barium sulfate and wollastonites, carbon nanotubes, graphene. Preferred inorganic fillers include aluminum powder, aluminum flakes, micaceous iron oxide, mica, glass fibers, wollastonite, calcium carbonate, silica and mixtures thereof, with flake-like fillers also being preferred. Preferably, the filler is aluminum powder or aluminum flakes (e.g., aluminum flake paste), or alloys thereof. The aluminum powder or aluminum flake may be used alone or in combination with other fillers, such as those mentioned previously. For example, aluminum flake paste may be used alone or in combination with micaceous iron oxide. The fillers, particularly the preferred fillers, may be present in the composition(s) in any suitable amount, such as about 0.01-95 wt. %, about 1-95 wt. %, about 5-95 wt. %, about 1-30 wt. %, preferably about 0.01-25 wt. %, preferably about 10-80 wt. %, preferably about 5-70 wt. %, preferably about 10-60 wt. %, preferably about 20-50 wt. %, and most preferably about 15 −40 wt. %. The aluminum flakes may have a particle size ranging from about 2-50 microns, preferably about 5-30 microns, most preferably about 10-20 microns. Metallic flakes such as zinc, aluminum, magnesium, nickel, etc. can be added as inorganic fillers to compositions as sacrificial anodes to provide cathodic protection. They can also be used in combination with electrically conducting fillers as taught in U.S. Pat. No. 7,794,626 to provide galvanic anti-corrosion protection to the substrates.

One particular preferred inorganic filler is Mica C3000, which may be present in the composition(s) in an amount ranging from about 0.01-95 wt. % (e.g., about 10-90 wt. %, 20-60 wt. %, 30-50 wt. %), based on the total weight of that particular composition.

Suitable dyes or pigments include MO 02294 black, MO-80406BV-Yellow from Chromaflo, and white pigment powder TI-PURE from Dupont.

Suitable adhesion promoters include isocyanates and their derivatives; phosphorous containing compounds such as phosphoric acids and phosphate ester containing compounds; sulfonic acid, sulfonate and sulfate containing compounds; carboxylic acid and carboxylate containing compounds; maleic-modified esters; organofunctional silanes; organometallic compounds such as zirconates, zircono aluminates and titanates; chlorinated olefins, etc. Some suitable adhesion promoters are carbamic acid [3-(triethoxysilyl) propyl]-bicyclo[2.2.1]hept-5-en-2-ylmethyl ester (NBCbSi), 3-(trimethoxysilyl) propyl methacrylate, [(5-bicyclo[2.2.1]hept-2-enyl)ethyl]trimethoxysilane, 5-bicyclo[2.2.1]hept-2-enyl)methyldichlorosilane, (5-bicyclo[2.2.1]hept-2-enyl)triethoxysilane, (5-bicyclo[2.2.1]hept-2-enyl)methyldiethoxysilane, (5-bicyclo[2.2.1]hept-2-enyl)dimethylethoxysilane, (3-acryloxypropyl) trimethoxysilane, n-(2-aminoethyl)-3-aminopropyltrimethoxysilane, (3-triethoxysilyl) propylsuccinic anhydride, 2-(3,4-epoxycyclohexyl)ethyltriethoxysilane, ((chloromethyl)phenylethyl)trimethoxysilane, 3-(guanidinyl) propyltrimethoxysilane, n,n-bis(2-hydroxyethyl)-3-aminopropyltriethoxysilane, styrylethyltrimethoxysilane, methacryloxymethyltrimethoxysilane, vinyltriethoxysilane, ureidopropyltriethoxysilane, 3-isocyanatopropyltriethoxysilane, triethoxysilyl modified poly-1,2-butadiene, bis(methyldiethoxysilylpropyl)amine, [2-(3-cyclohexenyl)ethyl]triethoxysilane, hexadecafluorododec-11-en-1-yltrimethoxysilane or mixtures of 2-hydroxyethyl bicyclo[2.2.1]hept-2-ene-5-carboxylate (HENB). Other typical adhesion promoters include coupling agents such as organosilanes (3-isocyanatopropyl triethoxysilane, bicyclo[2.2.1]hept-5-en-2-yl)ethyltrimethoxysilane), Bicyclo[2.2.1]hept-5-en-2-vi)triethoxysilane organozirconates, organotitanates (Manchem® products (Manchem® Zircoaluminates) (FedChem, LLC)(e.g., Manchem® A, Manchem® APG-X, Manchem® APG-1, Manchem® APG-2, Manchem® APG-3, Manchem® C, Manchem® CPG, Manchem® CPM, Manchem® F, Manchem® FPM, Manchem® M, Manchem® S, Manchem® 376, Manchem® 441) and Kenrich Petrochemicals products such as KR 55 (Titanium IV tetrakis (bis 2-propenolato methyl)-1-butanolato adduct 2 moles (di-tridecyl) hydrogen phosphite), KZ® TPPJ (Zirconium IV (2-ethyl, 2-propenolatomethyl) 1,3-propanediolato, cyclo bis 2-dimethylamino pyrophosphato-O, adduct with 2 moles of methanesulfonic acid), KZ® 55 (Zirconium IV tetrakis 2,2 (bis-2 propenolatomethyl) butanolato, adduct with 2 moles of di-tridecyl, hydrogen phosphite); phosphate and phosphate esters-containing resins (Sipomer PAM products from Solvay)(e.g., Sipomer PAM-100 (Phosphate esters of polyethylene glycol monomethacrylate), Sipomer PAM-200). Also other Sipomer products from Solvay containing other polar functional groups such as Sipomer WAM products, Sipomer WAM Il products, Sipomer COPS-1 products, Sipomer B-CEA, Sipomer BEM, Sipomer IBOA, Sipomer IBOMA, Sipomer SEM-25); carboxylic acid and anhydride-containing resins (Nucrel from DuPont (ethylene acrylic acid copolymer), Escor EAA copolymers from ExxonMobil Chemicals, POLYBOND (acrylic acid grafted polypropylene) from Addivant. Anhydride-containing resins such as FG1901, FG1924 (SEBS grafted with maleic anhydride) from Kraton, ROYALTUF 485, ROYALTUF 498 (EPDM polymers modified with maleic anhydride) from Addivant); isocyanate-containing resins (hexamethylene diisocyanate (HDI); 5-isocyanato-1-(isocyanatomethyl)-1,3,3-trimethyl-cyclohexane (commonly known as isophorone diisocyanate or IPDI); tetramethylxylene diisocyanate (TMXDI), methylene diphenyl diisocyanate (MDI-which may comprise any mixture of its three isomers 2,2′-MDI, 2,4′-MDI, and 4,4′-MDI); 4,4′methylene bis (cyclohexyl isocyanate)(H12MDI); hexamethylene-diisocyanatetrimer (HDIt); toluene diisocyanate (TDI-which may comprise any mixture of 2,4-TDI and 2,6-TDI); 2-biphenylyl isocyanate; 4-benzylphenyl isocyanate; toluene diisocyanates; PM200 (poly MDI), Lupranate® (poly MDI from BASF), Krasol® isocyanate terminated polybutadiene prepolymers, Krasol® LBD2000 (TDI based), Krasol® LBD3000 (TDI based), Krasol® NN-22 (MDI based), Krasol® NN-23 (MDI based), Krasol® NN-25 (MDI based); MDI prepolymer (Lupranate® 5080); liquid carbodiimide modified 4,4′-MDI (Lupranate® MM103); liquid MDI (Lupranate® MI); liquid MDI (e.g., Mondur® ML or Mondur® MLQ, which is a 50/50 blend of 4,4′-MDI and 2,4-MDI), or 2-hydroxyethyl acrylate (HEA) and liquid MDI (Mondur′ MLQ), or 9-decen-1-ol and liquid MDI (Mondur® MLQ), or oleyl alcohol and liquid MDI (Mondur® MLQ). The ratio between the alcohol and the liquid MDI varies from 1:1 to 1:10.; bicyclo[2.2.1]hept-5-ene-2-carboxylic acid, and 2-[[[[4-[(4-isocyanatophenyl)methyl]phenyl]amino]carbonyl]oxy]ethyl ester); chlorinated polyolefins such as Eastman CP 343-1, CP343-3, CP515-2, CP-164-1 (Eastman Chemical); Hardlen 13LP (Advanced Polymer); KEPRADH 949, 951, 958, 980, 982 (Kito Chemical); Lanco Intercoat VPP 154, 555 (Lubrizol); HARDLEN 15-LP, BS-40, CY-1132, CY-9122P, CY-9124P; TRAPYLEN 112X, 130X, 135X, 137X, 138S (Tramaco); Special-Primer pp 7560 (Worlee).

Preferably, the adhesion promoter comprises, consists essentially of, or consists of at least one compound containing at least two isocyanate groups. The at least one compound containing at least two isocyanate groups may be selected from a diisocyanate, a triisocyanate, and a polyisocyanate, such as, for example, toluene diisocyanate; tetramethylxylene diisocyanate (TMXDI); methylene diphenyl diisocyanate (MDI); a mixture of the three MDI isomers 2.2′-MDI, 2,4′-MDI, and 4,4′-MDI; liquid MDI; solid MDI; hexamethylenediisocyanatetrimer (HDIt); hexamethylenediisocyanate (HDI); isophorone diisocyanate (IPDI); 4,4′-methylene bis (cyclohexyl isocyanate)(H12MDI); polymeric MDI (PM200); MDI prepolymer; and liquid carbodiimide modified 4,4′-MDI. Preferably, the at least one compound containing at least two isocyanate groups is 4,4′-methylene diphenyl diisocyanate (MDI). The adhesion promoter may further comprise, consist essentially of, or consist of at least one compound containing at least one heteroatom-containing functional group and at least one metathesis—active olefin. The compound containing a heteroatom-containing functional group and a metathesis—active olefin may be selected from 5-norbornene-2-methanol (NB-MeOH); 2-hydroxyethyl bicyclo[2.2.1]hept-2-ene-5-carboxylate (HENB); and allyl alcohol. The adhesion promoter may also be the compound containing a heteroatom-containing functional group and a metathesis—active olefin reacted with the at least one compound containing at least two isocyanate groups. The adhesion promoter composition may be present in an amount ranging from 0.1-10 phr (e.g., 0.5-9.5 phr, 1-9 phr, 2-8 phr, 3-7 phr, 4-6 phr) or about 1 phr, 2, phr, 3 phr, 4 phr, 5 phr, 6 phr, 7 phr, 8 phr, 9 phr, or 10 phr.

Suitable rheology modifiers and anti-settling agents include inorganic and organic rheology modifiers. Inorganic rheology modifiers include clays and organoclays of hectorite, bentonite, attapulgite, kaoline, pyrophilite and talc; minerals such as fumed silica, precipitated silica, precipitated calcium carbonate, and montmorillonite, metal organic gellants such as zirconates, aluminates. Organic rheology modifiers include castor oil derivatives, modified polyurea, polyamides, calcium sulfonates, cellulose, hydrophobic ethoxylated urethane resins. Examples of suitable rheology modifiers include fumed silica such as Cab-O-Sil TS610, TS720 from Cabot Corp and AEROSIL 972, AEROSIL 974 from Evonik, organoclay such as BENTOLITE L-10, BENTOLITE-WH, CLAYTONE 40, CLAYTONE AF, MINERAL COLLOID BP, Garamite 7303 from BYK Chemie, USA; Bentonite 149, Bentonite 329, Bentonite 331, Bentonite 344 from Brentag Specialities, Attagel from BASF and the like, polyaminoamide phosphate, high molecular weight carboxylic acid salts of polyamine amides, and alkylene amine salts of an unsaturated fatty acid, all available from BYK Chemie USA as ANTI TERRA™, polyamide modified castor oil derivatives such as Luvotix ZHS, Luvitix ZH50 from Lehmann & Voss; micronized amide wax such as Crayvallac SUPER from Arkerna.

Suitable coupling agents include, for example, silane coupling agents known in the art. Examples of silane coupling agents include (3-glycidoxypropyl)trimethoxysilane (Silquest A187), (3-glycidoxypropyl)triethoxysilane (Silquest A1871), vinyltrimethoxysilane (Silquest A171), vinyltriethoxysilane (Silquest A151), methacryloxpropyltrimethoxysilane (Silquest A174NT), N-(2-aminoethyl)-3-aminopropyltrimethoxysilane (Silquest A1120), 3-aminopropyltrimethoxysilane (Silquest A1110), hexadecylltrimethoxysilane, isooctyltriethoxysilane, n-octyltriethoxysilane, isobutyltriethoxysilane, methyltrimethoxysilane, and N-ethyl-amino isobutyl trimethoxysilane (Silquest A-Link 15 Silane).

The composition(s) may contain additives such as dispersants/dispersing agents (surfactants) known in the art. Examples of dispersing agents and surfactants include sodium bis (tridecyl) sulfosuccinnate, di (2-ethylhexyl) sodium sulfosuccinnate, sodium dihexylsulfosuccinnate, sodium dicyclohexyl sulfosuccinnate, diamyl sodium sulfosuccinnate, sodium diisobutyl sulfosuccinate, disodium isodecyl sulfosuccinnate, disodium ethoxylated alcohol half ester of sulfosuccinnic acid, disodium alkyl amido polyethoxy sulfosuccinnate, tetrasodium N-(1,2-dicarboxy-ethyl)-N-oxtadecyl sulfosuccinnamate, disodium N-octasulfosuccinnamate, sulfated ethoxylated nonylphenol, 2-amino-2-methyl-1-propanol, and the like.

The composition(s) may further contain a metal or non-metal substrate material, including, for example, a plastic or polymer substrate, a polymer-coated substrate (e.g., primer-coated steel), a glass fiber substrate, a carbon fiber substrate, a natural fiber substrate, and a metal oxide substrate.

Preferably, the hybrid compositions of the invention do not contain dialkyl or diaryl peroxides, such as, for example, di-t-butyl peroxide and benzoyl peroxide.

### Articles of Manufacture of the Invention

The invention also relates to articles of manufacture comprising, consisting essentially of, or consisting of at least one hybrid composition of the invention.

The invention further relates to methods for making molded articles, comprising, consisting essentially of, or consisting of forming a resin composition comprising, consisting essentially of, or consisting of at least one hybrid composition of the invention, contacting the resin composition with at least one substrate, and subjecting the resin composition to conditions effective to promote an olefin metathesis reaction of the at least one cyclic olefin monomer.

### Coating Compositions of the Invention

The invention also relates to coating compositions comprising, consisting essentially of, or consisting of the hybrid compositions of the invention.

The invention also relates to a method for coating at least a portion of at least one surface of a substrate or object with a coating composition of the invention, comprising contacting at least a portion of the at least one surface of the substrate with the coating composition of the invention, and subjecting the coated substrate to conditions effective to promote an olefin metathesis reaction of the at least one cyclic olefin monomer in the presence of the at least one olefin metathesis catalyst and/or conditions effective to cure the resin composition polymerizable by addition or condensation polymerization. Therefore, the resin composition polymerizable by addition or condensation polymerization may also contain at least one curing agent (e.g., an organometallic complex, a free radical initiator, and a cationic initiator). The substrate surface is preferably a clean surface, but coating compositions of the invention may also be applied to “dirtier” surfaces than conventional epoxy-based coating compositions. A method of the invention may also apply a UV resistance topcoat over the coatings to provide protection against UV degradation as known in the art. A method of the invention accordingly produces an article of manufacture coated with a cured coating composition of the invention.

The adhesion to the substrate can be achieved by priming the substrate with an adhesion promoter or by adding an adhesion promoter as a coating additive to the coating formulation.

The substrates or objects to be coated may be of any configuration, any weight, any size, any thickness, and/or any geometric shape. Furthermore, the substrates or objects to be coated may be constructed of any material including but not limited to metal such as steel, stainless steel, aluminum, copper, metal alloys, iron, nickel, titanium, and silver as well as stone, plastics, rubbers, polymers, wood, cloth, ceramics, glass, carbon, brick, fabrics, cement, concrete, or composites, such as reinforced plastics and electronic assemblies.

The substrate or object surfaces to be coated may be partially or fully coated.

The coating compositions of the invention can be applied to the substrate material or object to be coated/protected by any method known in the art, including, without limitation, spraying, brushing, dipping, or rolling. The coating composition can be applied on the substrate material or object to be coated with a paint brush. The coating composition can also be sprayed on the substrate material or object to be coated with a film spray gun, a conventional spray gun, a plural component sprayer, a high-volume low pressure (HVLP) or an airless applicator.

The invention also relates to a cured article of manufacture, comprising, consisting essentially of, or consisting of the hybrid composition of the invention. The cured article of manufacture may, but does not need to, contain a reinforcement material, such as, for example, a substrate. Thus, the invention relates to cured articles of manufacture, comprising, consisting essentially of, or consisting of the hybrid composition of the invention, wherein the cured article does not contain a reinforcement material, such as, for example, a substrate.

### Adhesive Compositions of the Invention

The invention also relates to the use of the hybrid compositions of the invention as adhesives.

Adhesive compositions of the invention may be prepared by starting with pre-catalyzed compositions of the invention comprising, consisting essentially of, or consisting of the at least one cyclic olefin monomer, the at least one thermoplastic hydrocarbon resin, and the at least one olefin metathesis catalyst. These pre-catalyst compositions may then be mixed with the aforementioned additives to form uncured adhesive compositions of the invention. The uncured adhesive compositions may then be applied to at least some or all of the surface of a substrate and then cured.

### Examples

In the following examples, efforts have been made to ensure accuracy with respect to numbers used (e.g., amounts, temperature, etc.) but some experimental error and deviation should be accounted for. Unless indicated otherwise, temperature is in degrees Celsius[° C.] and pressure is at or near atmospheric. Additives added to the cyclic olefin compositions to form resin compositions are reported as phr, which is defined as the weight in grams of the additive per hundred grams of cyclic olefin composition. Ambient temperature and room temperature are used interchangeably herein and mean a temperature of 20-25° C.

As is known in the art, weight percent (wt %) can be represented by gas chromatography (GC) percent area (area %). Hence, GC area % obtained from the GC was reported as wt %. Weight percent (wt %) and percent by weight are used interchangeably herein.

GC Method used: Column: DB-5, 30 m×250 μm×0.25 μm film thickness or equivalent 5% Phenyl methyl Siloxane; Manufacturer: Agilent; GC and column conditions: Injector temperature: 280° C., Detector temperature: 310° C.; Oven temperature: Starting temperature: 50° C., hold time: 0.5 minute; Ramp rate 20° C./min to 210° C.; Ramp rate 5° C./min to 240° C.; Ramp rate 20° C./min to 280° C. hold time 2.5 minutes; Carrier gas: Helium 23.5 mL/min; Split ratio: 20.0:1.0.

All glassware was oven dried and reactions were performed under ambient conditions unless otherwise noted.

### Materials

All solvents and reagents were purchased from commercial suppliers and used as received unless otherwise noted.

The ruthenium catalysts used in the experimental procedures were prepared using known methods.

Irganox® 1076 antioxidant (BASF), butylated hydroxytoluene (BHT), CAB-O-SIL® TS720 (Cabot corporation), Mica C-3000 filler (IMERYS), Silquest® A-151 (Momentive) adhesion promoter, triphenylphosphine (TPP) from Hokko Chemical Industry Co. Ltd., and cumene hydroperoxide (CHP)(80% by weight solution from Millipore Sigma) were used where indicated. Isocyanurate of hexamethylene diisocyanate (HDI trimer)(Desmodur® N 3300A from Covestro), 1,3-propanediol (ProD)(Millipore Sigma), 1,5-pentanediol (PentD)(Millipore Sigma), ethylene glycol (EG)(Millipore Sigma), acetylacetone (Millipore Sigma), dibutyltin dilaurate (DBTDL)(Millipore Sigma), high molecular weight polyols from Huntsman (JEFFOL® FX31-240, JEFFOL® FE41-42), polyaspartic resins (Desmophen® NH 1220 (NH1220), Desmophen® NH 1420 (NH1420), and Desmophen® NH 1520 (NH1520)) from Covestro, and silicone resins from Dow Silicones (DOWSIL™ RSN-0431 HS Resin, DOWSIL™ RSN-6018 Resin Intermediate, DOWSIL™ RSN-6018 Resin Intermediate) and Wacker (SILRES® MSE 100, SILRES® KX, and SILRES® REN 70-M) were used where indicated.

UV-curable resins from Allnex, polyurethane (EBECRYL®4740), epoxidized soy oil acrylate (EBECRYL®5848), and bio-based aliphatic diacrylate (EBECRYL®5850), reactive diluent EBECRYL®160, and photoinitiators from Sigma Aldrich, 2-hydroxy-2-methyl-1-phenyl-1-propanone (same as DAROCUR® 1173) and phenylbis(2,4,6-trimethylbenzoyl) phosphine oxide (same as IRGACURE® 819) were used where indicated.

Standard epoxy resins, EPON™ Resin 828 and EPON™ Resin 862 (Hexion), imidazoles-2-ethylimidazole (El) and 2-ethyl-4-methylimidazole (EMI)(Millipore Sigma), hardeners-TH-432 (Kukdo Chemical Co.), KMH-153XB80 (Kukdo Chemical Co.), NMA 407 (Dixie Chemical), and solvents, ethyl acetate (EA)(Millipore Sigma), n-butyl acetate (n-BA)(Millipore Sigma), and methyl amyl ketone (MAK)(Millipore Sigma) were used where indicated.

Typical commercially available coating systems for CUI applications, comprising inorganic silicone-ceramic coating (C₁)(PPG HI-TEMP 1027™), silicone acrylic matrix (C₂)(PPG HI-TEMP™ 500), 2k aliphatic polyurethanes (C3, C4)(PPG Amershield™, PPG Amercoat® 450H), were used as is where indicated. The commercial coatings were formulated per respective technical data sheets.

DCPD (Ultrene® 99) was obtained from Cymetech Corporation. A representative lot of Ultrene® 99 comprised DCPD (99% by weight) and TCPD (1% by weight). A blend of DCPD/TCPD (43/57) was prepared by heat treatment of Ultrene® 99 generally as described in U.S. Pat. No. 4,899,005.

Low carbon steel of grade ASTM 4130 was purchased in 4″×4″ x ¼″ panels from Southwestern Paint Panels. Each panel was grit blasted using standard steel grits such that surface profile of the panels was between 2-3 mils for every substrate. After blasting, the steel substrate surface was cleaned with high pressure compressed air to remove particulates.

The following examples are to be considered as not being limiting of the invention as described herein and are instead provided as representative examples of hybrid compositions of the invention and methods for their use.

The following abbreviations are used in the examples: phr weight in grams of the component per hundred grams of reactive monomer C931

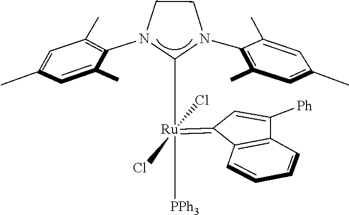

(1,3-Bis (2,4,6-trimethylphenyl)-2-imidazolidinylidene) ylidene)(triphenylphosphine) ruthenium[CAS 340810-50-69dichloro (3-phenyl-1H-inden-1

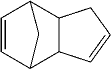

### DCPD

### Dicyclopentadiene[CAS 77-73-6]

It is to be understood that while the invention has been described in conjunction with specific embodiments thereof, that the description above as well as the examples that follow are intended to illustrate and not limit the scope of the invention. Other aspects, advantages, and modifications within the scope of the invention will be apparent to those skilled in the art to which the invention pertains.

### Example 1: Coating Formulations Preparation

Hybrid coatings or interpenetrating network (IPN) coatings were made using cyclic olefinic base formulations as Network 1 and the commercially available coating systems or generic coating formulations made in-house as Network 2. Different formulations were made by varying the ratios of Network 1: Network 2 as 75:25, 50:50, or 25:75. Control samples were made using the base olefinic formulations, the commercial coatings, or the generic formulations alone for comparison of performance with the hybrid coatings.

In the first step, pre-catalyzed Network 1 formulations were made by mixing the olefinic base monomer, DCPD/TCPD (43/57), with required amounts of some or all additives such as Irganox® 1076, CHP, or TPP, Silquest® A-151 adhesion promoter, CAB-O-SIL® TS-720, and Mica C-3000 in plastic mixing cups, suitable for use with FlackTek SpeedMixer®. For all the formulations, sequence of addition of the additives to the base monomer was maintained as: antioxidant, pot-life extender, adhesion promoter, and finally, filler. The components of Network 1 were mixed using a FlackTek SpeedMixer® at 1000-1600 rpm without vacuum for 2 minutes and 1000 rpm under vacuum for 1 minute. The mixing containers were sealed with tape and stored at ambient laboratory conditions (RT). Network 1 compositions N1 and N20 showed similar quantitative coating performance, indicating negligible effect of TPP on coating properties.

For IPNs containing the commercial coating systems as Network 2, resin components (Part A) were stirred by hand or mechanical stirrer to ensure complete homogeneity of the resin prior to making the formulations.

For 1K commercial systems, freshly stirred coating formulation was mixed with Network 1 in desired weight ratios directly to make hybrid formulations of varying ratios. For 2K commercial systems, freshly re-mixed Part A and their respective hardeners (Part B) were first mixed in plastic mixing cups per instructions in the respective technical data sheets. The mixtures of Parts A and B of the 2K systems were counted as Network 2. The mixtures were then mixed with Network 1 in desired ratios to make pre-catalyzed hybrid formulations.

Apart from the commercial systems, IPN formulations were also made comprising of generic polyurethane (PU) or epoxy systems (made in-house) as Network 2. For formulations containing generic PU, stoichiometric amounts of HDI trimer and polyols (ProD, PentD, EG, JEFFOL® FX31-240, JEFFOL® FE41-42) were first added to plastic mixing cups. The polyols were either used separately or in combination with each other to introduce hard or soft organic phases in the final hybrid coatings. Ratio of equivalence of NCO to hydroxyl functionality was maintained at 1.1:1 for all PU formulations. ≤10% by weight acetylacetone, used as a pot-life extender, was then added to the mixing cup where indicated, followed by addition of the solvents and filler. The contents of the mixing cups were first mixed thoroughly by hand using a wooden spatula and then with a FlackTek SpeedMixer® at 2500 rpm for 3 minutes. Lastly, the different PU mixes were catalyzed using DBTDL catalyst (used directly or as a 1% by weight solution in toluene). The catalyzed PU mixes were stirred vigorously by hand using a wooden spatula. The catalyzed PU mixes were stored at RT and used within 2 hours after mixing the catalyst.

For formulations containing generic epoxy formulations, standard epoxy resins, EPON™ Resin 828 or EPON™ Resin 862, were mixed with hardeners in plastic mixing containers using a wooden spatula. For formulations without imidazoles, amount of hardeners was calculated using AHEW of the different hardeners. Ratio of equivalence of epoxy to active hydrogens in the hardeners was maintained at 1:1 for all the different formulations. For formulations with imidazoles, amount of imidazole was maintained at 3 phr. Like the generic PU, required amounts of solvents (EA, n-BA, MAK or their combinations) and filler Mica C-3000 were added to the epoxy-imidazole mixing containers. The generic epoxy formulations were mixed thoroughly by hand using a wooden spatula, then with a FlackTek SpeedMixer® at 2500 rpm for 3 minutes, and stored at RT.

To make the hybrid coating formulations, required amounts of the pre-catalyzed Network 1 and the generic Network 2 were mixed together in different plastic mixing containers. The hybrid coating formulations were mixed by hand using a wooden spatula for 10 seconds to ensure complete homogeneity of the mixtures. All the liquid hybrid formulations were used within 1 hour of preparation. Tables 1 and 2 show the compositions of individual networks[N] and the compositions of different hybrid formulations[H], respectively.

TABLE 1
Compositions of individual networks [N]

| | Component | Component | Component | Irganox | CAB-O-SIL | Hardener/ | Additive 1/ | Additive 2/ |
|---|---|---|---|---|---|---|---|---|
| [N#] | 1 | 2 | 1:Component 2 | 1076 (phr) | TS720 (phr) | amount (phr) | amount (phr) | amount (phr) |
| N1 | DCPD/TCPD | — | 100:0 | 1 | — | C931 solution/ | TPP/0.6 | — |
| | (43/57) | | | | | 2 | | |
| N2 | DCPD/TCPD | — | 100:0 | 1 | — | C931 solution/ | Silquest A- | — |
| | (43/57) | | | | | 2 | 151/2 | |
| N3 | DCPD/TCPD | — | 100:0 | 1 | 6 | C931 solution/ | CHP/ | — |
| | (43/57) | | | | | 2 | 0.015 | |
| N4 | PentD | — | 100:0 | — | — | HDI trimer | DBTDL/ | Acetylacetone/ |
| | | | | | | | 0.5 | 10 |
| N5 | ProD | — | 100:0 | — | — | HDI trimer | DBTDL/ | Acetylacetone/ |
| | | | | | | | 0.5 | 10 |
| N6 | EPON ™ | — | 100:0 | — | — | El solution/ | | — |
| | Resin 828 | | | | | 6 | | |
| N7 | EPON ™ | — | 100:0 | — | — | EMI/3 | — | — |
| | Resin 828 | | | | | | | |
| N8 | EPON ™ | — | 100:0 | — | — | NMA 407/98 | — | — |
| | Resin 828 | | | | | | | |
| N9 | PentD | — | 100:0 | — | — | HDI trimer | DBTDL/ | — |
| | | | | | | | 0.07 | |
| N10 | JEFFOL ® | — | 100:0 | — | — | HDI trimer | DBTDL/ | — |
| | FE41-42 | | | | | | 0.07 | |
| N11 | JEFFOL ® | PentD | 50:50 | — | — | HDI trimer | DBTDL/ | — |
| | FE41-42 | | | | | | 0.07 | |
| N12 | JEFFOL ® | — | 100:0 | — | — | HDI trimer | DBTDL/ | — |
| | FE41-42 | | | | | | 2 | |
| N13 | JEFFOL ® | PentD | 50:50 | — | — | HDI trimer | DBTDL/ | — |
| | FE41-42 | | | | | | 2 | |
| N14 | JEFFOL ® | — | 100:0 | — | — | HDI trimer | DBTDL/ | — |
| | FX31-240 | | | | | | 0.5 | |
| N15 | JEFFOL ® | EG | 50:50 | — | — | HDI trimer | DBTDL/ | — |
| | FX31-240 | | | | | | 0.5 | |
| N16 | EG | — | 100:0 | — | — | HDI trimer | DBTDL/ | — |
| | | | | | | | 0.5 | |
| N17 | NH1520 | — | 100:0 | — | — | HDI trimer | — | — |
| N18 | EPON ™ | — | 100:0 | — | — | TH-432 | — | — |
| | Resin 828 | | | | | | | |
| N19 | EPON ™ | — | 100:0 | — | — | KMH | — | — |
| | Resin 828 | | | | | | | |
| N20 | DCPD/TCPD | — | 100:0 | — | — | C931 solution/ | — | — |
| | (43/57) | | | | | 2 | | |
| N21 | NH1220 | — | 100:0 | — | — | HDI trimer | — | — |
| N22 | NH1420 | — | 100:0 | — | — | HDI trimer | — | — |
| N23 | NH1220 | — | 100:0 | — | — | HDI uretdione | — | — |
| N24 | NH1420 | — | 100:0 | — | — | HDI uretdione | — | — |
| N25 | NH1520 | — | 100:0 | — | — | HDI uretdione | — | — |
| N26 | NH1220 | — | 100:0 | — | — | IPDI trimer | — | — |
| N27 | NH1420 | — | 100:0 | — | — | IPDI trimer | — | — |
| N28 | NH1520 | — | 100:0 | — | — | IPDI trimer | — | — |
| N29 | NH1220 | — | 100:0 | — | — | NZ | — | — |
| N30 | NH1420 | — | 100:0 | — | — | NZ | — | — |
| N31 | NH1520 | — | 100:0 | — | — | NZ | — | — |

TABLE 2
Compositions of different hybrid formulations [H]

| | | | Net- | | | Solvent |
|---|---|---|---|---|---|---|
| | | | work | Filler/ | Solvent/ | 2/ |
| | Net- | Net- | 1:Net- | amount | amount | amount |
| [H#] | work 1 | work 2 | work 2 | (phr) | (phr) | (phr) |
| H1 | N2 | C1 | 75:25 | Mica C- | — | — |
| | | | | 3000/40 | | |
| H2 | N2 | C1 | 50:50 | Mica C- | — | — |
| | | | | 3000/40 | | |
| H3 | N2 | C1 | 25:75 | Mica C- | — | — |
| | | | | 3000/40 | | |
| H4 | N3 | C2 | 75:25 | — | — | — |
| H5 | N3 | C2 | 50:50 | — | — | — |
| H6 | N3 | C2 | 25:75 | — | — | — |
| H7 | N3 | N4 | 75:25 | — | EA/40 | — |
| H8 | N3 | N4 | 50:50 | — | EA/40 | — |
| H9 | N3 | N4 | 25:75 | — | EA/40 | — |
| H10 | N3 | C3 | 75:25 | — | — | — |
| H11 | N3 | C3 | 50:50 | — | — | — |
| H12 | N3 | C3 | 25:75 | — | — | — |
| H13 | N3 | C4 | 75:25 | — | — | — |
| H14 | N3 | C4 | 50:50 | — | — | — |
| H15 | N3 | C4 | 25:75 | — | — | — |
| H16 | N1 | N4 | 75:25 | Mica C- | EA/40 | — |
| | | | | 3000/40 | | |
| H17 | N1 | N4 | 50:50 | Mica C- | EA/40 | — |
| | | | | 3000/40 | | |
| H18 | N1 | N4 | 25:75 | Mica C- | EA/40 | — |
| | | | | 3000/40 | | |
| H19 | N1 | N5 | 75:25 | Mica C- | EA/40 | — |
| | | | | 3000/40 | | |
| H20 | N1 | N5 | 50:50 | Mica C- | EA/40 | — |
| | | | | 3000/40 | | |
| H21 | N1 | N5 | 25:75 | Mica C- | EA/40 | — |
| | | | | 3000/40 | | |
| H22 | N3 | C1 | 75:25 | — | — | — |
| H23 | N3 | C1 | 50:50 | — | — | — |
| H24 | N3 | C1 | 25:75 | — | — | — |
| H25 | N1 or | N6 | 75:25 | Mica C- | n-BA/25 | — |
| | N20 | | | 3000/40 | | |
| H26 | N1 or | N6 | 50:50 | Mica C- | n-BA/25 | — |
| | N20 | | | 3000/40 | | |
| H27 | N1 or | N6 | 25:75 | Mica C- | n-BA/25 | — |
| | N20 | | | 3000/40 | | |
| H28 | N1 or | N7 | 75:25 | Mica C- | n-BA/25 | — |
| | N20 | | | 3000/40 | | |
| H29 | N1 or | N7 | 50:50 | Mica C- | n-BA/25 | — |
| | N20 | | | 3000/40 | | |
| H30 | N1 or | N7 | 25:75 | Mica C- | n-BA/25 | — |
| | N20 | | | 3000/40 | | |
| H31 | N1 or | N8 | 50:50 | Mica C- | n-BA/20 | — |
| | N20 | | | 3000/40 | | |
| H32 | N1 or | N9 | 50:50 | Mica C- | n-BA/20 | — |
| | N20 | | | 3000/40 | | |
| H33 | N1 or | N10 | 50:50 | Mica C- | n-BA/20 | — |
| | N20 | | | 3000/40 | | |
| H34 | N1 or | N11 | 50:50 | Mica C- | n-BA/20 | — |
| | N20 | | | 3000/40 | | |
| H35 | N1 or | N12 | 50:50 | Mica C- | n-BA/20 | — |
| | N20 | | | 3000/40 | | |
| H36 | N1 or | N13 | 50:50 | Mica C- | n-BA/20 | — |
| | N20 | | | 3000/40 | | |
| H37 | N1 or | N14 | 75:25 | Mica C- | n-BA/10 | MAK/10 |
| | N20 | | | 3000/50 | | |
| H38 | N1 or | N14 | 50:50 | Mica C- | n-BA/10 | MAK/10 |
| | N20 | | | 3000/50 | | |
| H39 | N1 or | N14 | 25:75 | Mica C- | n-BA/10 | MAK/10 |
| | N20 | | | 3000/50 | | |
| H40 | N1 or | N15 | 75:25 | Mica C- | n-BA/10 | MAK/10 |
| | N20 | | | 3000/50 | | |
| H41 | N1 or | N15 | 50:50 | Mica C- | n-BA/10 | MAK/10 |
| | N20 | | | 3000/50 | | |
| H42 | N1 or | N15 | 25:75 | Mica C- | n-BA/10 | MAK/10 |
| | N20 | | | 3000/50 | | |
| H43 | N1 or | N16 | 75:25 | Mica C- | n-BA/10 | MAK/10 |
| | N20 | | | 3000/50 | | |
| H44 | N1 or | N16 | 50:50 | Mica C- | n-BA/10 | MAK/10 |
| | N20 | | | 3000/50 | | |
| H45 | N1 or | N16 | 25:75 | Mica C- | n-BA/10 | MAK/10 |
| | N20 | | | 3000/50 | | |
| H46 | N1 or | N17 | 75:25 | Mica C- | n-BA/10 | MAK/10 |
| | N20 | | | 3000/50 | | |
| H47 | N1 or | N17 | 50:50 | Mica C- | n-BA/10 | MAK/10 |
| | N20 | | | 3000/50 | | |
| H48 | N1 or | N17 | 25:75 | Mica C- | n-BA/10 | MAK/10 |
| | N20 | | | 3000/50 | | |
| H49 | N1 or | N6 | 75:25 | Mica C- | n-BA/10 | MAK/10 |
| | N20 | | | 3000/50 | | |
| H50 | N1 or | N6 | 50:50 | Mica C- | n-BA/10 | MAK/10 |
| | N20 | | | 3000/50 | | |
| H51 | N1 or | N6 | 25:75 | Mica C- | n-BA/10 | MAK/10 |
| | N20 | | | 3000/50 | | |
| H52 | N1 or | N8 | 75:25 | Mica C- | n-BA/10 | MAK/10 |
| | N20 | | | 3000/50 | | |
| H53 | N1 or | N8 | 50:50 | Mica C- | n-BA/10 | MAK/10 |
| | N20 | | | 3000/50 | | |
| H54 | N1 or | N8 | 25:75 | Mica C- | n-BA/10 | MAK/10 |
| | N20 | | | 3000/50 | | |
| H55 | N1 or | N18 | 75:25 | Mica C- | n-BA/10 | MAK/10 |
| | N20 | | | 3000/50 | | |
| H56 | N1 or | N18 | 50:50 | Mica C- | n-BA/10 | MAK/10 |
| | N20 | | | 3000/50 | | |
| H57 | N1 or | N18 | 25:75 | Mica C- | n-BA/10 | MAK/10 |
| | N20 | | | 3000/50 | | |
| H58 | N1 or | N19 | 75:25 | Mica C- | n-BA/10 | MAK/10 |
| | N20 | | | 3000/50 | | |
| H59 | N1 or | N19 | 50:50 | Mica C- | n-BA/10 | MAK/10 |
| | N20 | | | 3000/50 | | |
| H60 | N1 or | N19 | 25:75 | Mica C- | n-BA/10 | MAK/10 |
| | N20 | | | 3000/50 | | |
| H61 | N20 | N21 | 75:25 | Mica C- | n-BA/10 | MAK/10 |
| | | | | 3000/50 | | |
| H62 | N20 | N21 | 50:50 | Mica C- | n-BA/10 | MAK/10 |
| | | | | 3000/50 | | |
| H63 | N20 | N21 | 25:75 | Mica C- | n-BA/10 | MAK/10 |
| | | | | 3000/50 | | |
| H64 | N20 | N22 | 75:25 | Mica C- | n-BA/10 | MAK/10 |
| | | | | 3000/50 | | |
| H65 | N20 | N22 | 50:50 | Mica C- | n-BA/10 | MAK/10 |
| | | | | 3000/50 | | |
| H66 | N20 | N22 | 25:75 | Mica C- | n-BA/10 | MAK/10 |
| | | | | 3000/50 | | |
| H67 | N20 | N23 | 75:25 | Mica C- | n-BA/10 | MAK/10 |
| | | | | 3000/50 | | |
| H68 | N20 | N23 | 50:50 | Mica C- | n-BA/10 | MAK/10 |
| | | | | 3000/50 | | |
| H69 | N20 | N23 | 25:75 | Mica C- | n-BA/10 | MAK/10 |
| | | | | 3000/50 | | |
| H70 | N20 | N24 | 75:25 | Mica C- | n-BA/10 | MAK/10 |
| | | | | 3000/50 | | |
| H71 | N20 | N24 | 50:50 | Mica C- | n-BA/10 | MAK/10 |
| | | | | 3000/50 | | |
| H72 | N20 | N24 | 25:75 | Mica C- | n-BA/10 | MAK/10 |
| | | | | 3000/50 | | |
| H73 | N20 | N25 | 75:25 | Mica C- | n-BA/10 | MAK/10 |
| | | | | 3000/50 | | |
| H74 | N20 | N25 | 50:50 | Mica C- | n-BA/10 | MAK/10 |
| | | | | 3000/50 | | |
| H75 | N20 | N25 | 25:75 | Mica C- | n-BA/10 | MAK/10 |
| | | | | 3000/50 | | |
| H76 | N20 | N26 | 75:25 | Mica C- | n-BA/10 | MAK/10 |
| | | | | 3000/50 | | |
| H77 | N20 | N26 | 50:50 | Mica C- | n-BA/10 | MAK/10 |
| | | | | 3000/50 | | |
| H78 | N20 | N26 | 25:75 | Mica C- | n-BA/10 | MAK/10 |
| | | | | 3000/50 | | |
| H79 | N20 | N27 | 75:25 | Mica C- | n-BA/10 | MAK/10 |
| | | | | 3000/50 | | |
| H80 | N20 | N27 | 50:50 | Mica C- | n-BA/10 | MAK/10 |
| | | | | 3000/50 | | |
| H81 | N20 | N27 | 25:75 | Mica C- | n-BA/10 | MAK/10 |
| | | | | 3000/50 | | |
| H82 | N20 | N28 | 75:25 | Mica C- | n-BA/10 | MAK/10 |
| | | | | 3000/50 | | |
| H83 | N20 | N28 | 50:50 | Mica C- | n-BA/10 | MAK/10 |
| | | | | 3000/50 | | |
| H84 | N20 | N28 | 25:75 | Mica C- | n-BA/10 | MAK/10 |
| | | | | 3000/50 | | |
| H85 | N20 | N29 | 75:25 | Mica C- | n-BA/10 | MAK/10 |
| | | | | 3000/50 | | |
| H86 | N20 | N29 | 50:50 | Mica C- | n-BA/10 | MAK/10 |
| | | | | 3000/50 | | |
| H87 | N20 | N29 | 25:75 | Mica C- | n-BA/10 | MAK/10 |
| | | | | 3000/50 | | |
| H88 | N20 | N30 | 75:25 | Mica C- | n-BA/10 | MAK/10 |
| | | | | 3000/50 | | |
| H89 | N20 | N30 | 50:50 | Mica C- | n-BA/10 | MAK/10 |
| | | | | 3000/50 | | |
| H90 | N20 | N30 | 25:75 | Mica C- | n-BA/10 | MAK/10 |
| | | | | 3000/50 | | |
| H91 | N20 | N31 | 75:25 | Mica C- | n-BA/10 | MAK/10 |
| | | | | 3000/50 | | |
| H92 | N20 | N31 | 50:50 | Mica C- | n-BA/10 | MAK/10 |
| | | | | 3000/50 | | |
| H93 | N20 | N31 | 25:75 | Mica C- | n-BA/10 | MAK/10 |
| | | | | 3000/50 | | |

COMPARISON DATA

| | | | | | |
|---|---|---|---|---|---|
| HC1 | N2 | 100:0 | Mica C- | — | — |
| | | | 3000/40 | | |
| HC2 | C1 | 100:0 | — | — | — |
| HC3 | N3 | 100:0 | — | — | — |
| HC4 | C2 | 100:0 | — | — | — |
| HC5 | N4 | 100:0 | — | EA/40 | — |
| HC6 | C3 | 100:0 | — | — | — |
| HC7 | C4 | 100:0 | — | — | — |
| HC8 | N1 | 100:0 | Mica C- | — | — |
| | | | 3000/40 | | |
| HC9 | N4 | 100:0 | Mica C- | — | — |
| | | | 3000/40 | | |
| HC10 | N5 | 100:0 | Mica C- | — | — |
| | | | 3000/40 | | |
| HC11 | N6 | 100:0 | Mica C- | n-BA/25 | — |
| | | | 3000/40 | | |
| HC12 | N7 | 100:0 | Mica C- | n-BA/25 | — |
| | | | 3000/40 | | |
| HC13 | N8 | 100:0 | Mica C- | n-BA/20 | — |
| | | | 3000/40 | | |
| HC14 | N9 | 100:0 | Mica C- | n-BA/20 | — |
| | | | 3000/40 | | |
| HC15 | N10 | 100:0 | Mica C- | n-BA/20 | — |
| | | | 3000/40 | | |
| HC16 | N11 | 100:0 | Mica C- | n-BA/20 | — |
| | | | 3000/40 | | |
| HC17 | N12 | 100:0 | Mica C- | n-BA/20 | — |
| | | | 3000/40 | | |
| HC18 | N13 | 100:0 | Mica C- | n-BA/20 | — |
| | | | 3000/40 | | |
| HC19 | N14 | 100:0 | Mica C- | n-BA/10 | MAK/10 |
| | | | 3000/50 | | |
| HC20 | N15 | 100:0 | Mica C- | n-BA/10 | MAK/10 |
| | | | 3000/50 | | |
| HC21 | N16 | 100:0 | Mica C- | n-BA/10 | MAK/10 |
| | | | 3000/50 | | |
| HC22 | N17 | 100:0 | Mica C- | n-BA/10 | MAK/10 |
| | | | 3000/50 | | |
| HC23 | N1 | 100:0 | Mica C- | — | — |
| | | | 3000/50 | | |
| HC24 | N6 | 100:0 | Mica C- | n-BA/10 | MAK/10 |
| | | | 3000/50 | | |
| HC25 | N8 | 100:0 | Mica C- | n-BA/10 | MAK/10 |
| | | | 3000/50 | | |
| HC26 | N18 | 100:0 | Mica C- | n-BA/10 | MAK/10 |
| | | | 3000/50 | | |
| HC27 | N19 | 100:0 | Mica C- | n-BA/10 | MAK/10 |
| | | | 3000/50 | | |
| HC28 | N20 | 100:0 | Mica C- | — | — |
| | | | 3000/50 | | |
| HC29 | N21 | 100:0 | Mica C- | n-BA/10 | MAK/10 |
| | | | 3000/50 | | |
| HC30 | N22 | 100:0 | Mica C- | n-BA/10 | MAK/10 |
| | | | 3000/50 | | |
| HC31 | N23 | 100:0 | Mica C- | n-BA/10 | MAK/10 |
| | | | 3000/50 | | |
| HC32 | N24 | 100:0 | Mica C- | n-BA/10 | MAK/10 |
| | | | 3000/50 | | |
| HC33 | N26 | 100:0 | Mica C- | n-BA/10 | MAK/10 |
| | | | 3000/50 | | |
| HC34 | N27 | 100:0 | Mica C- | n-BA/10 | MAK/10 |
| | | | 3000/50 | | |
| HC35 | N28 | 100:0 | Mica C- | n-BA/10 | MAK/10 |
| | | | 3000/50 | | |
| HC36 | N29 | 100:0 | Mica C- | n-BA/10 | MAK/10 |
| | | | 3000/50 | | |

### Example 2: General Procedure for Coating Metal Substrate Panels

Metal Panel Surface Preparation (NACE SSPC SP10 standard)

Carbon steel panels (4″×4″ x ¼″) were grit-blasted using steel grits according to NACE SSPC SP10 standard with a resulting surface profile of 2-3 mils. The uncured liquid hybrid coating mixtures were then applied onto the panels within 4 hours after gritblasting.

### Application and Curing of Hybrid Formulations

Before applying the uncatalyzed hybrid formulations, 2 phr C931 Ru catalyst solution (0.8% by weight in mineral oil) was added to the hybrid formulations. The amount of catalyst solution to be added was calculated based on the amount of the olefinic Network 1 alone. The Ru catalyzed formulations were then mixed using a wooden spatula for 10 seconds and applied onto the grit blasted steel substrates immediately using a film applicator set at 20 mil wet film thickness. Control formulations with only the olefinic Network 1 were also catalyzed using 2 phr C931 catalyst solution prior to application.

All the hybrid formulations were cured at RT for 7 days, except coatings containing the generic epoxy-imidazole component (H25 to H30) as Network 2. Formulations H25 to H30 were allowed to stand in a ventilated hood under ambient conditions for 15-20 minutes and then heated using a hand-held infrared (IR) lamp for 8 minutes. Distance between the IR lamp and the catalyzed hybrid coatings was maintained at 4.5-5 inches.

A replicate set of panels was made for select formulations that were tested for cathodic disbondment performance. This replicate set was post-cured in a convection oven at 150° C. for 1 hour.

The thickness of the dry film coatings was measured using an ultrasonic thickness gauge from Elcometer. A total of 3 measurements were taken on each coating.

Proxima hybrid formulations include resins that are curable using ultraviolet (UV) or visible light—not just IR. Therefore, the tunable nature of hybrid coating systems enables other curing mechanisms such as curing with exposure to UV light and/or visible light, i.e., sunlight. To test this hypothesis, coating panels were made by combining Proxima base monomer (N20) with commercially available UV-curable resins.

Network 1 comprised of Proxima monomer (N20) and 40 phr mica. The two components for Network 1 were mixed using a FlackTek high speed mixer at 2530 rpm for 2 minutes.

For Network 2, three different UV-curable resins, polyurethane (EBECRYL®4740), epoxidized soy oil acrylate (EBECRYL®5848), and bio-based aliphatic diacrylate (EBECRYL®5850), were used to make UV-curable hybrid coating formulations. EBECRYL®160 was used as a reactive diluent in combination with the three UV-curable resins to make three different UV-curable resin mixes. EBECRYL®160 was expected to adjust viscosity of the mixes and introduce crosslinks in the final coating.

The ratio of the commercial UV-curable resins and the reactive diluent was maintained at 70:30 for all the formulations. 40 phr mica was added to the resins that formed Network 2. Lastly, photoinitiators 2-hydroxy-2-methyl-1-phenyl-1-propanone (same as DAROCUR® 1173) and phenylbis(2,4,6-trimethylbenzoyl) phosphine oxide (same as IRGACURE® 819), were added to the filled UV-curable base mixes separately to make different Network 2 compositions. The amount of the photoinitiators was maintained at 3% by weight of reactive solids, i.e., select resins and reactive diluent for all the formulations.

All components of Network 2 were mixed using a FlackTek high speed mixer at 2530 rpm for 2 minutes to form Network 2 base compositions comprising of varying UV-curable resins.

Hybrid coating formulations were made by weighing equal parts of the Networks 1 and 2 base compositions in a plastic mixing container with lid to maintain 1:1 by weight ratio of the reactive components in the final hybrid formulation. The liquid hybrid formulations were mixed using a FlackTek high speed mixer at 2530 rpm for 2 minutes to form a homogenous mix. Then, 2% by weight of Network 1 Ru catalyst (C931) suspension was added to all the hybrid formulations. The hybrid formulations were mixed by hand using a wooden spatula in clock-wise circular movement for 10 seconds. The formulations were then applied on grit-blasted metal coupons using a film applicator at WFT of 20 mils.

Coatings with 2-hydroxy-2-methyl-1-phenyl-1-propanone photoinitiator were placed under a handheld UV lamp, UVA Hand 250 from Panacol-USA (intensity=250k μW/cm2) for 5 minutes. Coatings with phenylbis(2,4,6-trimethylbenzoyl) phosphine oxide photoinitiator were exposed to sunlight for 5 minutes.

Panels were also made using Network 2 base compositions alone without Proxima and cured using UV lamp (2-minute exposure) or sunlight (2-minute exposure), depending on the photoinitiator used in the base composition. This preliminary experiment showed that hard, tack-free hybrid coating films can be easily formed upon exposure to UV light or sunlight in 2-5 minutes.

Proxima hybrid formulations comprising moisture-curing silicone resins, similar to hybrid formulations with UV-curable resins, were also prepared. Experiments were conducted with commercially available silicone resins that form tack-free coating films in presence of moisture. Hybrid formulations were made using Proxima base mix (N20) as Network 1 and three different silicone resins from Wacker as Network 2. The two networks, along with other additives (40 phr mica, 10 phr solvent) were mixed as described above. After mixing, 2% by weight of Network 1 Ru catalyst was added to the hybrid formulations and stirred manually using a wooden spatula in plastic mixing containers.

### Example 3: Testing of the Sheet Steel Coated Panels

Pull-off adhesion test according to ASTM D4541

This test method covers a procedure for evaluating the pull-off strength (commonly referred to as adhesion) of a coating from metal substrates. The major components of a pull-off adhesion tester are a pressure source, a pressure gage, and an actuator. During operation, the flat face of a pull stub (dolly) is adhered to the coating to be evaluated.

Prior to the adhesion test, a 2K epoxy adhesive (Defelsko) was prepared by mixing the 2 components in 1:1 ratio in a FlackTek SpeedMixer. Test areas were prepared on the cured hybrid coatings by scoring using a 14 mm diameter circular hole saw, such that 14 mm diameter isolated coating circles were formed with exposed steel surface around the circumference of the circles. Aluminum (14 mm) dollies were grit blasted similar to the carbon steel substrates, while the coating circles were roughened using a sandpaper (100 grit).

The epoxy adhesive was then applied onto the roughened dollies to cover the entire grit blasted base of the dolly. The dollies were then carefully placed onto the coating test circles, such that the dollies were exactly perpendicular to the substrate. Any excess adhesive was carefully removed to prevent adhesion onto the bare substrate surrounding the dolly. The epoxy glue on the coatings with the dollies were cured at RT for 24 hours. Three test areas were prepared per coating. Using an automated PosiTest adhesion tester (Defelsko), the dollies were pulled from the coating. Adhesion strength was reported as the average of three adhesion values required to completely detach the dollies from the coating.

Qualitative failure modes were recorded to identify mechanism of failure after the pull-off adhesion test: A=adhesive failure of coating to steel substrate; C=cohesive failure of coating, G=adhesive or cohesive failure of epoxy glue between coating and dolly. The pull-off strength data is expressed with a ranking system, as described in Table 3.

Pull-off adhesion performance data of the coatings, cured at room temperature, is displayed in Table 4. Similarly, the adhesion performance of the post-cured coatings, is shown in Table 5.

Hot water immersion test according to ASTM D870

This test covers the basic principles and operating procedures for testing water resistance of coatings by the partial or complete immersion of coated specimens in distilled or de-mineralized water at ambient or elevated temperatures.

Prior to the test, exposed metal on the coated panels was painted with a layer of standard protective coating to protect the exposed substrate from corrosion. The protective paint was allowed to cure at RT for 24 hours.

After 24 hours, the cured hybrid coatings, with the dry protective layer covering the exposed substrate, were placed in an enclosed water bath. The water bath was then filled with deionized water to completely submerge the cured coatings. Temperature of the water bath was increased to 95° C. After 7 days, the panels were removed from the water bath. Visual observations were made to identify changes in the coatings after the test. Also, pull-off adhesion test (ASTM D4541) was conducted on the panels according to procedure explained above. Tables 4 and 5 show adhesion performance of the coatings cured at room temperature and the coatings cured at elevated temperature (post-cured) respectively. Hot/Dry Heat Aging Test

Carbon steel panels coated with the cured hybrid coatings were placed in a forced air oven subjected to heating continuously at 205° C. The panels were taken out of the oven and cooled down to room temperatures periodically for inspection. The time in days when first crack was observed in the coatings was recorded as shown in Table 4 (room temperature cured coatings) and Table 5 (post-cured coatings).

Cathodic disbondment test (CDT) according to NACE Standard TM0115-2015

This test method covers a procedure for evaluating the cathodic disbondment resistance of the steel structure coating systems under cathodic protection.

A circular holiday, 0.25″ (6 mm) in diameter, was created in the center of the coatings, such that the drill exposed the underlying substrate. The panels were attached to the CDT cells fabricated according to specifications in NACE Standard TM0115-2015.

Approximately 300 ml of 3% by weight NaCl solution was poured into the CDT cells. A saturated calomel electrode (SCE), used as the reference electrode, was inserted into the solution through the solution port. A titanium mesh coated with mixed metal oxide was introduced as the anode. The anode was isolated inside a plastic tube with a glass wool plug (NACE Standard TM0115-2015). A potential of −1.38+0.02 V vs. SCE was applied to the panel using a DC supply unit (Instek GPS-18300), with the panel connected to the negative terminal and the isolated anode connected to the positive terminal. The test was conducted at ambient room conditions for 28 days.

After 28 days, four radial direction cuts were made through the drilled holiday in the coating using a sharp blade. Then, a rigid pointed knife was used to “chip” or delaminate the coatings around the drilled holiday, by inserting the knife between the coating and the substrate with a lever action, until no more disbondment or delamination can be detected. The results from the test are reported as the cathodic disbondment length: cathodic disbondment=(average disbondment diameter-drilled holiday diameter)/2. A coating that shows disbondment length≤8.5 mm is typically considered to have passed the test.

Hybrid formulations characterized for CDT performance were H26 and H47, both of which were post-cured at 150° C. for 1 hour. Post-cured H26 and H47 showed CDT lengths of 5.95 mm and 17.1 mm respectively. The results, thus, showed that post-cured formulation H26, comprising of cyclic olefin and epoxy resin cured using El imidazole, in 50:50 weight ratio, passed the test.

### Electrochemical Testing

Select room-temperature cured hybrid coatings (formulations H47, H56, and H59) were characterized using standard electrochemical tests such as Electrochemical Impedance Spectroscopy (EIS) to determine polarization resistance (Rp) and evaluate corrosion rate (Linear Polarization Resistance; LPR-CR) of the coatings.

An acrylic tube (3.5″ long, 1.3″ inner diameter, ⅛″ thick) was glued onto each select hybrid coating coupon perpendicularly using standard gorilla glue.

The glue was allowed to cure overnight under ambient laboratory conditions.

The next day, the tubes were filled up to approximately 3″ with sodium chloride (NaCl) solution (3.5 wt. % in deionized water) to “soak” the coatings in a salt-rich environment at ambient laboratory conditions.

After approximately 12-16 hours of soak, a reference electrode (saturated calomel electrode; SCE) and a counter electrode (graphite rod) were inserted into the acrylic tubes containing the NaCl solution.

The soaked panels with the electrodes were moved to Faraday cages, where the two electrodes and bare, uncoated area of the metal coupon (working electrode) were connected to an AC power source.

Electrochemical test protocol comprised of four main stages-open circuit potential (OCP; duration of 1800 seconds), LPR-CR (scan rate of 0.125 mV/s), another round of OCP, and lastly, polarization resistance (R^{p})(frequency range of 10-2 to 105 Hz).

OCP was measured to stabilize the system prior to LPR-CR and R^{p} measurements.

Changes in corrosion resistance of the select coatings was determined by periodically measuring Rp and LPR-CR, until visual changes in the soaked area of the coatings were observed (rusted or delamination). Results are shown in Table 6.

TABLE 3
Ranking System Used in Pull-Off Strength

| Ranking Value | Pull-off strength [psi] |
|---|---|
| AA | 2501-3000 |
| BB | 2001-2500 |
| CC | 1501-2000 |
| DD | 1001-1500 |
| EE | 0-1000 |

TABLE 4
Standard test performance of hybrid coatings cured at room temperature

| | | | | | Hot dry |
|---|---|---|---|---|---|
| | | | | | aging |
| | Initial | | Hot water immersion | | Days |
| | Pull-off | | Pull-off | | until |
| FORMU- | strength | Failure | strength | Failure | first |
| LATIONS | ranking | Mode | ranking | Mode | crack |
| H1 | EE | A | DD | Mixed A/C | 16 |
| H2 | EE | C | DD | C | 16 |
| H3 | EE | C | EE | C | >90 |
| H4 | EE | A | DD | A | 12 |
| H5 | EE | A | EE | C | 16 |
| H6 | EE | A | EE | C | 55 |
| H7 | EE | A | CC | G | 46 |
| H8 | DD | Mixed A/C | CC | Mixed G/C | 46 |
| H9 | CC | Mixed G/C/A | BB | G | 46 |
| H10 | EE | A | CC | G | 11 |
| H11 | EE | A | EE | A | 7 |
| H13 | DD | Mixed G/C/A | CC | G | 11 |
| H14 | EE | A | EE | Mixed A/C | 4 |
| H15 | DD | C | DD | Mixed C/G | 30 |
| H17 | DD | C | DD | A | 39 |
| H18 | EE | A | EE | A | >40 |
| H19 | EE | A | DD | Mixed A/G | >40 |
| H20 | DD | Mixed A/C | CC | Mixed G/C/A | 35 |
| H21 | EE | A | EE | A | 45 |
| H22 | EE | A | DD | Mixed A/C/G | 11 |
| H23 | EE | A | EE | A | 11 |
| H38 | EE | Mixed A/G | EE | Mixed A/G/C | >60 |
| H39 | EE | C | EE | C | >60 |
| H40 | DD | Mixed C/A/G | DD | Mixed A/C | >60 |
| H41 | EE | C | EE | Mixed A/C | >60 |
| H42 | EE | C | EE | C | 55 |
| H43 | EE | C | EE | A | >60 |
| H44 | DD | C | EE | A | >60 |
| H45 | EE | A | EE | A | >60 |
| H46 | EE | C | DD | Mixed G/C | 24 |
| H47 | EE | Mixed C/A | DD | C | >60 |
| H48 | DD | A | DD | Mixed C/A | >60 |
| H49 | EE | Mixed A/C | EE | Mixed A/C | >14 |
| H50 | EE | Mixed A/C | DD | Mixed G/A | >14 |
| H51 | EE | G | — | — | >14 |
| H52 | EE | C | EE | A | 4 |
| H53 | EE | C | — | — | >14 |
| H54 | EE | Mixed G/C | — | — | 18 |
| H55 | EE | C | DD | Mixed A/C | 19 |
| | | | | (rusted) | |
| H56 | CC | C | EE | C (rusted) | >14 |
| H57 | BB | C | DD | C | >14 |
| H60 | CC | C | CC | C | >14 |
| H61 | EE | C | DD | C | >60 |
| H62 | DD | C | DD | C | 60 |
| H63 | DD | C | DD | C | 67 |
| H64 | CC | Mixed A/C | CC | C | >60 |
| H65 | CC | Mixed A/C/G | DD | C | >60 |
| H66 | DD | C | DD | C | >60 |
| H67 | EE | C | EE | C | 5 |
| H68 | EE | C | EE | C | 5 |
| H69 | EE | C | DD | A | 5 |
| | | | | (Water | |
| | | | | spots) | |
| H70 | DD | Mixed C/G | DD | C | 5 |
| H71 | CC | Mixed C/G | CC | C | 58 |
| H72 | DD | A | DD | Mixed C/G | 5 |
| H73 | EE | C | EE | A (rusted) | 5 |
| H74 | EE | C | EE | Mixed A/C | 5 |
| H76 | EE | CC | cracked, | | 5 |
| | | | delaminated | | |
| H77 | EE | C | EE | Mixed C/A | 45 |
| H78 | EE | Mixed G/C | Cracked, | | 5 |
| | | | delaminated | | |
| H79 | EE | C | DD | C | 5 |
| H80 | EE | C | DD | C | 14 |
| H81 | EE | Mixed G/C | Cracked, | | 5 |
| | | | delaminated | | |
| H82 | EE | A | DD | Mixed G/C | 5 |
| H83 | EE | C | DD | A | 24 |
| | | | | (water | |
| | | | | ingress) | |
| H84 | EE | Mixed G/C | DD | C (rusted) | 5 |
| H85 | EE | C | DD | Mixed C/G | 5 |
| H86 | EE | C | DD | C | 5 |
| H87 | EE | C | DD | C | 5 |
| H88 | EE | C | DD | C | 5 |
| H89 | DD | C | DD | C | 5 |
| H90 | DD | Mixed C/A | DD | C | 19 |
| H91 | EE | C | DD | Mixed C/A | 5 |
| H92 | EE | Mixed G/C | CC | C | 5 |
| H93 | DD | Mixed G/C | EE | C | 5 |

COMPARISON DATA

| HC1 | EE | A | DD | A | 27 |
|---|---|---|---|---|---|
| HC2 | EE | C | EE | Mixed A/C | >90 |
| HC3 | EE | A | CC | G | 9 |
| HC4 | EE | C | EE | C | >55 |
| HC5 | CC | A | DD | Mixed A/C | 23 |
| HC6 | CC | Mixed G/A | CC | Mixed G/A | >55 |
| HC7 | BB | Mixed G/C | BB | Mixed G/C | >50 |
| HC8 | EE | A | DD | G | >40 |
| HC9 | CC | G | DD | Mixed A/C | 23 |
| HC10 | BB | G | EE | Mixed A/G | >40 |
| HC13 | EE | G | EE | A | — |
| HC14 | AA | G | CC | Mixed A/G | — |
| HC20 | EE | Mixed A/C | EE | C | >60 |
| HC21 | EE | C | EE | A | 55 |
| HC22 | DD | Mixed C/G | DD | A | 55 |
| HC23 | EE | A | DD | G | >14 |
| HC25 | EE | G | — | — | >14 |
| HC26 | DD | C | DD | Mixed A/C | >14 |
| | | | | (rusted) | |
| HC27 | CC | C | DD | C | >14 |
| HC28 | EE | A | DD | G | 32 |
| HC29 | EE | Mixed A/C | DD | A | 39 |
| | | | | (water | |
| | | | | ingress) | |
| HC30 | DD | C | DD | A (rusted) | 60 |
| HC31 | EE | C | EE | C (rusted) | 5 |
| HC32 | DD | C | DD | C | 5 |
| HC33 | EE | C | Cracked, | | 19 |
| | | | delaminated | | |
| HC34 | EE | G | Cracked, | | 5 |
| | | | delaminated | | |
| HC35 | EE | MIXED G/C | Cracked, | | 5 |
| | | | delaminated | | |
| HC36 | EE | C | DD | A | 5 |

TABLE 5
Standard test performance of post-cured hybrid coatings

| | | | | | Hot dry |
|---|---|---|---|---|---|
| | Initial | | Hot water immersion | | aging |
| | Pull-off | | Pull-off | | Days until |
| FOR- | strength | Failure | strength | Failure | first |
| MULATIONS | ranking | Mode | ranking | Mode | crack |
| H24 | EE | Mixed C/A | EE | C | 11 |
| H25 | EE | Mixed A/C | EE | Mixed A/C | >75 |
| H26 | CC | Mixed C/G | CC | Mixed C/A | >75 |
| H27 | AA | Mixed G/C | — | — | >75 |
| H28 | EE | A | DD | Mixed A/C | >75 |
| H29 | EE | G | — | — | 75 |
| H30 | BB | Mixed G/C | CC | C | >75 |
| H31 | AA | G | DD | Mixed A/G | — |
| H32 | AA | G | CC | Mixed C/A | — |
| H47 | CC | C | BB | C | — |
| H49 | EE | C | EE | A | >14 |
| H50 | EE | C | — | — | >14 |
| H51 | BB | Mixed C/G | EE | A | >14 |
| H52 | CC | Mixed C/G | EE | A (rusted) | >14 |
| H53 | BB | G | EE | A (rusted) | >14 |
| H54 | AA | Mixed C/G | DD | Mixed C/A | >14 |
| | | | | (rusted) | |
| H56 | CC | Mixed C/G | DD | C | >14 |
| H57 | BB | Mixed G/C | DD | C | >14 |
| H58 | EE | C | — | — | >14 |
| H59 | CC | C | EE | C | >14 |
| H60 | CC | Mixed C/G | EE | C | >14 |
| H61 | EE | C | DD | Mixed A/C | >60 |
| | | | | (rusted) | |
| H62 | DD | Mixed G/C | DD | C | >60 |
| H63 | CC | Mixed G/C | DD | C | 39 |
| H64 | DD | C | DD | C | 32 |
| H65 | CC | Mixed A/C/G | DD | C | >60 |
| H66 | CC | Mixed A/C/G | DD | C | >60 |
| H67 | EE | A | DD | Mixed A/C | 3 |
| | | | | (rusted) | |
| H68 | EE | C | EE | C | 3 |
| H69 | EE | C | EE | Mixed C/G | 3 |
| H70 | DD | C | DD | C | 3 |
| H71 | CC | Mixed C/G | CC | C | 3 |
| H72 | CC | C | DD | C | 3 |
| H73 | EE | A | DD | Mixed A/C | 3 |
| | | | | (rusted) | |
| H74 | EE | C | EE | A (rusted) | >60 |
| H77 | EE | C | — | — | — |
| H79 | CC | C | EE | Mixed C/A | 3 |
| H80 | DD | C | DD | Mixed A/C | 3 |
| H82 | DD | G | CC | A (rusted) | 32 |
| H83 | EE | C | CC | C | 32 |
| H84 | EE | C | CC | C | 28 |
| H85 | EE | C | CC | Mixed C/A | 3 |
| | | | | (rusted) | |
| H86 | DD | C | DD | C | 3 |
| H87 | DD | Mixed C/G | DD | C | 3 |
| H88 | CC | C | CC | C | 3 |
| H89 | CC | G | DD | C | 3 |
| H90 | BB | C | CC | C | 3 |
| H91 | DD | C | CC | C | 23 |
| H92 | EE | C | EE | CC (rusted) | 32 |
| H93 | | | | | |

COMPARISON DATA

| | | | | | |
|---|---|---|---|---|---|
| HC8 | CC | G | BB | G | 27 |
| HC11 | AA | G | EE | A | 27 |
| HC12 | AA | Mixed C/G | EE | A | >75 |
| HC13 | AA | G | DD | Mixed A/G | — |
| HC14 | AA | G | CC | Mixed C/A | — |
| HC23 | DD | Mixed A/C | CC | Mixed G/A | >14 |
| | | | | (slightly | |
| | | | | rusted) | |
| HC24 | BB | G | — | — | >14 |
| HC25 | BB | Mixed G/C | EE | A (rusted) | >14 |
| HC26 | BB | C | DD | C | >14 |
| HC27 | BB | Mixed G/C | DD | C | >14 |
| HC28 | DD | A | CC | Mixed G/A | 21 |
| | | | | (rusted) | |
| HC29 | DD | G | CC | Mixed G/C | 12 |
| HC30 | BB | Mixed G/C | CC | Mixed C/G | 14 |
| HC32 | CC | Mixed G/C | DD | Mixed G/C | 3 |
| HC35 | EE | C | CC | C | 3 |
| HC36 | DD | C | DD | G | 5 |

TABLE 6
Rₚ and LPR-CR for select hybrid formulations

| | Measurement 1 (initial) | | Measurement 2 | |
|---|---|---|---|---|
| | Rₚ | LPR-CR | Rₚ | LPR-CR |
| FORMULATIONS | (Ω-cm²) | (mpy) | (Ω-cm²) | (mpy) |
| H41 | 2.92E+09 | 2.76E−06 | 4.53E+04 | 4.67E−02 |
| H47 | 1.22E+10 | 2.27E−06 | 2.46E+08 | 1.18E−05 |
| H56 | 5.07E+08 | 1.22E−05 | 1.14E+04 | 3.89E−01 |
| H59 | 2.63E+10 | 9.06E−07 | 1.79E+09 | 7.01E−06 |

1. A hybrid composition comprising:
a) at least one cyclic olefin monomer composition comprising:
a1) at least one cyclic olefin monomer;
a2) optionally, at least one linear monomer;
a3) at least one olefin metathesis catalyst; and
a4) optionally, at least one additive; and
b) at least one resin composition polymerizable by addition or condensation polymerization; and
c) optionally, at least one additive;
wherein components a) and/or b) are optionally crosslinked.

2. The hybrid composition of claim 1, wherein the hybrid composition comprises an interpenetrating polymer network (IPN) or a semi-interpenetrating prepolymer network (SIPN) of the at least one cyclic olefin monomer composition and the at least one resin composition polymerizable by addition or condensation polymerization.

3. The hybrid composition of claim 1 wherein the cyclic olefin monomer is selected from the group consisting of Formulae (I), (II), (III), (V), (VI), and mixtures thereof: 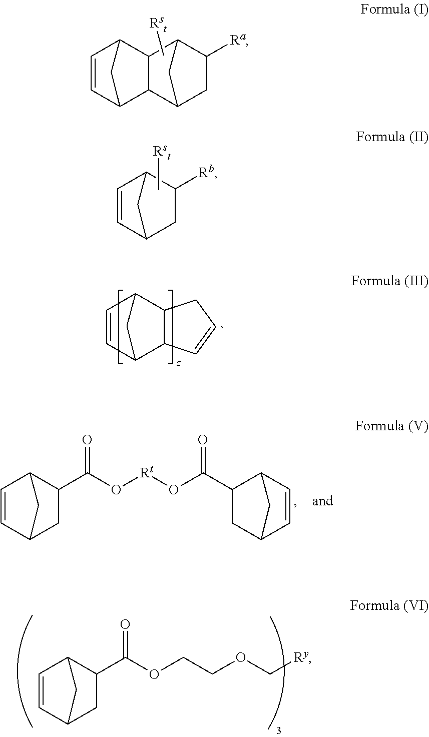
and the linear olefin monomer, if present, has the structure of Formula (IV): 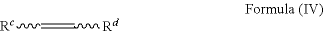
wherein:
R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR)₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁱ), —C(R^{h})(Rⁱ)C(O)NR^{o}R^{p}, [or]-C(R^{h})(Rⁱ)C(O)NR^{o}ORⁿ, or R^{b} is H, optionally substituted linear or branched C₁₋₂₄ alkyl, optionally substituted linear or 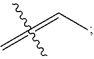 [SMILES: *=CC]
branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —Si(OR^{k})₃-S(O)₂OR^{h}, —OS(O)R^{h}, optionally substituted heterocycle, spiro optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, [or]]-C(R^{h})(Rⁱ)C(O)NR^{o}ORⁿ, or 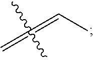 [SMILES: *=CC]
R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —ORB, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, or —C(R^{h})(Rⁱ)C(O)NR^{o}ORⁿ;
R^{d} is H, optionally substituted linear or branched C₁₋₂₄ alkyl, optionally substituted linear or branched C₂₋₂₄ alkenyl, halogen, —C(O)R′, —CH₂—C(O)R′, —OR^{g}, —CH₂—OR^{g}, CN, NO₂, —CF₃—P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, or —C(R^{h})(Rⁱ)C(O)NR^{o}ORⁿ;
each R^{s} is independently optionally substituted linear or branched C₁₋₂₄ alkyl, optionally substituted linear or branched C₂₋₂₄ alkenyl, halogen, —C(O)R¹, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COORⁱ, —C(R^{h})(Rⁱ)C(O) H, —C(R^{h})(Rⁱ)C(O)R^{k}, —C(R^{h})(Rⁱ)CRⁱ(ORⁿ)(ORⁿ), —C(R^{h})(Rⁱ)C(O)NR^{o}R^{p}, or —C(R^{h})(Rⁱ)C(O)NR^{o}ORⁿ;
t is 0, 1, 2, 3, 4, 5, or 6;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)—(optionally substituted C₅₋₂₄ aryl), —C(O)—(optionally substituted linear or branched C₂₋₂₄ alkenyl), or optionally substituted C₃₋₁₂ cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{k} is optionally substituted linear or branched C₁₋₂₄ alkyl, optionally substituted linear or branched C₂₋₂₄ alkenyl, optionally substituted C₃₋₁₀ cycloalkyl, optionally substituted heterocycle, optionally substituted C₅₋₂₄ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
Rt is an optionally substituted linear or branched C₁-C₁₂ alkyl, —(optionally substituted linear or branched C₁-C₆ alkyl)-R^{u}-(optionally substituted linear or branched C₁-C₆ alkyl)—, or —(R^{v})—(R^{w})—(R^{x})—;
R^{u} is O, an optionally substituted C₃-C₁₀-cycloalkyl, optionally substituted C₃-C₁₂ cycloalkenyl, optionally substituted heterocycle, or optionally substituted C₅-C₂₄ aryl;
R^{v} and R^{x} are independently selected from—(optionally substituted linear or branched C₁-C₁₂ alkyl)-aryl-, wherein one or more of the carbon atoms in the C₁-C₁₂ alkyl may be replaced by O;
R^{w} is optionally substituted linear or branched C₁-C₆ alkyl;
R^{y} is optionally substituted linear or branched C₁-C₆ alkyl; and
z is 0, 1, 2, or 3.

4. The hybrid composition of claim 3, wherein:
R^{a} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
R^{b} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
R^{c} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
R^{d} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
t is 0;
R^{f} is OH, OR^{k}, NR^{g}R^{h}, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{h} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{h} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
z is 2;
Rⁱ is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{j} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{k} is optionally substituted C₁₋₁₂ alkyl, optionally substituted linear or branched C₂₋₁₂ alkenyl, optionally substituted C₃₋₈ cycloalkyl, optionally substituted heterocycle, optionally substituted C₆₋₁₀ aryl, optionally substituted C₃₋₁₂ cycloalkenyl, —CH₂-(optionally substituted C₃₋₁₀ cycloalkyl), —CH₂-(optionally substituted C₅₋₂₄ aryl), or —CH₂-(optionally substituted C₃₋₁₂ cycloalkenyl);
R^{l} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{m} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
Rⁿ is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{o} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl; and
R^{p} is H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl.

5. The hybrid composition of claim 3, wherein
the cyclic olefin monomer of formula (I) is tetracyclododecene (TCD), 2-ethylidene-1,2,3,4,4a,5, 8,8a-octahydro-1,4:5,8-dimethanonaphthalene (ENB-DDA), 2-hexyl-1,2,3,4,4a,5,8,8a-octahydro-1,4:5,8-dimethanonaphthalene (HNB-DDA), or a mixture thereof;
the cyclic olefin monomer of formula (II) is 5-ethylidene-2-norbornene (ENB), 5-octyl-2-norbornene (ONB), 2-hydroxyethyl bicyclo[2.2.1]hept-5-ene-2-carboxylate (HENB), 5-carboxylic acid-2-norbornene methyl ester (NBMeE), 5-carboxylic acid-2-norbornene ethyl ester (NBEtE), 5-carboxylic acid-2-norbornene n-Butyl ester (NBnBE), 5-carboxylic acid-2-norbornene tert-butyl ester (NBtBE), 5-carboxylic acid-2-norbornene 2-ethyl hexyl ester (NB-EHE), 5-norbornene-2,3-dicarboxylic acid, dimethyl ester, bicyclo[2.2.1]hept-5-ene-2-carboxylic acid, (3aR,4R,7R,7aR)—3a,4,5,6,7,7a-hexahydro-4,7-methano-1H-inden-5-yl ester (NB-DCPE), carbamic acid, [3-(triethoxysilyl) propyl]-bicyclo[2.2.1]hept-5-en-2-ylmethyl ester (NBCbSi), 5-norbornene-2-methanol (NB-methanol), 5-norbornene-2-exo,3-exo-dimethanol (NB-dimethanol), 2-hydroxyethyl bicyclo[2.2.1]hept-5-ene-2-carboxylate (NB-epoxide), norbornene triethoxy silane (NB-triethoxysilane), 5-(perfluorobutyl) bicyclo[2.2.1]hept-2-ene (NB-Fluorocarbon (1)), bicyclo[2.2.1]hept-5-ene-2-carboxylic acid, 1,1,2,2,3,3,4,4,5,5,6,6-dodecafluorohexyl ester (NB-fluorocarbon (2)), bicyclo[2.2.1]hept-5-ene-2-carboxylic acid, 2,2,2-trifluoro-1-(trifluoromethyl)ethyl ester (NB-fluorocarbon (3)), or a mixture thereof; and
the cyclic olefin monomer of formula (III) is dicyclopentadiene (DCPD), tricyclopentadiene (TCPD), tetracyclopentadene (TeCPD), or a mixture thereof.

6. The hybrid composition of claim 3, wherein:
the cyclic olefin monomer of formula (II) is 5-ethylidene-2-norbornene (ENB), 5-octyl-2-norbornene (ONB), or a mixture thereof; and
the cyclic olefin monomer of formula (III) is dicyclopentadiene (DCPD), tricyclopentadiene (TCPD), tetracyclopentadene (TeCPD), or a mixture thereof.

7. The hybrid composition of claim 3, wherein the cyclic olefin monomer of formula (III) is dicyclopentadiene (DCPD) and tricyclopentadiene (TCPD) and the ratio of DCPD: TCPD ranges from 30:70 to 70:30.

8. The hybrid composition of claim 1, wherein the additive (a3) and (d) are independently selected from the group consisting of an adhesion promoter, a free radical initiator, a cationic initiator, a gel modifier, a hardness modulator, an impact modifier, a cure rate inhibitor, a pot-life controller, an antioxidant, an antiozonant, a filler, a binder, a thixotrope, a rheology modifier, a dispersant, a wetting agent, a plasticizer, a pigment, a flame retardant, a dye, fibers, a reinforcement material, a coupling agent, a UV absorber, a UV light stabilizer, a film former, a lubricant, and mixtures thereof.

9. The hybrid composition of claim 8, wherein the additive is an antioxidant selected from Irganox 1076.

10. The hybrid composition of claim 8, wherein the additive is a pot life extender.

11. The hybrid composition of claim 8, wherein the additive is an adhesion promoter selected from a silane coupling agent.

12. The hybrid composition of claim 8, wherein the additive is a rheology modifier selected from CAB-O-SIL® TS-720.

13. The hybrid composition of claim 8, wherein the additive is a filler selected from Mica C-3000.

14. The hybrid composition of claim 1, wherein the resin composition polymerizable by addition or condensation polymerization is selected from the group consisting of a polyurethane formulation, an epoxy resin formulation, an inorganic silicone-ceramic formulation, a silicone acrylic matrix formulation, and mixtures thereof.

15. The hybrid composition of claim 14, wherein the polyurethane formulation comprises the reaction product of at least one polyol and at least one polyisocyanate.

16. The hybrid composition of claim 15, wherein the polyol is 1,5-pentadiol or 1,5-propanediol, and the polyisocyanate is an HDI trimer.

17. The hybrid composition of claim 1, wherein the ratio of the cyclic olefin monomer prepolymer network: the SIPN ranges from 75:25 to 25:75.

18. The hybrid composition of claim 1, wherein the at least one olefin metathesis catalyst has the structure of Formula (1): 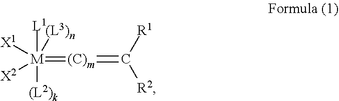
wherein:
M is ruthenium;
L¹, L², and L³ are independently neutral electron donor ligands;
n is 0 or 1;
m is 0, 1, or 2;
k is 0 or 1;
X¹ and x² are independently anionic ligands; and
R¹ and R² are independently hydrogen, optionally substituted hydrocarbyl, optionally substituted heteroatom-containing hydrocarbyl; or R¹ and R² are linked together to form one or more cyclic groups.

19. The hybrid composition of claim 18, wherein:
L¹ and/or L² is 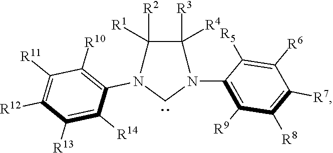
R¹ is H, optionally substituted C₁₋₂₄ alkyl, halogen, —C(O)R²⁵, —OR²⁶, CN, —NR²⁷R²⁸, NO₂, —CF₃, —S(O), R²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² can form a spiro compound, or together with R³ or together with R⁴ can form a polycyclic ring;
R² is H, optionally substituted C₁₋₂₄ alkyl, halogen, —C(O)R²⁵, —OR²⁶, CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R¹ can form a spiro compound, or together with R³ or together with R⁴ can form a polycyclic ring;
R³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² or together with R¹ can form a polycyclic ring, or together with R⁴ can form a spiro compound;
R⁴ is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R³ can form a spiro compound, or together with R² or together with R¹ can form a polycyclic ring;
R⁵ is H, optionally substituted C₁₋₂₄ alkyl, halogen, —C(O)R²⁵, —OR²⁶, CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁶ can form an optionally substituted polycyclic ring;
R⁶ is H, optionally substituted C₁₋₂₄ alkyl, halogen, —C(O)R²⁵, —OR²⁶, —CN, —NR²⁷R²⁸, —NO₂, —CF₃, —cycloalkyl, optionally substituted C₅₋₂₄ aryl, optionally substituted C₃₋₈ cycloalkenyl, or together with R⁵ or together with R⁷ can form an optionally substituted polycyclic ring;
R⁷ is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl optionally substituted C₃₋₈ cycloalkenyl, or together with R⁶ or together with R^{g} can form an optionally substituted polycyclic ring;
R^{g} is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁷ or together with R⁹ can form an optionally substituted polycyclic ring;
R⁹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R^{g} can form an optionally substituted polycyclic ring;
R¹⁰ is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ can form an optionally substituted polycyclic ring;
R¹¹ is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁰ or together with R¹² can form an optionally substituted polycyclic ring;
R¹² is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ or together with R¹³ can form an optionally substituted polycyclic ring;
R¹³ is H, optionally substituted C₁₋₂₄ alkyl, halogen, —C(O)R²⁵, —OR²⁶, —CN, —NR²⁷R²⁸, —NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁴ or together with R¹² can form an optionally substituted polycyclic ring;
R¹⁴ is H, optionally substituted C₁₋₂₄ alkyl, halogen, —C(O)R²⁵, —OR²⁶, —CN, —NR²⁷R²⁸, —NO₂, —CF₃, —cycloalkyl, optionally substituted C₅₋₂₄ aryl, optionally substituted C₃₋₈ cycloalkenyl, or together with R¹³ can form a polycyclic ring;
R²⁵ is —OH, —OR³⁰, —NR²⁷R²⁸, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁷ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁹ is H, optionally substituted C₁₋₂₄ alkyl, —OR²⁶, —NR²⁷R²⁸, optionally substituted heterocycle, optionally substituted C₃₋₁₀ cycloalkyl, optionally substituted C₅₋₂₄ aryl, or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; and
x is 1 or 2.

20. (canceled)

21. (canceled)

22. (canceled)

23. The hybrid composition of claim 1, wherein the at least one olefin metathesis catalyst has the structure of Formula (2): 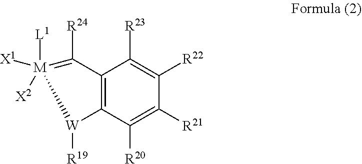
wherein:
M is ruthenium;
L¹ is a neutral electron donor ligand;
X¹ and X² are independently anionic ligands;
W is O, halogen, NR³³ or S;
R¹⁹ is H, optionally substituted C₁₋₂₄ alkyl, —C(R³⁴)(R³⁵)COOR³⁶, —C(R³⁴)(R³⁵)C(O) H, —C(R³⁴)(R³⁵)C(O)R³⁷, —C(R³⁴)(R³⁵)CR³⁸ (OR³⁹)(OR⁴⁰), —C(R³⁴)(R³⁵)C(O)NR⁴¹R⁴², —C(R³⁴)(R³⁵)C(O)NR⁴¹OR⁴⁰, —C(O)R²⁵, optionally substituted heterocycle, optionally substituted C₃₋₁₀ cycloalkyl, optionally substituted C₅₋₂₄ aryl, optionally substituted C₃₋₈ cycloalkenyl, or when W is NR³³, then R¹⁹ together with R³³ can form an optionally substituted heterocyclic ring or when W is halogen then R¹⁹ is nil;
R²⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²¹ can form a polycyclic ring;
R²¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²⁰ or together with R²² can form a polycyclic ring;
R²² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl or together with R²¹ or together with R²³ can form a polycyclic ring;
R²³ is H, optionally substituted C₁₋₂₄ alkyl, halogen, —C(O)R²⁵, —OR²⁶, CN, —NR²⁷R²⁸, NO₂, —CF₃, —cycloalkyl, optionally substituted C₅₋₂₄ aryl, optionally substituted C₃₋₈ cycloalkenyl or together with R²² can form a polycyclic ring;
R²⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl or optionally substituted C₃₋₈ cycloalkenyl;
R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁷ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³³ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁴ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁵ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁶ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁷ is optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁸ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R³⁹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴⁰ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴¹ is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl;
R⁴² is H, optionally substituted C₁₋₂₄ alkyl, optionally substituted C₃₋₁₀ cycloalkyl, optionally substituted heterocycle, optionally substituted C₅₋₂₄ aryl or optionally substituted C₃₋₈ cycloalkenyl; and
x is 1 or 2.

24. (canceled)

25. (canceled)

26. (canceled)

27. An article of manufacture, comprising the hybrid composition of claim 1.

28. A method of making a molded article, comprising:
forming a resin composition comprising the hybrid composition of claim 1,
contacting the resin composition with at least one substrate, and
subjecting the resin composition to conditions effective to promote an olefin metathesis reaction of the at least one cyclic olefin monomer.

29. A coating composition, comprising the hybrid composition of claim 1.

30. A method for coating at least one substrate, comprising:
optionally applying an adhesion promoter onto at least a portion of a surface of the at least one substrate;
applying onto the at least portion of the surface of the at least one substrate a composition comprising the hybrid composition of claim 1; and
curing the coating applied to the substrate surface.

31. An article of manufacture, comprising the at least one coated substrate of claim 30.

32. (canceled)

33. (canceled)

34. An adhesive composition, comprising the hybrid composition of claim 1.

35. A cured article of manufacture, comprising the hybrid composition of claim 1.
